(19) United States
(12) Patent Application Publication
(10) Pub. No.: US 2015/0197130 A1
(43) Pub. Date: Jul. 16, 2015

(54) SUSPENSION FOR A MULTIPLE HEIGHT VEHICLE

(71) Applicant: Dallas Smith Corporation, Greencastle, IN (US)

(72) Inventors: Judson L. Smith, Greencastle, IN (US); Darren K. Back, Greencastle, IN (US); Garrett J. Smith, Chicago, IL (US); Virgil R. Dutton, Ft. McDowell, AZ (US)

(21) Appl. No.: 14/575,453

(22) Filed: Dec. 18, 2014

Related U.S. Application Data
(60) Provisional application No. 61/917,627, filed on Dec. 18, 2013.
(60) Provisional application No. 61/940,012, filed on Feb. 14, 2014.
(60) Provisional application No. 62/019,720, filed on Jul. 1, 2014.
(60) Provisional application No. 62/052,197, filed on Sep. 18, 2014.
(60) Provisional application No. 62/081,917, filed on Nov. 19, 2014.

(51) Int. Cl. B60G 11/46

(52) U.S. Cl. CPC B60G 11/46

(57) ABSTRACT

Some embodiments of the present invention relates to rear drive axle suspension systems for OEM cargo truck and ambulance type vehicles and more particularly to a method and a means to provide said vehicles with a 2-Position suspension system, wherein Position-1 is for vehicle transport and Position-2 is for vehicle loading and unloading. And, wherein improved vehicle ride, stability, and handling is achieved in Position-1, and improved lowered vehicle load floor is achieved in Position-2.

### CROSS REFERENCE TO RELATED APPLICATIONS

This application claims the benefit of priority to U.S. provisional patent application Ser. No. 62/081,917, filed Nov. 19, 2014; U.S. provisional patent application Ser. No. 62/052,197, filed Sep. 18, 2014; U.S. provisional patent application Ser. No. 62/019,720, filed Jul. 1, 2014; U.S. provisional patent application Ser. No. 61/940,012, filed Feb. 14, 2014; and U.S. provisional patent application Ser. No. 61/917,627, filed Dec. 18, 2013, all of which are incorporated herein by reference.

### FIELD OF THE INVENTION

Various embodiments of the present inventions pertain to vehicle suspensions and in particular to suspensions for cargo-carrying vehicles, including suspensions and suspension kits useful in reducing the height of the cargo floor.

### BACKGROUND OF THE INVENTION

It is well described within the art that standard OEM truck rear drive axles generally incorporate leaf spring type suspension systems as can be seen in patents: U.S. Pat. No. 2,226,047; U.S. Pat. No. 3,213,959; U.S. Pat. No. 2,919,760; and, U.S. Pat. No. 3,213,959. Coil rear drive axle springs have also been used by OEMs, but generally have such applications with vehicles having a low gross vehicle axle rating (automobiles), as can be seen in patent U.S. Pat. No. 2,300,844.

Although leaf spring type suspensions generally provide adequate jounce and rebound of the vehicle's axle travel, they are operated in only a single position, which is at the vehicle's ride height. To provide lowering of the truck's rear load floor, e.g. for a do it yourself self-moving van truck having a loading/unloading ramp, the OEM leaf spring suspension is normally replaced with an air suspension system such as a Kelderman brand F2R24ECC11AL (U.S. Pat. No. 6,340,165) or, a Link brand 8M000097 or, a Liquid Air, Granning, and Hendrickson brands of air suspension systems. Replacing an OEM leaf spring suspension with an air ride suspension can be time consuming and normally at additional significant cost. Still other designs have been offered for manipulation of one or more leaf springs, including U.S. Pat. No. 5,433,578.

Furthermore, OEM trucks generally have frame rails with an overall width of approximately 34 inches—which places the centerline of the leaf spring, or an air suspension “spring base,” at approximately 40 inches. Ambulance type vehicles encounter emergency type driving requirements that include excessive vehicle speeds, maneuverings, braking, etc. It would be desirable in such vehicle use applications to have a rear suspension with a wider “spring base” to provide improved vehicle ride, stability, handling, and safety. Also, ambulance type vehicles often meet a specific vehicle rear load floor deck height dimension for “standard” patient gurney height access, which in most cases necessitates the lowering of certain vehicle's rear load floor during the time patient gurneys are removed from or placed into the ambulance.

These features are important components of trucks with respect to the operating characteristics, original costs and maintenance of such vehicles. Accordingly, it is desirable to provide such rear axle suspensions that have optimum operating characteristics combined with improved safety, driver comfort, and the added utility of being able to change the rear suspension's relationship with the vehicle's frame in order to enhance a truck's loading and unloading operations.

Heretofore, rear axle suspensions for trucks have been available whereby the active suspension members, e.g., air springs, leaf springs, coil springs, etc., are positioned in close proximity to the truck's frame rails, and generally adjacent to the centerline of the rear drive axle, which provide for a narrow spring base with very little active leverage of the suspension in the axle's jounce and rebound travel.

However, rear axle leaf suspensions have not been previously known or available which provide both a ride height position combined with a lowered height position. And, a method or means to provide a wider leveraged spring base with a means to also lower the truck's load floor. Such novel combinations of a two (2) position leaf spring suspension, and or a wider leveraged rear suspension spring base of the truck's load floor are now provided in accordance with the present invention.

For a more complete understanding of the nature and scope of the invention reference may now be made to the following summary and detailed description of the presently preferred embodiments of the invention taken with the accompanying drawings wherein:

### SUMMARY OF THE INVENTION

It would be desirable to be able to lower and/or raise a standard leaf spring rear axle suspension of an OEM truck's load floor to achieve: alignment with warehouse unloading dock heights; lowering, for trucks utilizing pull-out loading ramps wherein having a lower load floor of a truck will require a shorter overall length ramp; and, whereby with certain cargo of a truck that is loaded and unloaded by stepping-in and stepping-out from the lowered load floor becomes an easier and safer operation.

It has been found in accordance with some embodiments of the present invention that such objectives and improvements can be achieved by providing a truck rear axle leaf spring suspension having two (2) operating positions. Additionally, in accordance with the present invention the objective of having a wider leveraged spring base, utilizing individual trailing arms employing a means to lower the truck's rear load floor through the compression; release of compression; or, disengaging the rear axle from the suspension of said wider leveraged spring base suspensions is achieved.

Yet another invention embodiment employs a rear drive axle with a wider leveraged coil spring suspension supported by independent, yet connected trailing arms. The method and apparatus of this embodiment also provides for lowering the vehicle's rear load floor deck by an actuator that is attached to the vehicle's frame connected by a flexible link to a fixedly mounted fastener located on the connecting frame between the suspension's trailing arms. The actuator and arrangement of components can either compress the coil spring suspension, or the independent trailing arm can be released from their locked fastened position in the coil spring frame housing which allows for the vehicle frame to be lowered through the actuator. This embodiment provides vehicles such as ambulances a means to achieve better vehicle stability and handling as well as the ability to lower the rear load floor deck to align with the federally regulated required patient gurney heights.

It will be appreciated that the various apparatus and methods described in this summary section, as well as elsewhere in this application, can be expressed as a large number of different combinations and subcombinations. All such useful, novel, and inventive combinations and subcombinations are contemplated herein, it being recognized that the explicit expression of each of these combinations is unnecessary.

### BRIEF DESCRIPTION OF THE DRAWINGS

Some of the figures shown herein may include dimensions. Further, some of the figures shown herein may have been created from scaled drawings or from photographs that are scalable. It is understood that such dimensions, or the relative scaling within a figure, are by way of example, and not to be construed as limiting.

FIG. 1 is a rear view of OEM chassis cab vehicle having a leaf spring rear suspension.

FIG. 2 is a rear view of the chassis cab vehicle of FIG. 1 with a retractor mechanism to compress the leaf spring suspension to lower the rear frame deck of the vehicle.

FIG. 3 is a rear view of the chassis cab vehicle of FIG. 1 with rear frame deck lowered (compressed suspension).

FIG. 4 is a side elevation view of a chassis cab vehicle at ride height with a rear trailing arm coil suspension, according to another embodiment of present invention.

FIG. 5 is a side elevation view of the chassis cab vehicle of FIG. 4 at lowered (compressed) height with a rear trailing arm coil suspension.

FIG. 6 is a rear view of the chassis cab vehicle of FIG. 4 at ride height having a trailing arm coil spring suspension and mechanism to compress suspension to lower vehicle's rear deck frame.

FIG. 7 is a rear view of the chassis cab vehicle of FIG. 4 at lowered (compressed coil suspension) rear deck frame.

FIG. 8 is an isometric view of the chassis cab vehicle of FIG. 4 having a trailing arm coil suspension.

FIG. 9 is a rear view of a chassis cab vehicle having standard leaf spring suspension and showing the “spring base” relationship between the centerline of the leaf springs to other vehicle components, e.g. wheels, frame, axle, etc.

FIG. 10 is a rear view of the chassis cab vehicle of FIG. 8 having a wide leveraged coil spring suspension anchored to pivoting trailing arms and the “spring base” relationship between the centerline of the coil springs to other vehicle components, e.g. wheels, frame, axle, etc.

FIG. 11 is a side elevation view of a chassis cab vehicle according to another embodiment of the present invention at ride height having a wide leveraged coil spring suspensions anchored to pivoting trailing arms.

FIG. 12 is a side elevation view of the chassis cab vehicle of FIG. 11 with a lowered rear frame deck having trailing arms wide leveraged coil spring suspension wherein the trailing arms are released from their connection with the coil springs allowing the vehicles rear frame to lower. For clarity, the left side components have been removed showing the right side lower spring mount (7), coiled spring (8), trailing arm (6), and locking member (31).

FIG. 13 is a rear view of a chassis cab vehicle at ride height having a wide leveraged coil spring trailing arm suspension.

FIG. 14 is a rear view of the chassis cab vehicle of FIG. 13 at a lowered rear frame deck utilizing a wide leveraged coil spring trailing arm suspension showing the trailing arms released from the coil spring(s) frame.

FIG. 15A is an isometric view of the chassis cab vehicle of FIG. 13 having a wide leveraged coil trailing arm suspension and the mechanism to provide release of the trailing arms from coupling with the lower spring mounts (which results in a state of compression with the coil springs in the transport mode of operation), and a means to lock or unlock said trailing arms to the coil suspension frame. FIG. 15 shows both trailing arms 6 coupled to the lower spring mounts.

FIG. 15B shows an enlarged portion of the apparatus of FIG. 15A.

FIG. 16A is a rear view of a chassis cab vehicle having a wide leveraged trailing arm air suspension according to another embodiment of the present invention.

FIG. 16B is a rear view of a chassis cab vehicle having a wide leveraged trailing arm air suspension according to another embodiment of the present invention.

FIG. 16C is a rear view of a chassis cab vehicle having a wide leveraged trailing arm air suspension according to another embodiment of the present invention.

FIG. 17 is an isometric view of a chassis cab vehicle according to another embodiment of the present invention having a wide leveraged trailing arm coil spring suspension wherein the trailing arms have a means to be connected or released from the coil spring frame by a gear drive motor and chain and sprocket assembly which is connected to the trailing arms.

FIG. 18 is a side view detail of the drive motor and chain and sprocket assembly as shown in FIG. 17.

FIG. 19 is a side view detail of the rear vehicle frame (at ride height) utilizing the gear drive motor and chain and sprocket assembly as shown in FIG. 17.

FIG. 20 is an isometric view of the operating components described in FIG. 17.

FIG. 21 is an isometric view of the operating components described in FIG. 17, with the coil spring removed for clarity.

FIG. 22 is an isometric view of the operating components described in FIG. 17, with the coil spring removed for clarity.

FIG. 23A is a side view of a chassis cab vehicle at ride height having a standard leaf spring suspension but with movable support brackets which allow the distance relationship between the frame and the rear drive axle to be shortened and/or lengthened lowering or raising the rear frame deck of the vehicle.

FIG. 23B is an enlarged representation of a portion of FIG. 23A.

FIG. 23C is an alternate embodiment of the apparatus of FIG. 23A.

FIG. 24A is a side view of a chassis cab vehicle at lowered height having a standard leaf spring suspension but with movable support brackets which allow the distance relationship between the frame and the rear drive axle to be shortened and/or lengthened lowering or raising the rear frame deck of the vehicle.

FIG. 24B is an enlarged representation of a portion of FIG. 24A.

FIG. 25 is a front, top, perspective view looking aft of a shaded CAD representation of a driver's side portion of a suspension according to one embodiment of the present invention, with the suspension shown in the first, vehicle transport mode of operation.

FIG. 26 shows the apparatus of FIG. 25 with a portion of the slider assembly removed to show internal construction features.

FIG. 27A is a view of the apparatus of FIG. 25 from the rear looking forward.

FIG. 27B is a view of the apparatus of FIG. 27A, except shown with the suspension in the second, vehicle-loading position.

FIG. 28A is a side elevational view of the apparatus of FIG. 25.

FIG. 28B is a view of the apparatus of FIG. 28A, except shown in the second, vehicle-loading position.

FIG. 29 is an enlargement of a portion of the apparatus of FIG. 28.

FIG. 30 is a view of the apparatus of FIG. 29 from a rear perspective, with several of the components being shown in see-through.

FIG. 31 is a perspective representation of a portion of the apparatus of FIG. 25.

FIGS. 32A, B, and C are line drawings showing orthogonal views of the apparatus of FIG. 31.

FIGS. 33A, B, and C are line drawings showing orthogonal views of the attachment support housing of FIG. 25.

FIG. 34A is a top plan view looking downward of the apparatus of FIG. 32C.

FIG. 34B is a cross sectional representation of the apparatus of FIG. 33A as taken along line 34B-34B.

FIG. 35 is a perspective shaded CAD representation of a latch pivot arm according to one embodiment of the present invention.

FIG. 36A is a close-up photographic representation of the suspension of a left rear wheel of a vehicle shown in a perspective view from the outboard and front side of the installed kit, similar to the kit of FIGS. 25-35, with the chassis shown at the lowered position.

FIG. 36B is a perspective photographic representation of a view of the chassis looking from above, toward the rear, and from the left outboard side of the vehicle of FIG. 36A, with the chassis shown at the normal ride height.

FIG. 36C is a close-up photographic representation of the apparatus of FIG. 36B.

FIG. 36D is a close-up photographic representation of the apparatus of FIG. 36C.

FIG. 36E [REMOVED]

FIG. 36F is a view of the apparatus of FIG. 36A as viewed facing forward, from an outboard vantage point, with the actuator shown in the fully retracted position.

FIG. 36G is a view of the apparatus of FIG. 36F, with the actuator shown in the extended position.

FIG. 37 is a CAD perspective representation of an apparatus according to another embodiment of the present invention, and adapted and configured for the rear leaf spring mount for a left rear tire of a vehicle, as viewed from the rear facing forward.

FIG. 38 is a CAD perspective representation of the apparatus of FIG. 37 as viewed from the front looking aft.

FIG. 39 is an elevational CAD representation of the apparatus of FIG. 37 as viewed from the rear looking forward.

FIG. 40 is an elevational CAD representation of the apparatus of FIG. 39 as viewed from the front looking aft.

FIG. 41 is a side elevational view of the apparatus of FIG. 37 from the outboard looking in.

FIG. 42 [REMOVED]

FIG. 43 is a side elevational view of the apparatus of FIG. 37 as viewed from the inboard looking out.

FIG. 44 is a bottom plan view of the apparatus of FIG. 37.

FIG. 45A is a CAD perspective line drawings of a portion of the apparatus of FIG. 37.

FIG. 45B is a view of the apparatus of FIG. 45A from a different perspective.

FIG. 46A is a CAD perspective line drawing of the sliding bracket of FIG. 37.

FIG. 46B is a CAD perspective representation of the apparatus of FIG. 46a.

FIG. 47A is a side elevational CAD line drawing of the apparatus of FIG. 41, with the chassis shown at the normal ride height.

FIG. 47B is a view of the apparatus of FIG. 46A, with the chassis shown in the lowered position.

FIG. 48A is a side elevational CAD line drawing of the apparatus of FIG. 41, with the chassis shown at the normal ride height and with the certain components removed for clarity and other components shown in cross sectional views.

FIG. 48B is a view of the apparatus of FIG. 48A, with the chassis shown in the lowered position and with the certain components removed for clarity and other components shown in cross sectional views.

FIG. 49 is graphical representation of an apparatus according to one embodiment of the present invention shown in both of the normal ride height and cargo-loading positions, overlaid.

FIG. 50 is a side elevational CAD drawing of the embodiments of FIG. 36, showing dimensions.

FIG. 51 is a top plan view of a CAD drawing of the embodiments of FIG. 36, showing dimensions.

FIG. 52 is a left side photographic representation looking to the right and aft of a vehicle suspension system according to another embodiment of the present invention.

FIG. 53 is a photographic representation from the right side looking inboard of a portion of the apparatus of FIG. 52.

FIG. 54A is a CAD drawing representing portions of the apparatus of FIG. 53, shown in the normal ride height position.

FIG. 54B is a photographic representation from the rear looking forward of the apparatus of FIG. 53.

FIG. 55 is a CAD drawing of the apparatus of FIG. 54A shown in the lowered or squatting position.

FIG. 56 is a right side photographic representation looking inboard of the apparatus of FIG. 56, shown in the lowered position.

FIG. 57 is a right side photographic representation from the aft looking forward and inboard of the apparatus of FIG. 56.

FIG. 58 is a photographic representation from the right side and aft looking forward of the apparatus of FIG. 57.

FIG. 59 is a CAD representation of a portion of a front suspension, as viewed from the right side looking inboard, and shown in the normal ride height position.

FIG. 60 is a cutaway CAD representation of the apparatus of FIG. 59 as viewed from the front looking aft.

FIG. 61 is cutaway CAD representation of the apparatus of FIG. 60, shown in the lowered or squatting position.

FIG. 62 is a photographic representation from the right side looking aft and inboard of a front suspension shown in the lowered position, according to another embodiment of the present invention.

FIG. 63 is a photographic representation from the right side looking inboard and slightly downward of the apparatus of FIG. 62.

FIG. 64 is a 3D, CAD representation of a portion of a right side, rear suspension system shown in the normal ride height position according to another embodiment of the present invention.

FIG. 65A is a CAD representation of the apparatus of FIG. 64, as viewed from the right side looking inboard and forward of the apparatus of FIG. 64, except shown in the lowered or squatting position.

FIG. 65B is a view from the bottom looking upward at a CAD representation of the apparatus of FIG. 65A.

FIG. 66 is a CAD representation of the apparatus of FIG. 64, shown from the right side looking outboard and forward.

FIG. 67A is a perspective CAD representation of the apparatus of FIG. 64, as shown from the right side looking aft and downward.

FIG. 67B is a view from the front right looking aft, downward, and outboard, of an apparatus similar to the apparatus of FIG. 67A.

FIG. 68 is a CAD perspective representation of a portion of apparatus of FIG. 64.

FIG. 69 is a CAD perspective representation of a portion of apparatus of FIG. 64.

FIG. 70 is an orthographic side angle view of a leaf spring rear shackle assembly, according to another embodiment of the present invention.

FIG. 71 is an orthographic rear angle view of the leaf spring rear shackle assembly of FIG. 70.

FIG. 72 is an orthographic cross-sectional view of the leaf spring rear shackle assembly of FIG. 70.

FIG. 73 is an orthographic side angle view of the leaf spring rear shackle assembly shown with the outboard upper shackle support removed of FIG. 70.

FIG. 74 is a right side, front perspective photographic representation looking left and aft of a portion of the front suspension of a vehicle according to one embodiment of the present invention, prior to addition of a front suspension kit.

FIG. 75 is an enlarged photographic representation of a portion of the apparatus of FIG. 74.

FIG. 76 is a largely side view of a photographic representation of an OEM leaf spring for the front suspension of a vehicle.

FIG. 77A is a side schematic representation of the apparatus of FIG. 76 as installed on a vehicle.

FIG. 77B is a right side schematic representation looking left of a portion of the front suspension of a vehicle according to one embodiment of the present invention, with the kit installed.

FIG. 78 is a side elevational line drawing of a multi-height rear suspension on the curb-side of an OEM chassis according to one embodiment of the present invention, shown at the normal ride height.

FIG. 79 is a view of the apparatus of FIG. 78, except actuated to place the rear suspension at a lowered position.

FIG. 80 is an outboard perspective view from the front looking aft of the apparatus of FIG. 79.

FIG. 81 is a view similar to that of FIG. 80, except according to another embodiment of the present invention.

FIG. 82 is a side elevational line drawing of a multi-height rear suspension on the curb-side of an OEM chassis according to one embodiment of the present invention, shown at the normal ride height.

FIG. 83 is a view of the apparatus of FIG. 82, except actuated to place the rear suspension at a lowered position.

### ELEMENT NUMBERING

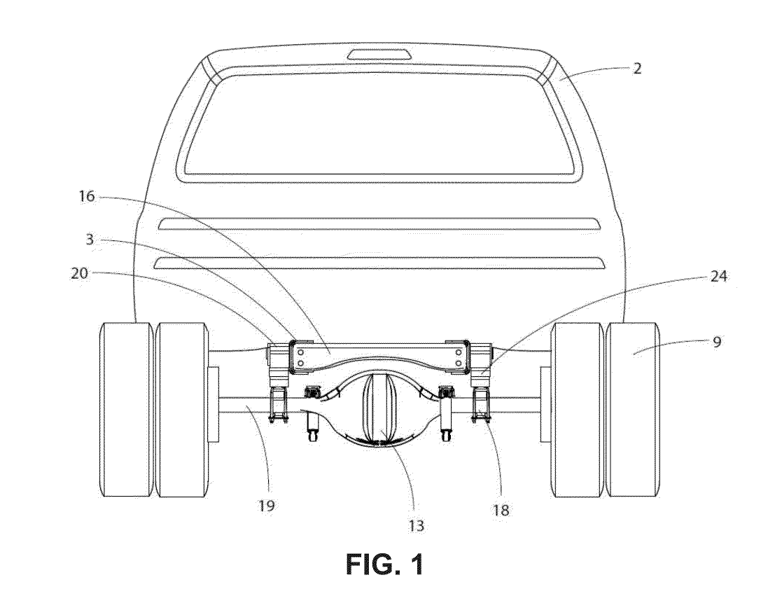

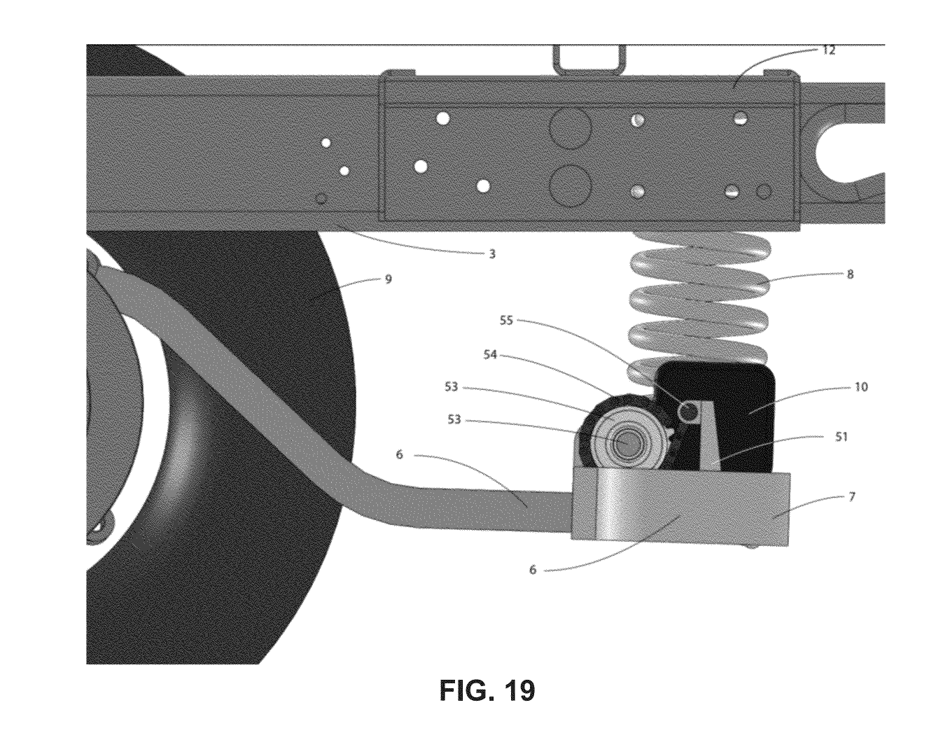

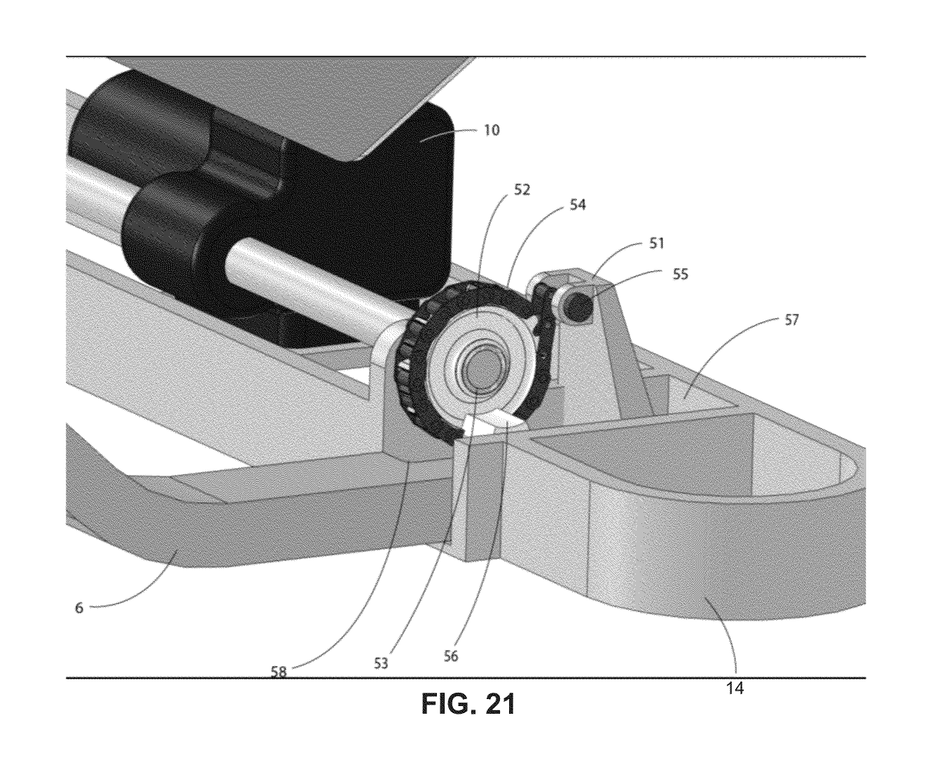

The following is a list of element numbers and at least one noun used to describe that element. It is understood that none of the embodiments disclosed herein are limited to these nouns, and these element numbers can further include other words that would be understood by a person of ordinary skill reading and reviewing this disclosure in its entirety. The following element numbering is applicable for FIGS. 1-24.

| | |
|---|---|
| 1 | vehicle |
| 2 | cab |
| 3 | longitudinal chassis frame rail |
| 4 | suspension trailing arm front pivot mount |
| 5 | suspension trailing arm pivot |
| 6 | suspension trailing arm |
| 7 | coil spring lower mount |
| 7B | pocket |
| 8 | trailing arm suspension coil spring |
| 9 | wheel |
| 9A | tire |
| 9B | trailing arm suspension vehicle at ride |
| | height |
| 9C | trailing arm suspension vehicle at lowered |
| | height |
| 10 | rear axle retractor actuator |
| 11 | rear axle retracting link |
| 12 | coil spring upper mount |
| 13 | rear drive axle |
| 14 | trailing arms - coil spring carrier frame |
| 14H | hinge |
| 15 | trailing arms - carrier frame |
| 16 | frame cross member gusset |
| 17 | rear axle retracting link bracket |
| 17A | coil spring frame retracting mount |
| 18 | rear suspension axle mount |
| 19 | rear drive axle mount |
| 20 | rear suspension frame mount |
| 21 | air spring |
| 22 | OEM leaf spring - spring base |
| 23 | coil spring - spring base |
| 24 | rear suspension leaf spring |
| 30 | trailing arm retracted to up position |
| 31 | trailing arm release lock from spring frame |
| 32 | trailing arm coil spring vehicle ride height |
| 33 | trailing arm coil spring vehicle lowered |
| | height |
| 34 | gear drive actuator |
| 35 | upper link mount to frame |
| 36 | lower link mount to spring frame |
| 37 | crossmember to mount gear drive |
| | actuator |
| 38 | frame locking pin retracted |
| 39 | support connecting trailing arms |
| 40A | suspension at vehicle ride height |
| 40B | retractor link |
| 41A | suspension at vehicle lowered height |
| 50 | rotary drive shaft |
| 51 | spring carrier from upper link mount |
| 52 | drive sprocket |
| 53 | trailing arm nesting housing |
| 54 | chain |
| 55 | chain upper mount pivot |
| 56 | rotary drive shaft sprocket locking lug |
| 58 | spring frame locking cavity for trailing arm |
| 59 | trailing notch out to receive sprocket log |
| 100 | leaf spring front pivot mount |
| 101 | sliding “yaw” bracket; guiding channel |
| 102 | rear drive axle leaf spring mount; rub |
| | block |
| 103 | rear leaf spring movable mount |
| 104 | actuator mount |
| 105 | wheel |
| 106 | rear leaf spring movable link |
| 107 | actuator |
| 108 | vehicle ride height vertical dimension |
| 109 | vehicle lowered height vertical dimension |

### ELEMENT NUMBERING

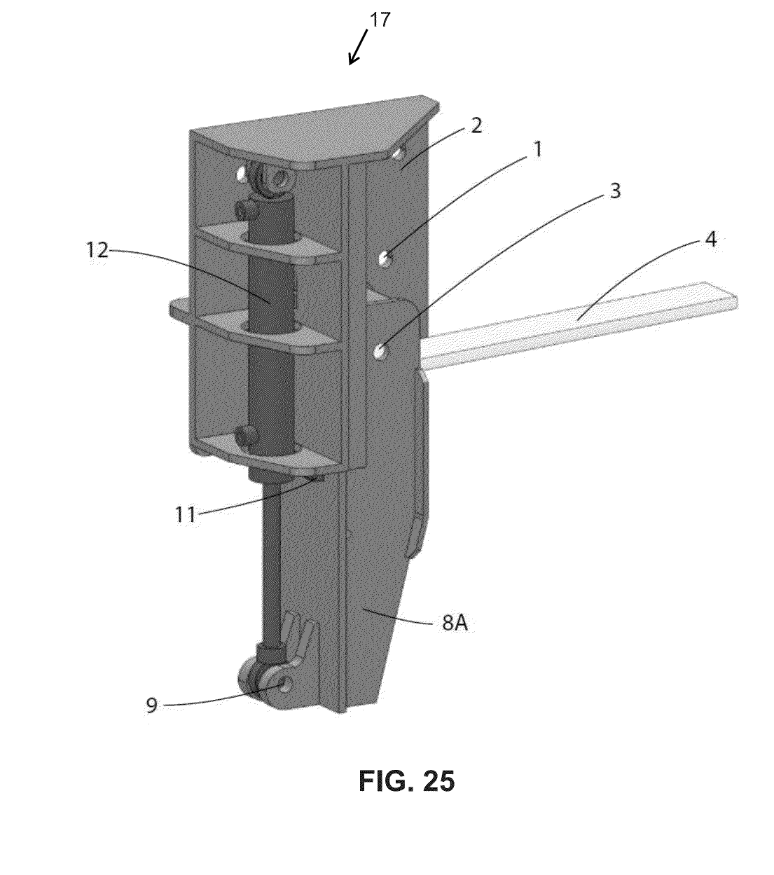

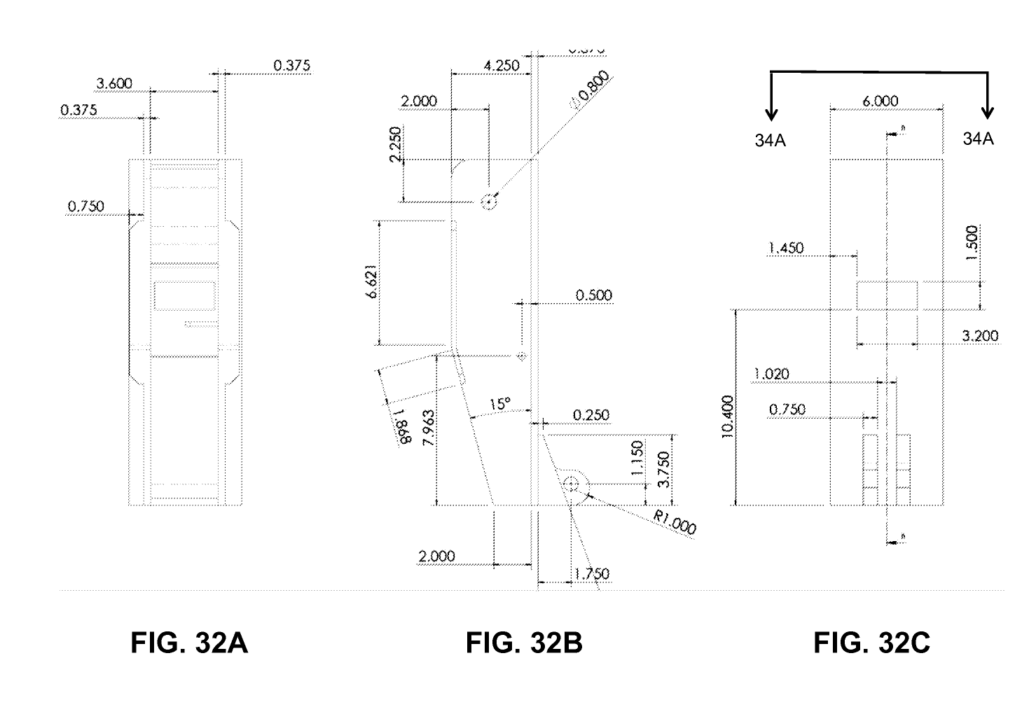

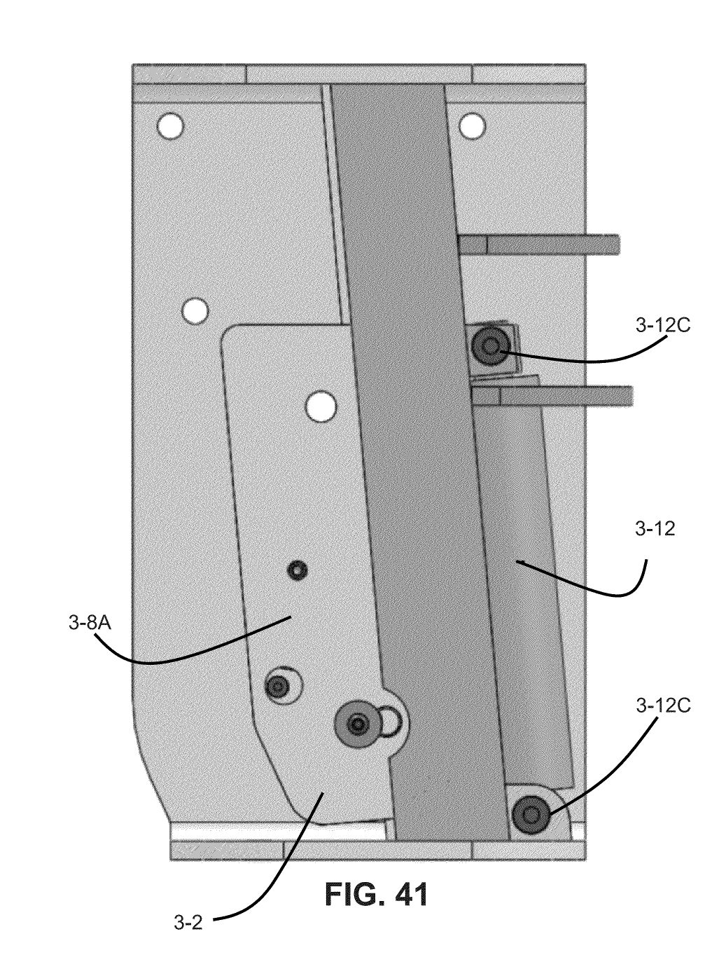

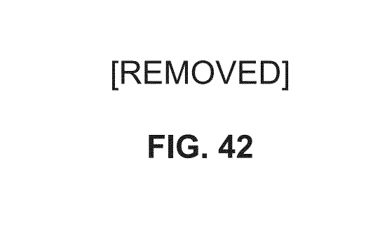

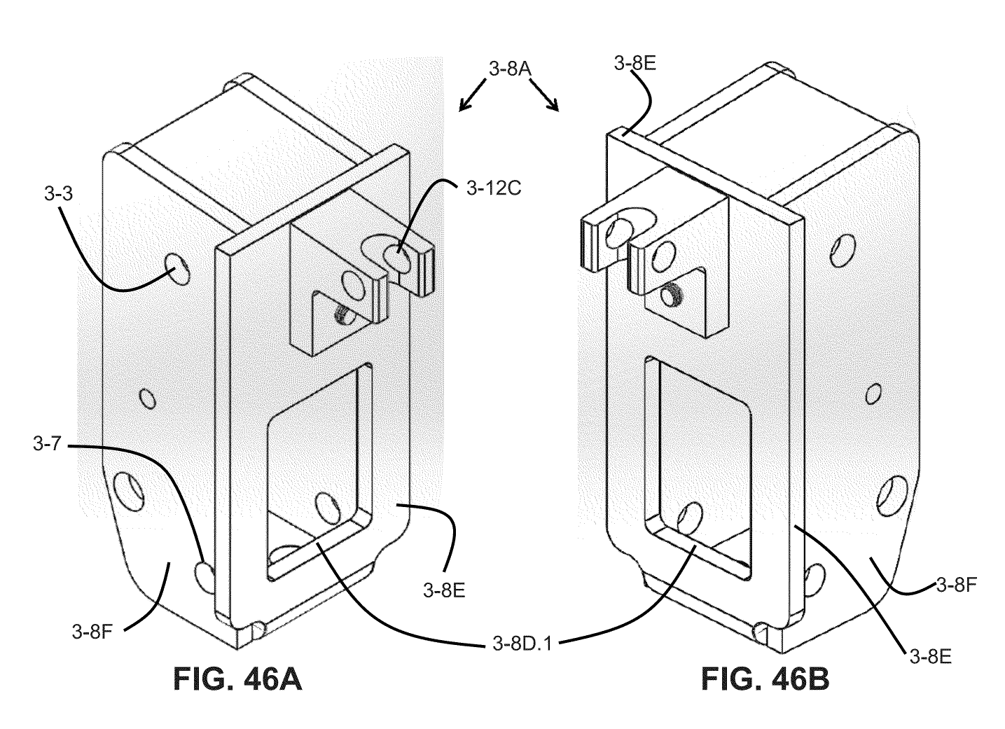

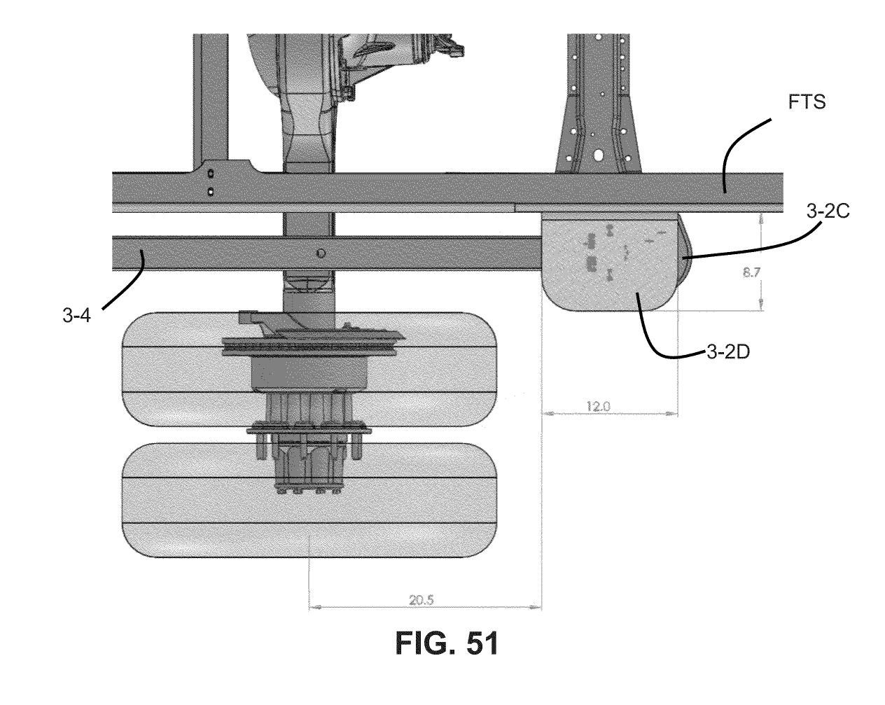

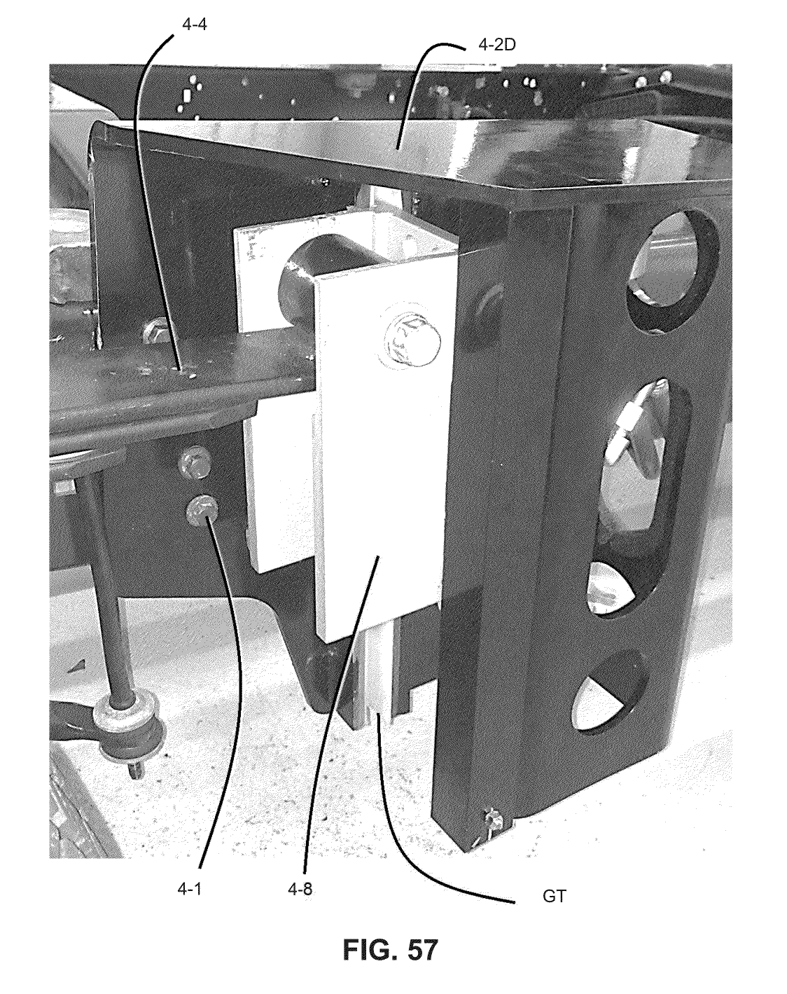

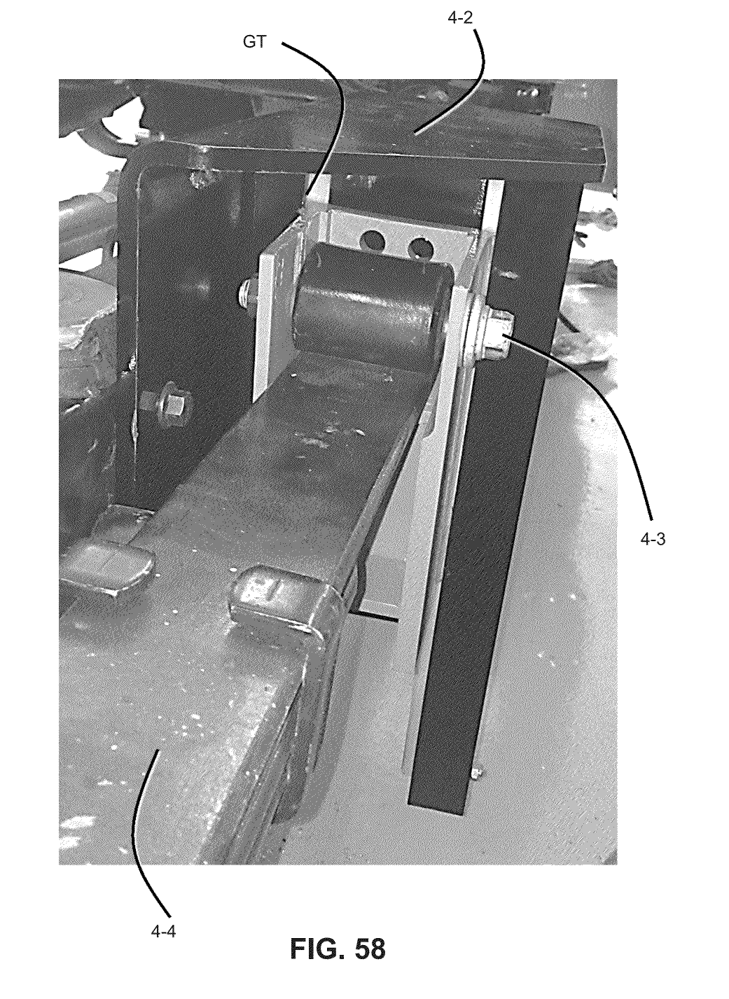

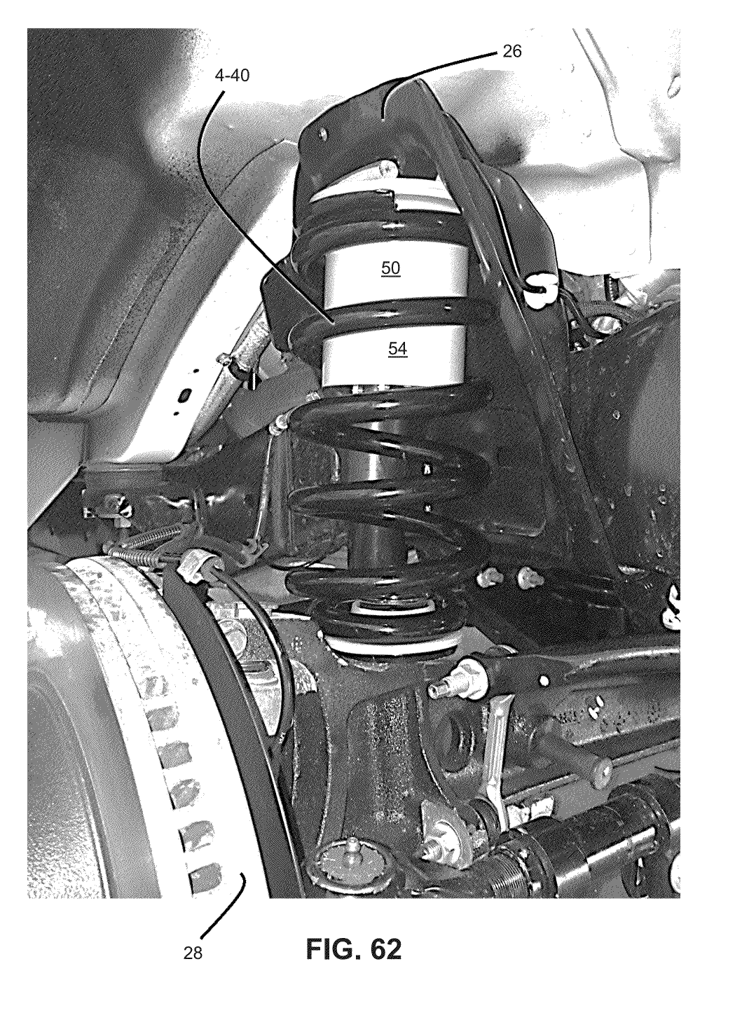

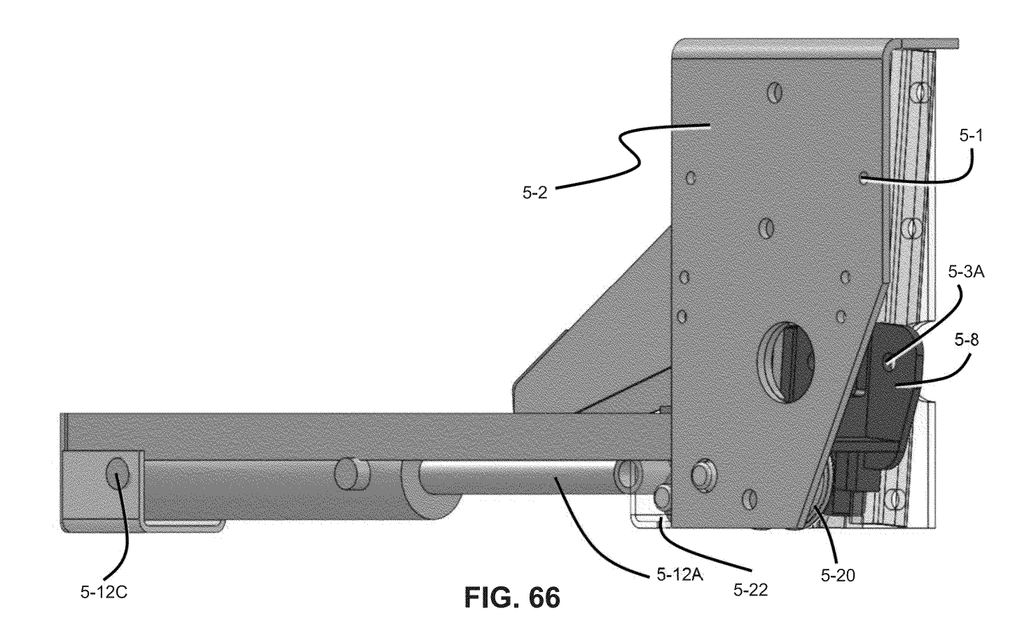

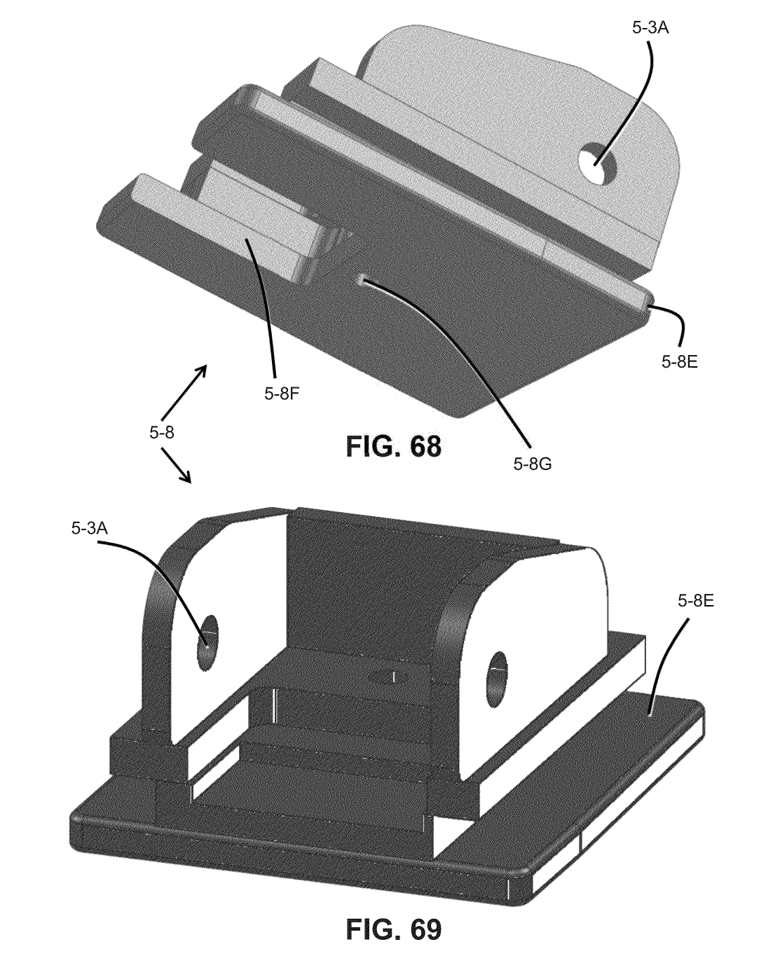

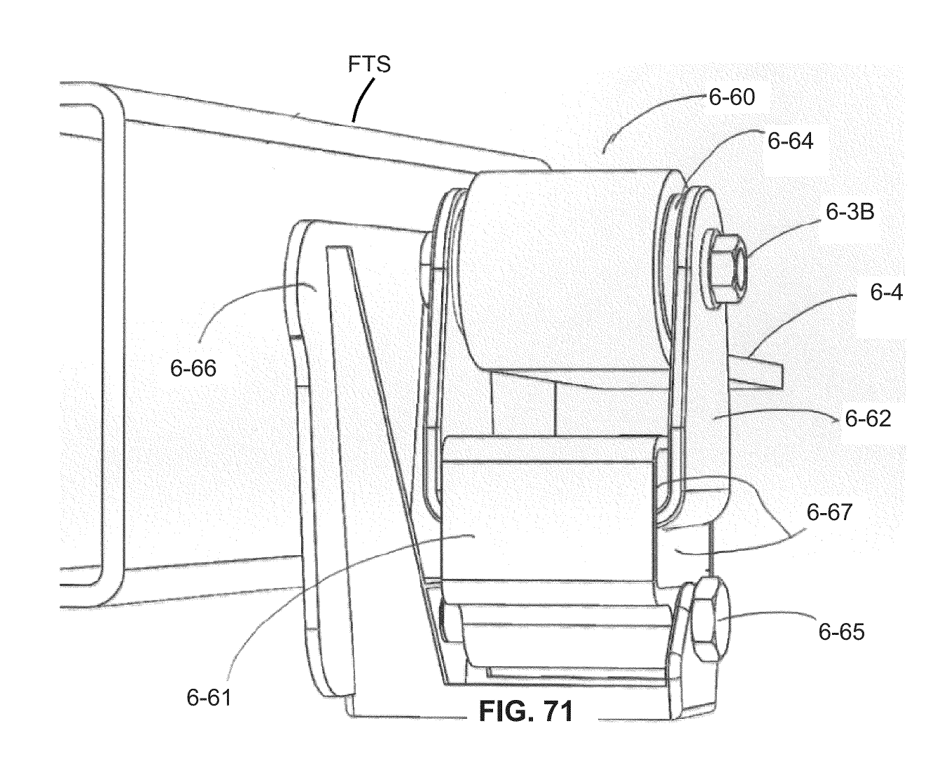

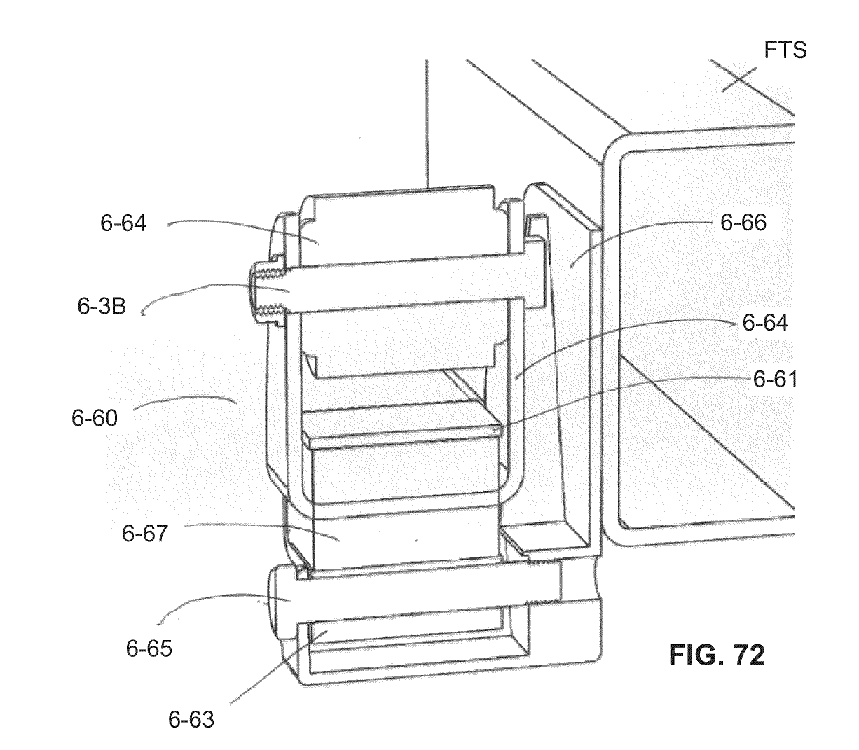

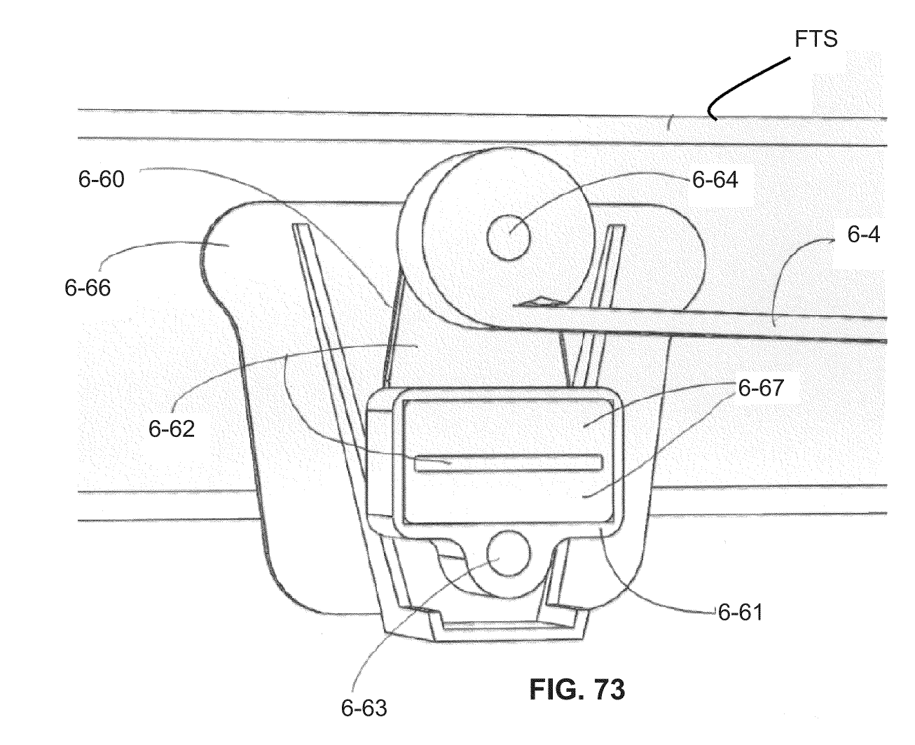

The following is a list of element numbers and at least one noun used to describe that element. It is understood that none of the embodiments disclosed herein are limited to these nouns, and these element numbers can further include other words that would be understood by a person of ordinary skill reading and reviewing this disclosure in its entirety. The following element numbering is applicable for FIGS. 25-83.

| | |
|---|---|
| 1 | attachment hole - assembly |
| | support housing |
| 2 | assembly support housing |
| 2A | assembly support housing - |
| | horizontal bracket |
| 2B | slider assembly side channel |
| 2B.1 | angle |
| 2C | strengthening ribs |
| 2D | top plate |
| 2E | bottom plate |
| 2F | aperture |
| 3 | front leaf spring pivot |
| 3A | front leaf spring pivot |
| 3B | rear leaf spring pivot |
| 4 | leaf spring |
| 5 | latch lock actuator |
| 5A | latch lock actuator mount |
| 5B | latch lock actuator rod |
| 5C | rod pivotal coupling |
| 5D | threaded coupling |
| 6 | actuator attachment to latch |
| 7 | latch pivot |
| 8 | slider assembly; bell crank |
| 8A | side section slider assembly, sliding |
| | bracket |
| 8B | latch lock actuator housing |
| 8C | slider plate |
| 8D | latch lock access window |
| 8E | channel guiding feature |
| 8F | side members |
| 8G | linkage attachment |
| 8H | pulley groove |
| 8I | cable; chain; wire rope |
| 8J | bell crank actuator arm |
| 8K | bell crank spring arm |
| 8L | bell crank pivot |
| 9 | actuator attachment |
| 9A | slider actuator pivot |
| 10 | latch pivot arm |
| 10A | latch lock load surface |
| 10B | side view latch lock pivot assembly |
| | arm |
| 10C | latch pad assembly pivot shaft |
| | access |
| 11 | latch lock pad |
| 12 | actuator, rear |
| 12.1, | piggyback actuators |
| 12.2 | |
| 12A | slider actuator rod |
| 12B | hydraulic lines; hydraulic flowpath |
| 12C | pivotal attachments |
| 12D | cylinder |
| 12E | piggyback bracket |
| 12F | static bracket |
| 13 | slider actuator signal port #1 |
| 14 | slider actuator signal port #2 |
| 15 | UHMW (plastic) slider contact |
| | surface |
| 16 | latch lock pivot shaft |
| 16A | latch lock spring |
| 17 | kit |
| 18 | boot |
| 19 | limit switch |
| 20 | pulley |
| 22 | guide |
| 24 | link or cable |
| 26 | frame |
| 27 | shock absorber |
| 28 | front brake disc |
| 29 | lower suspension arm |
| 30 | actuator, front |
| 32 | actuator, cylinder |
| 34 | actuator/rod |
| 36 | actuator rod spherical end |
| 40 | spring, front |
| 50 | actuator/spring interface assy. |
| 52 | outer actuator support |
| 53 | inner actuator support |
| 54 | spring support |
| 55 | spring support guide |
| 56 | spring support loading surface |
| 60 | rear shackle assembly |
| 61 | lower shackle |
| 62 | upper shackle |
| 63 | lower shackle bushing |
| 64 | upper shackle bushing |
| 65 | lower shackle bushing fastener |
| 66 | leaf spring rear shackle assy, frame |
| | support bracket |
| 67 | polyurethane molded/bonding |
| | member |
| GT | guiding track |
| FTS | frame top surface |
| V | vertical |
| SL | short link |
| KND | kneeling distance |

### DESCRIPTION OF THE PREFERRED EMBODIMENT

For the purposes of promoting an understanding of the principles of the invention, reference will now be made to the embodiments illustrated in the drawings and specific language will be used to describe the same. It will nevertheless be understood that no limitation of the scope of the invention is thereby intended, such alterations and further modifications in the illustrated device, and such further applications of the principles of the invention as illustrated therein being contemplated as would normally occur to one skilled in the art to which the invention relates. At least one embodiment of the present invention will be described and shown, and this application may show and/or describe other embodiments of the present invention. It is understood that any reference to “the invention” is a reference to an embodiment of a family of inventions, with no single embodiment including an apparatus, process, or composition that should be included in all embodiments, unless otherwise stated. Further, although there may be discussion with regards to “advantages” provided by some embodiments of the present invention, it is understood that yet other embodiments may not include those same advantages, or may include yet different advantages. Any advantages described herein are not to be construed as limiting to any of the claims. The usage of words indicating preference, such as “preferably,” refers to features and aspects that are present in at least one embodiment, but which are optional for some embodiments.

The use of a prefix before an element number (N-X.Y, for example as used in FIGS. 25-83) refers to an element that is the same as elements having a different prefix (M-X.Y), except as shown and described. As an example, an element 12 would be the same as element 2-12, except for those different features of 12 that are shown and described, or otherwise understood by persons of ordinary skill in the art. Further, common elements and common features of related elements may be drawn in the same manner in different figures, and/or use the same symbology in different figures. As such, it is not necessary to describe the features of 12 and 2-12 that are the same, since these common features are apparent to a person of ordinary skill in the related field of technology. Further, it is understood that the features 12C and 2-12C may be forward and backward compatible, as would be understood by those of ordinary skill in the art. This description convention also applies to the use of prime (′), double prime (″), and triple prime (′″) suffixed element numbers. Therefore, it is not necessary to describe the features of 20.1, 20.1′, 20.1″, and 20.1′″ that are the same, since these common features are apparent to persons of ordinary skill in the related field of technology.

As shown and described in the element numbering tables, the elements of FIGS. 25-83 are numbered and use terminology that may be different than the element numbering applied to the other figures. However, as will be recognized by persons of ordinary skill in the art, the use of different numbering or nomenclature does not detract from the understanding that various features and aspects of FIGS. 25-83 are compatible with and usable with the features and aspects of the other drawings and embodiments. Persons of ordinary skill in the art will recognize and appreciate the large number of different embodiments described in all of the figures taken as a whole that pertain to suspension systems that provide multiple heights to a vehicle.

Although various specific quantities (spatial dimensions, temperatures, pressures, times, force, resistance, current, voltage, concentrations, wavelengths, frequencies, heat transfer coefficients, dimensionless parameters, etc.) may be stated herein, such specific quantities are presented as examples only, and further, unless otherwise explicitly noted, are approximate values, and should be considered as if the word “about” prefaced each quantity. Further, with discussion pertaining to a specific composition of matter, that description is by example only, and does not limit the applicability of other species of that composition, nor does it limit the applicability of other compositions unrelated to the cited composition.

Various references may be made to one or more processes, algorithms, operational methods, or logic, accompanied by a diagram showing such organized in a particular sequence. It is understood that the order of such a sequence is by example only, and is not intended to be limiting on any embodiment of the invention.

One embodiment of the present invention is best seen by viewing FIGS. 1, 2, 3, which illustratively represent an OEM chassis cab truck vehicle (1) with a leaf spring suspension having a rear drive axle housing (13) securement bracket (17) that is indirectly connected to an actuator (10). Actuator (10) preferably provides a rotational response after receiving power, including as examples electric, hydraulic, and pneumatic motors. The actuator is attached to the vehicle's frame (16) and the connection between the rear axle bracket and the actuator is through a flexible link, e.g. chain link (11). In some embodiments, actuator (10) includes a sprocket having a plurality of teeth, wherein each of the teeth couple to a link of the chain. In yet other embodiments, retracting link (11) can be a toothed belt, with actuator (10) likewise having each tooth or cog of the belt aligning in a toothed or cogged pulley. In still further embodiments, link (11) can be a cable that attaches at one end to a linear actuator, and at the other end to bracket (17), such that retraction of the linear actuator applies tension to the cable.

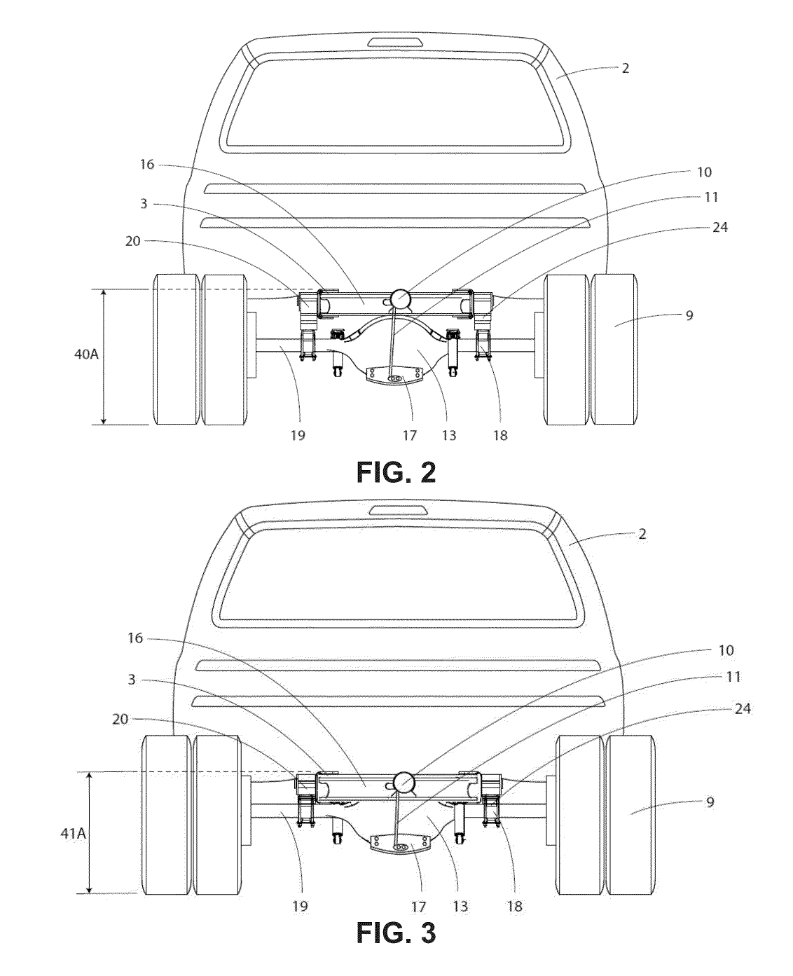

Upon receiving an electronic signal from an electronic controller, or a manual signal (such as by an operator pressing a button) the actuator causes the leaf spring suspension to compress, by winding of the chain link (11) about a rotating surface of actuator (10) so as to place link (11) in compression and pull frame member 16 and axle housing (13) together. In some embodiments the actuator (10) is of the type that substantially locks in position after the vehicle is brought to the compressed height. As examples, this locking can be accomplished by maintaining hydraulic pressure or electrical power sufficient to maintain the actuator in position. As yet other examples, a solenoid-operated pin can be inserted through a corresponding hole in the actuator so as to provide a positive mechanical stop preventing retraction of the actuator. Position 1, the ride height is shown in FIG. 1 and FIG. 2; Position 2, the lowered height, is shown in FIG. 3. After the operator has utilized the vehicle at the lowered height, a corresponding electronic signal or manual signal (such as by pressing a button, or by removing a mechanical lock) releases the position of the rotary or linear actuator, such that the stored energy of the compressed leaf spring is released to cause the frame 3 to return to the normal ride height. The features shown in the above-described embodiment provide a leaf spring suspension, which is lowered to provide load floor adjustment to the vehicle to align with loading/unloading docks, or to provide a sloping floor for easier unloading and loading of cargo by two wheeled carts and the like.

FIG. 1 is a rear view drawing of an OEM type cab chassis truck (2) having longitudinal frame rails (3) connected by laterally spaced cross members (16) creating a load floor, suspended from the rear drive axle (13) by leaf springs (24) which are coupled to axle (13) by lower brackets (18) and to the vehicle frame (3) by upper brackets (20). Upon the vehicle's wheel (9) jounce and/or rebound action, the leaf spring suspension (24) will compress (jounce) or decompress (rebound), e.g., during a vehicle's travel over a bumpy, irregular surfaced road. The centerline of the rotational axis of the wheel (9) and axle (13) are represented by the axle's lateral tube housings (19) and are coupled midway, in the fore and aft direction, of the leaf spring suspension (24). Additionally, the suspension leaf springs (24) are directly attached to the outboard faces of the vehicle's frame rails (3). Now referring to FIG. 2, rotary actuator (10) which is attached to structural cross member (16) connects to rear axle (13) differential housing by cradle bracket (17) through flexible link (e.g. chain) (11). As shown in FIG. 3, upon rotary actuator (10) receiving a command signal, rotates in a direction which retracts or recoils the flexible link (11) which lowers by compressing leaf spring suspension (24), the vehicle's rear load floor represented by the vehicle's frame rails (3). Representation of the load floor (3) Position 1, in the ride height position, is illustrated in FIG. 2 (40A), and Position 2, in the lowered height, through illustration in FIG. 3 (41A).

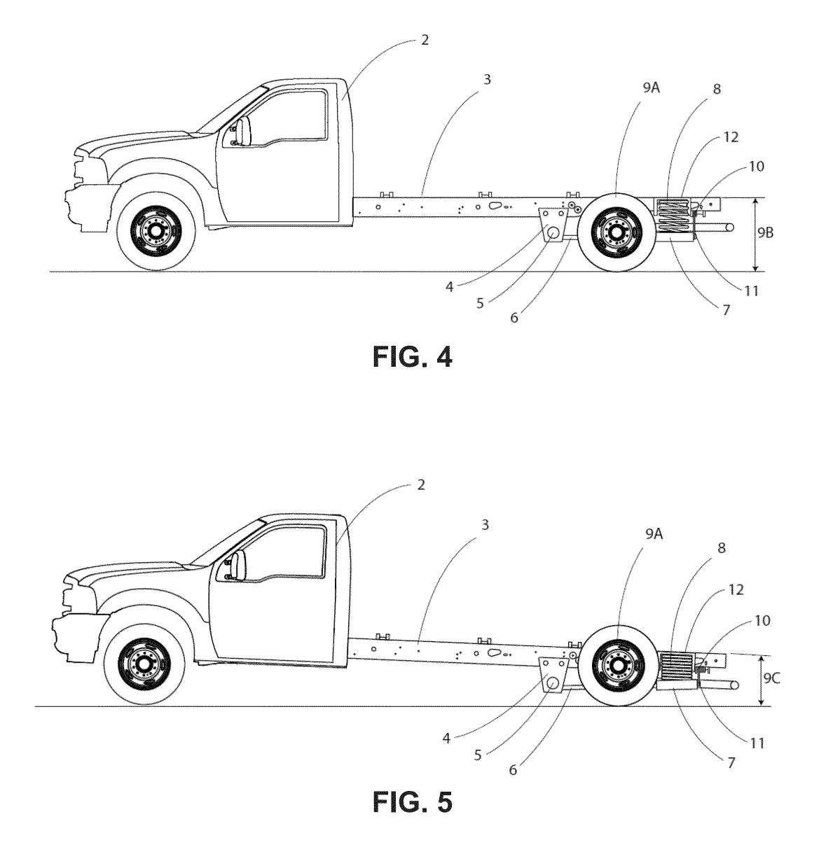

FIGS. 4-8 show an OEM chassis cab vehicle modified in accordance with one embodiment of the present invention. Comparing FIG. 4 to FIG. 1, it can be seen that the leaf springs (24) are coupled to the top of rear axle 13 by corresponding axle mounts (14). This coupling of the leaf spring to the axle occurs roughly in the middle of the leaf spring. The ends of the leaf spring are mounted to frame rails (3) by corresponding frame mounts (20), all of which is best seen in FIG. 1.

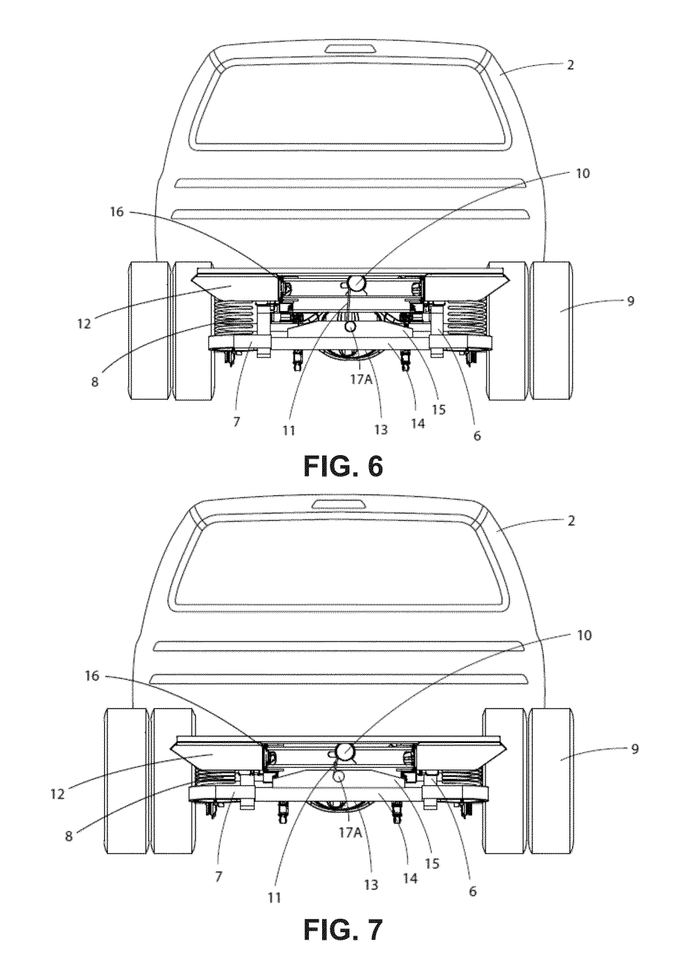

FIG. 4 shows the OEM vehicle of FIG. 1 after modifications in accordance with one embodiment of the present invention. The leaf springs (24) have been removed, and instead the vehicle frame is suspended by a pair of coil springs (8) located behind corresponding wheels (9a) and further located outboard the frame rails (the latter being best seen in FIGS. 6 and 7). Each coil spring (8) is received by an upper mount (12) and a lower mount (7), the lower mount (7) being located on the aft end of a suspension trailing arm (6) that is pivotally coupled by a pivot (5) and pivot mount (4) to frame rail (3). FIGS. 6, 7, and 8 show that the upper spring mounts (12) are coupled to frame rails (3) by a laterally-extending cross member. Further details pertaining to the modifications of an OEM cab chassis from the OEM configuration of FIG. 4 to the trailing arm and outer and rearward coil springs of FIGS. 4-8 can be found in co-pending U.S. patent application Ser. No. 13/899,144, filed May 21, 2013, and published as US 2013/0330157.

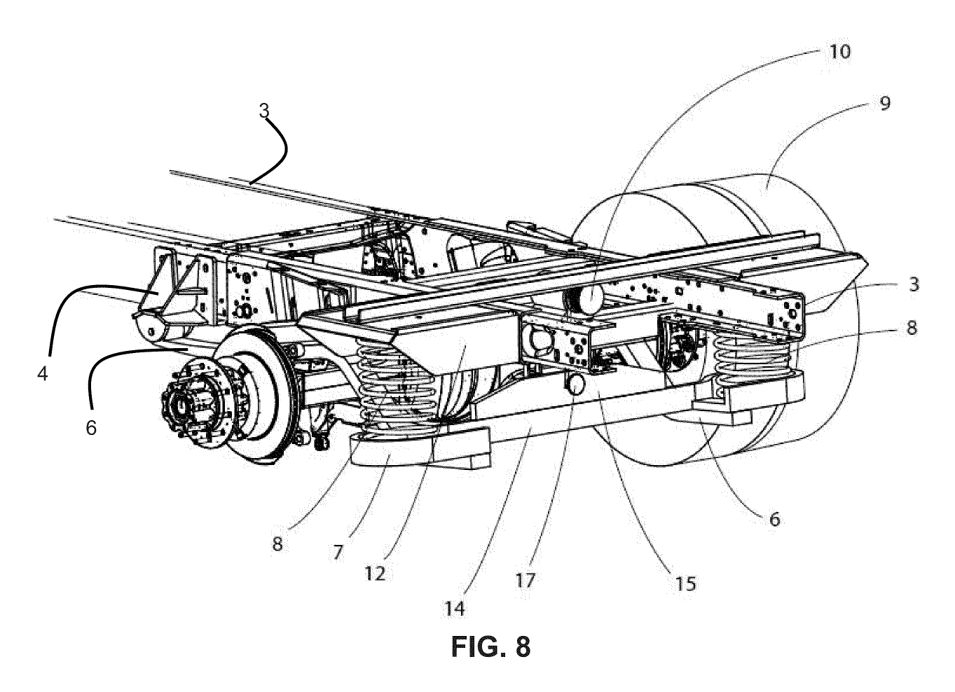

Referring to FIG. 8, it can be seen that each of the bottom ends of the coil springs (8) are retained in lower mounts (7) that are part of a carrier frame (17). Carrier frame (14) extends laterally across the rear of the vehicle frame, and includes a central section (15) that includes a bracket (17) that supports a linkage mount (17A). A comparison of FIGS. 6 and 7 shows the suspension system in the transport and loading positions, respectively. These figures show a link (11) (such as a chain) that is coupled at one end to mount (17A), and at the other end to a sprocket or other link-mounting feature that rotates upon command from actuator (10). FIG. 6 shows actuator (10) in the “unwound” position, such that chain (11) has a maximum length between actuator (10) and mount (17A). In FIG. 7, it can be seen that the link (11) has been wound around the periphery of the sprocket of actuator (10), such that coil springs (8) are compressed, and the top surface of the frame rails has been lowered (as can be seen in reference to the top surface of the wheels (9)). Preferably, actuator (10) is structurally coupled to the chassis frame by way of the laterally-extending cross member that couples the top spring supports (12) to the frame rails (3).

Some types of leaf springs are designed to provide relatively movement from extension to full compression. Further, some leaf springs are known to have a memory after being compressed, such that this travel distance from extension to compression is reduced. Therefore, some embodiments of the present invention include replacement of the leaf spring with a coil spring (8).

An embodiment of the present invention provides for a vehicle's wide leveraged suspension coil spring base as represented in FIG. 4 through and including FIG. 10. FIG. 4 shows a coil spring (8) which nests in an upward retaining pocket (12) and a lower coil spring carrier frame (7) which is coupled to a trailing arm (6) which has a pivot mount (4) and a pivot coupling (5). Ride height or Position 1 is shown by the dimensional reference space (9B) that represents the height dimension from the top of the vehicle's frame (load floor) (3) to the ground on which the tires (9A) rest. FIG. 4 shows a rotary actuator (10) having a retractor link (e.g. chain) (11) that is connected on its opposite end to the coil spring carrier frame (7). Now referring to FIG. 5, which illustrates the vehicle in Position 2 with a lower load floor (frame) (3), and is shown by the dimensional reference space (9C) which represents the height dimension from the top of the vehicle's frame (load floor) (3) to the ground on which the tires (9A) rest.

With further explanation, FIG. 6 (vehicle at Position 1) and FIG. 7 (vehicle at Position 2) are rear elevation views of the vehicle, and corresponding respectively to FIGS. 4 and 5. As can be seen in FIG. 7, when rotary actuator (10) is activated by a signal it retracts or recoils connecting link (11) which is attached to the spring carrier frame (7) by means of the carrier frame cross channel (14) which supports structural gusset (15) and the connecting link's (11) attachment to the coil spring carrier frame (17A), which then lowers the vehicle's load floor (frame) (3) from Position 1 to Position 2 by compressing coil springs (8). Upon receiving a subsequent command signal the rotary actuator (10) reverses its motion to release coil springs (8) from the Position 2 lowered compressed height FIG. 7 back to a Position 1 ride height FIG. 6.

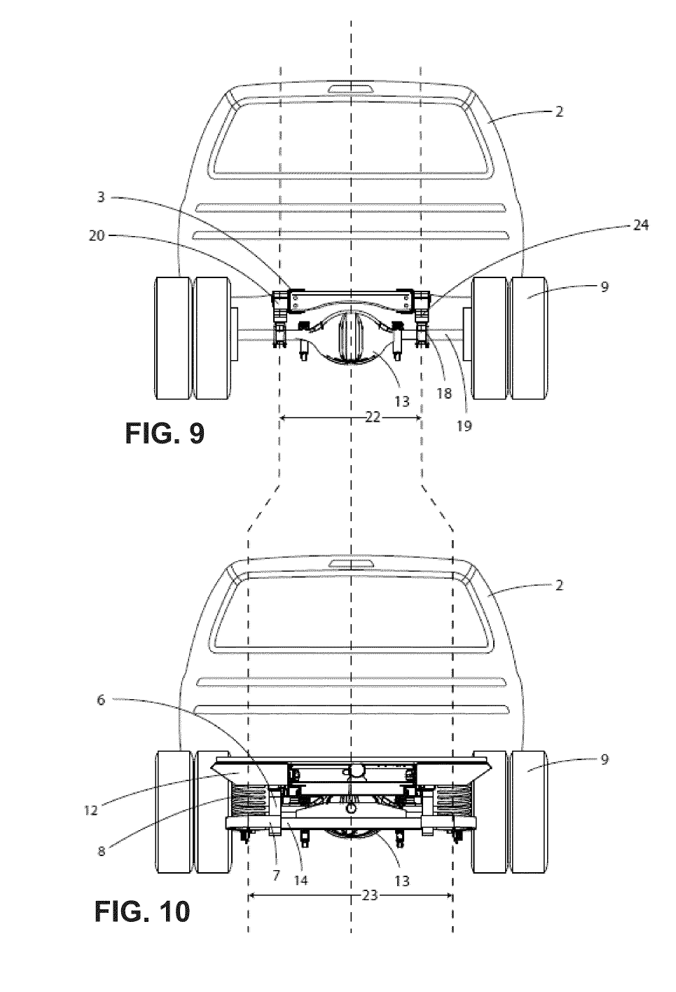

A comparison of FIGS. 9 and 10 show end views of the OEM cab chassis and the modified cab chassis, respectively. It can be seen in FIG. 9 that the leaf springs (24) are located relatively close to the centerline of the vehicle. FIG. 10 shows that some embodiments of the present invention contemplate placing replacement coil springs at greater distances from the centerline. However, it is understood that the coil springs (8) of FIG. 10 could also be placed substantially at the same distances from the vehicle centerline, as is contemplated in other embodiments of the present invention.

FIG. 9 shows the narrow dimensional relationship (22) of a standard leaf spring suspension (24) that is directly mounted to the axle tube sections (18) and frame (3), and wherein FIG. 10 and FIG. 8 show the improved increase in the vehicle's spring base (23) by utilizing a wide leveraged trailing arm (6) coil spring suspension.

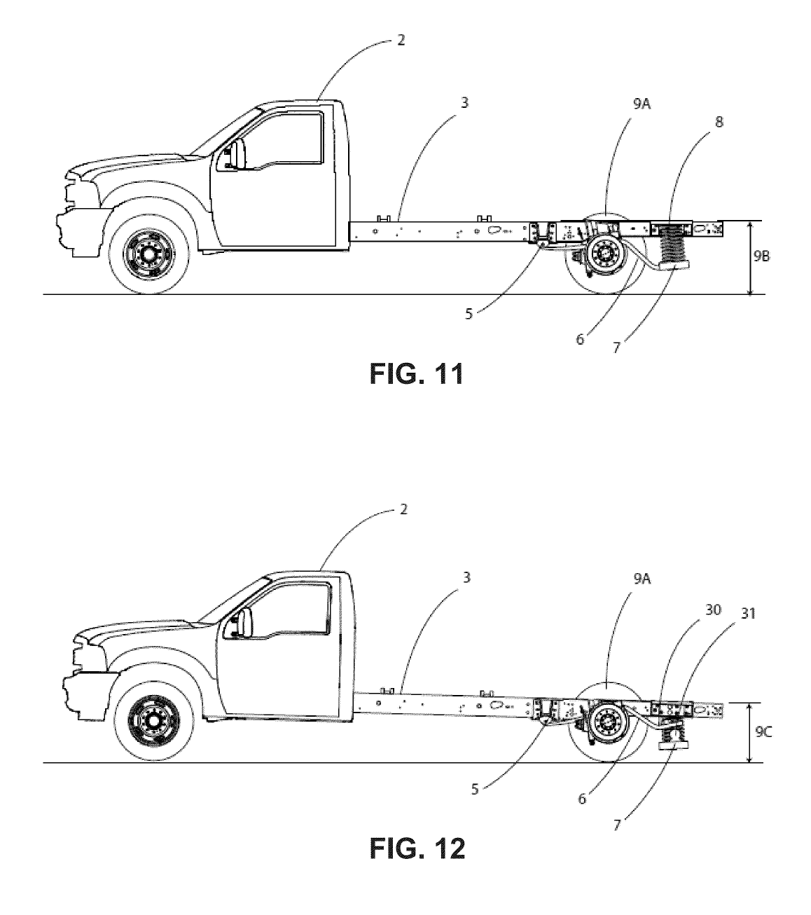

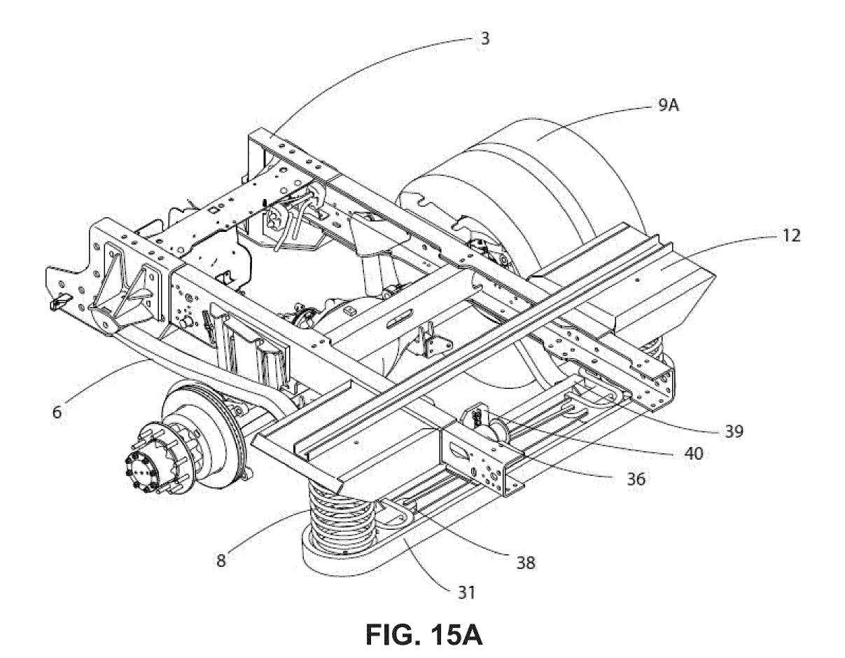

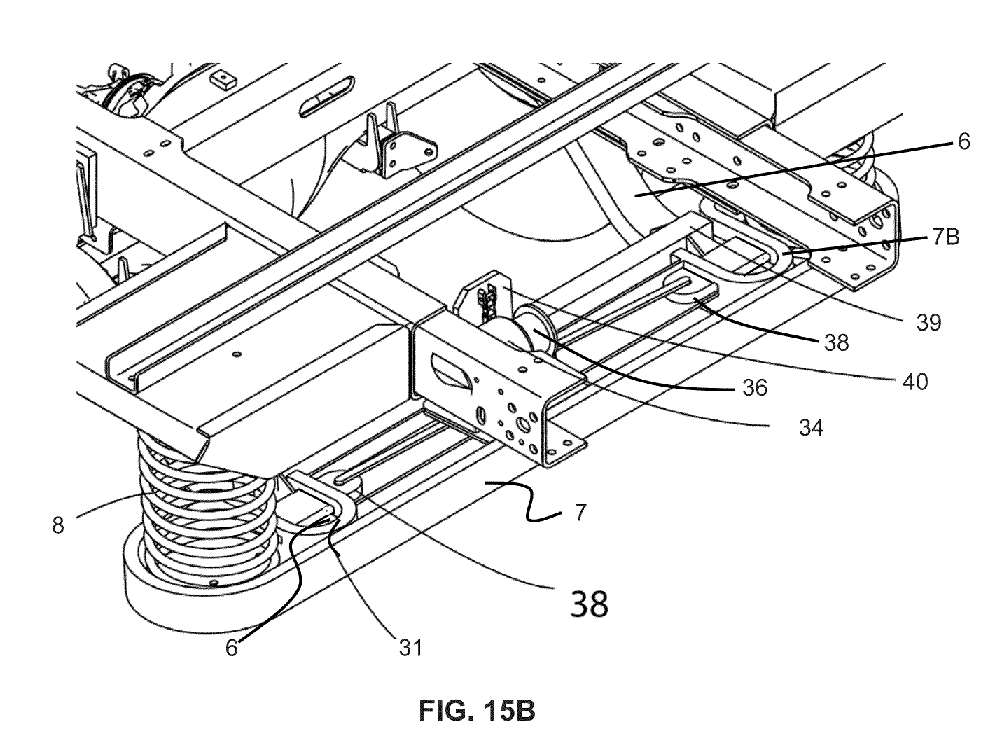

FIGS. 11-15 show various views of a modified OEM cab chassis according to another embodiment of the present invention. Referring to FIG. 15B, it can be seen that the aftmost end of each trailing arm (6) is retained within a U-shaped pocket of coil spring lower mount (7). Each end of the trailing arm is received within the lower end of the pocket (7B). The trailing arm end is vertically retained by a corresponding locking pin (38) that is slidably received within a pair of slots on either leg of the U-shape. FIG. 15 shows these locking pins (38) retained within their corresponding slots on the right and left sides. Each pin (38) is pivotally connected to a corresponding link that is pivotally connected to a rotary actuator. This rotary actuator is rotated when the main actuator (34) is at either end of its complete travel. At one end the complete travel, the pins (38) are extended laterally outward by the greatest amount (as shown in FIGS. 15A and 15B), so as to maintain the end of trailing arm (6) within the pocket. At the other end of the maximum travel of the central actuator, each of the locking pins is pulled inward, thus freeing the end of the trailing arms 6 (and their interconnection bracket (39)), and thus permitting vertical separation between spring mount (7) and the end of the trailing arms (as can be seen in FIG. 14). The insertion of the pins (38) through the U-shaped pocket occurs after central actuator (36) has provided maximum compression of each coil spring (8), such that the corresponding ends of the trailing arms are located deepest within their corresponding pockets. When the central actuator (36) is then released, coil springs (8) urge the spring mount (7) apart from the top spring mounts, and friction between the end of the trailing arms and the underside surface of the pins (38) maintains the pins (38) in position, and also captures the trailing arm ends within the pockets.

In some embodiments, the contact between lug (56) and suspension arm (6) can include a roller bearing attached to one or both of lug (56) or trailing arm (6). The use of this roller bearing (or bearings) facilitates the otherwise sliding motion between lug (56) and arm (6) when the suspension system is moving from the transport mode to the cargo-loading mode.

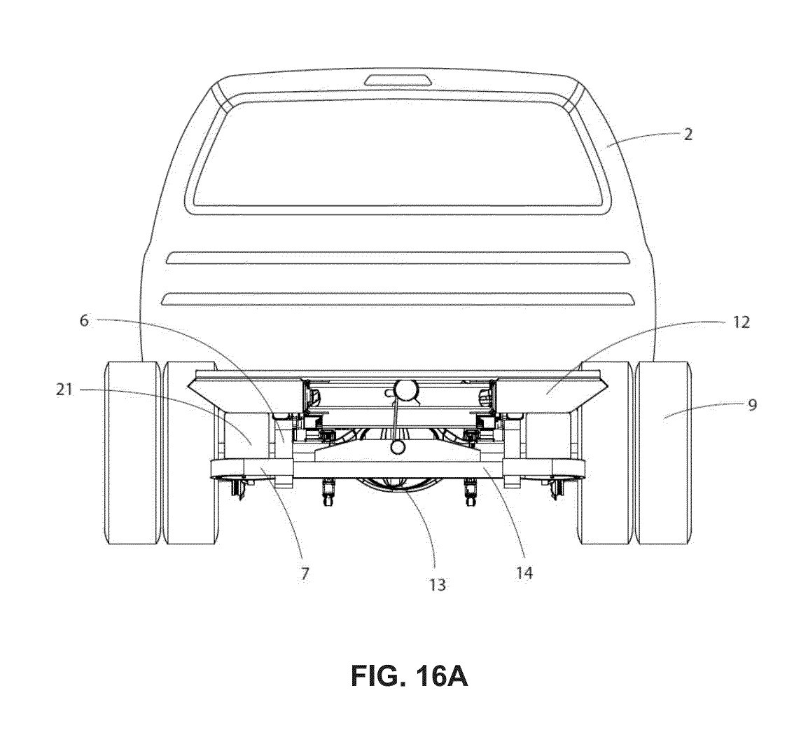

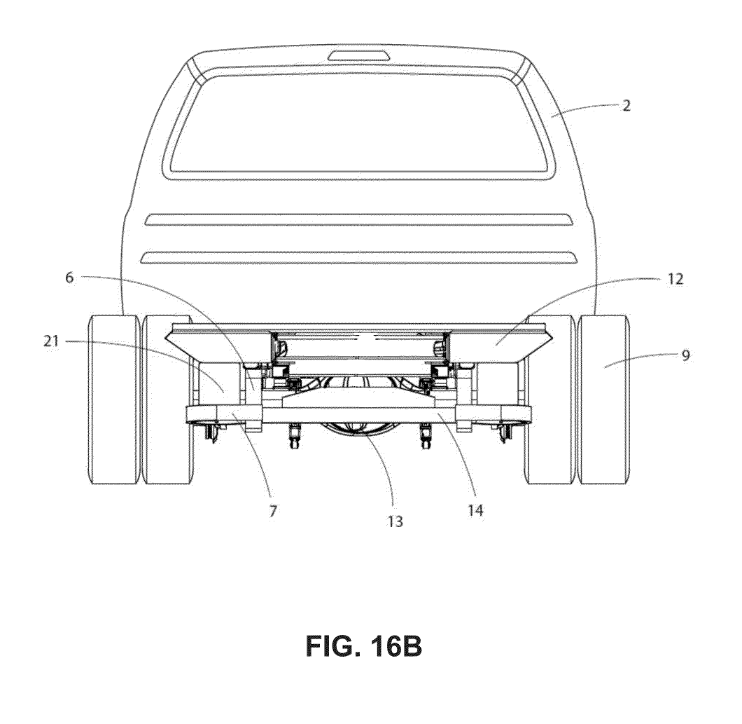

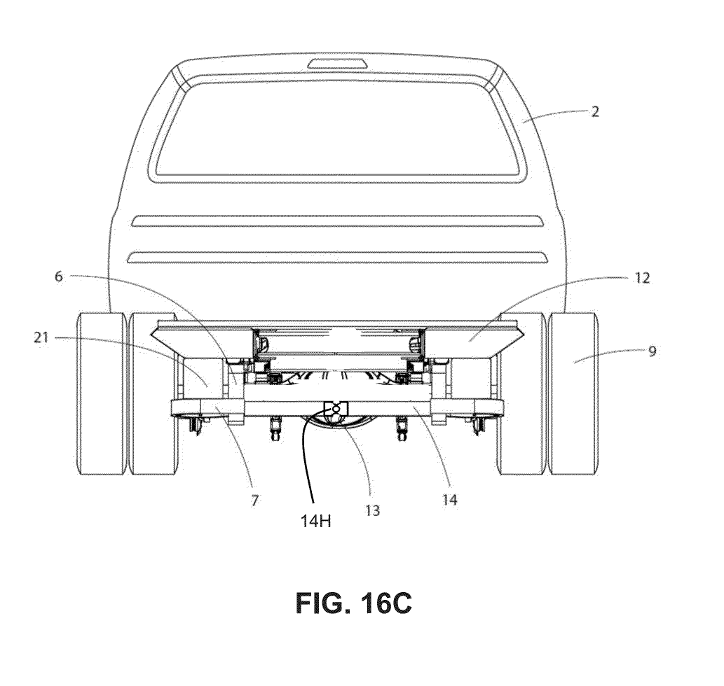

Additional embodiments of the invention provide for the release and control of the trailing arms from the coil spring carrier frame. These embodiments are best seen by viewing FIG. 11 through and including 22 (excluding FIG. 16). FIG. 12 shows a side elevation view of the vehicle having a trailing arm wide leveraged coil spring suspension wherein the coil spring carrier frame (7) has a locking mechanism (31) which upon a command signal releases the connected trailing arms (39) and (6) from the coil spring carrier frame (7) and allows for the frame (3) load floor to lower as shown in the decrease spatial dimension (30) of the connected trailing arms as they become closer to the frame (3).

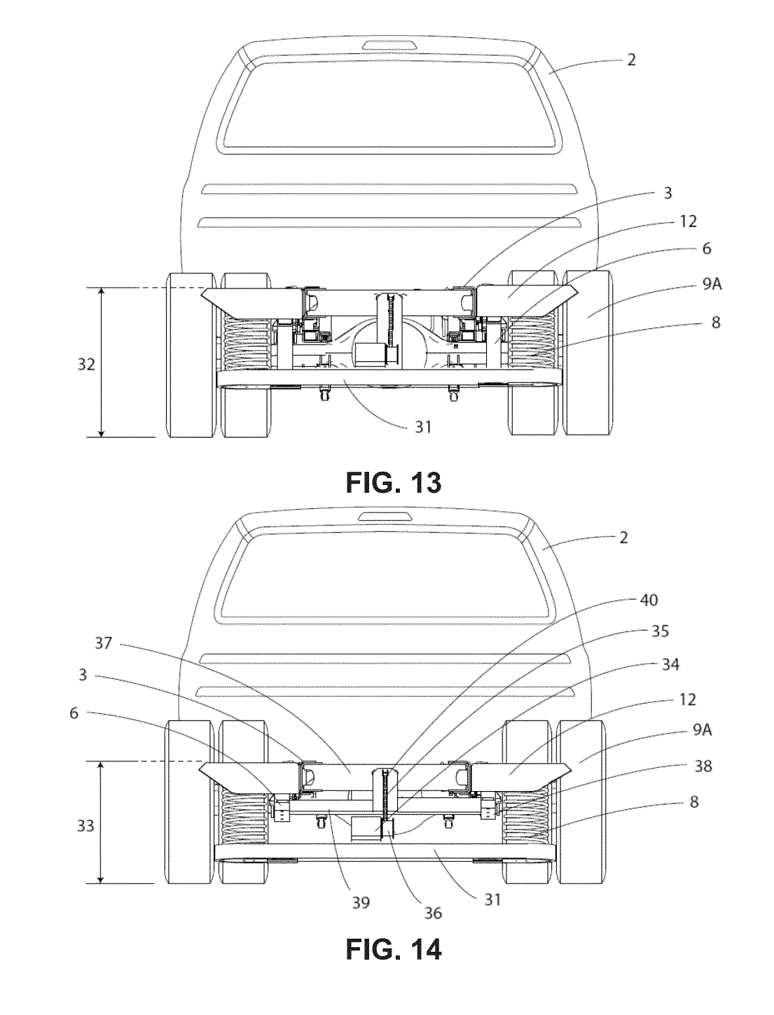

Now referring to FIG. 14, which is a rear elevation view and wherein the vehicle is in Position 2 (lowered height), a rotary actuator (34) having a drive gear (36) is mounted to the coil spring carrier frame (7) and connected by a link (35) e.g. chain, to a mount (40B) fixedly attached to a reinforced frame cross member (37) rigidly mounted to the vehicle's frame (3). The rotary actuator maintains a separation between coil spring carrier frame (7) and the vehicle's load floor (3) frame for the vehicle's Position 1 ride height (FIG. 13 (32)) and Position 2 lowered height (FIG. 14 (33)) operation.

In FIG. 15, the connected trailing arm locking mechanism (38) is actuated which releases the connected trailing arms (39).

An additional embodiment can be viewed in FIG. 16A wherein an air spring (21) is place in a wide leveraged spring base carrier frame (7). The embodiment of FIG. 16A is similar to that of FIGS. 15A and 15B, except that the coil springs have been replaced with air springs, and in some embodiments, the trailing arm-to-lower spring carrier latching mechanisms located in the spring carrier frame (14) are preferably removed. The vehicle of FIG. 16A can be placed in the cargo-loading position by deflation of the air springs (21), and if desired still further lowered by use of the actuator and winching. The cargo loading height can be further lowed by the use of sliding yaw bracket (101) (or rub block) guided within a channel of a mount 102. Further discussion of the rub block (102) and guiding channel (101) can be found within co-pending U.S. patent application Ser. No. 13/899,144, incorporated herein by reference.

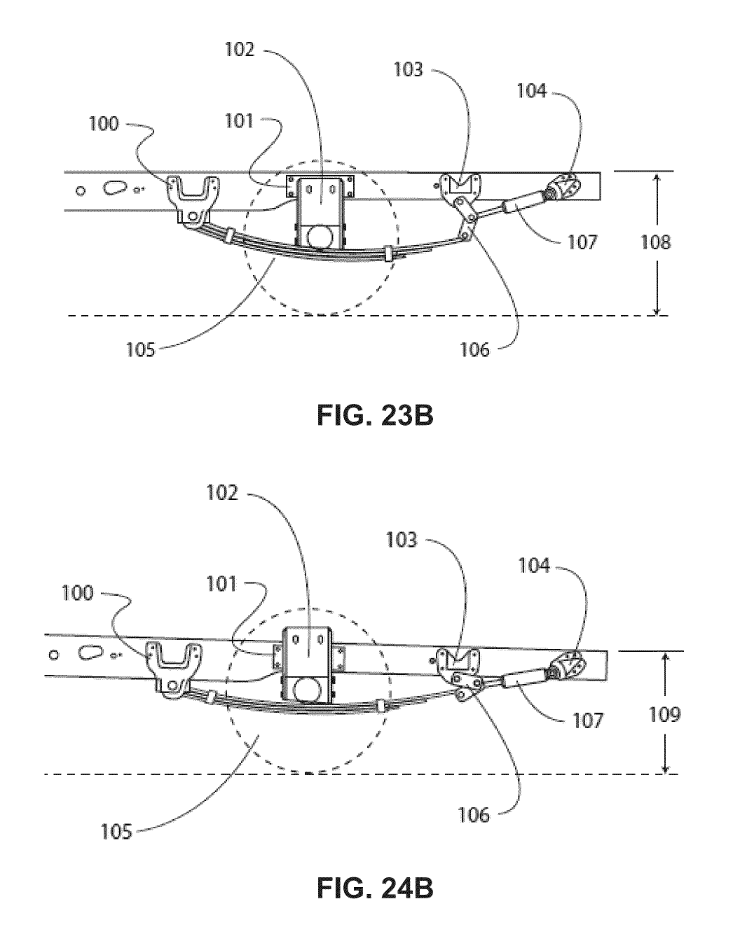

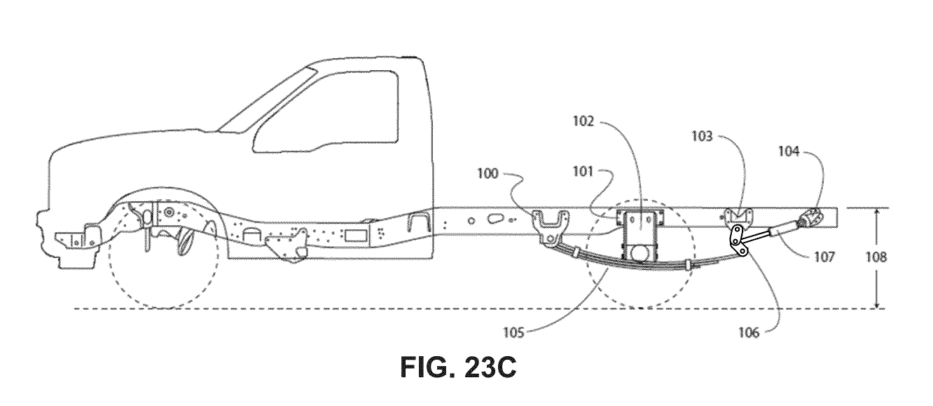

FIG. 16B shows a modification of the apparatus of FIG. 16A, in which the actuator and winching mechanism has been removed. In this embodiment, the frame is lowered to a loading position by deflation of the air springs (21), preferably in combination with the use of a rub block (102) mounted to the axle, and vertically guided within a channel (101) mounted to the frame. As seen in FIGS. 23A and 24A, the rub block permits a reduction in the height of the top of the frame, this reduced height being limited by mechanical interference among other components, such as between the rear axle and one or more structural members of the frame.

FIG. 16C shows an embodiment similar to the embodiment of FIG. 16B, except that carrier frame (14) (which as serves as the spring support for the lower end of each air spring) is no longer an integral (or fixedly attached unitary) piece, but rather comprises two pieces joined in the middle by a pivot hinge 14H. In some embodiments, the hinge action of the spring carrier 14 of FIG. 16C permits somewhat more independence of the motion of the left wheel relative to the right wheel (as compared to the embodiment of FIG. 16A). Further, the hinged configuration of FIG. 16C results in a different stress pattern within spring carrier halves (14), such that the structural aspects of each spring carrier half can be optimized for a different load path. What has been shown and described in FIG. 23C is a hinge between the right and left halves of the bottom spring carrier, permitting pivoting motion with one degree of freedom (about the longitudinal axis). However, yet other embodiments contemplate other types of pivotal connections, including pivotal connections that include multiple degrees of freedom. As one example, the connection between the right and left halves could be a ball joint suspension, similar to those used to connect vehicle wheels to suspension components. The use of such ball joints could permit pivoting in two or three degrees of freedom.

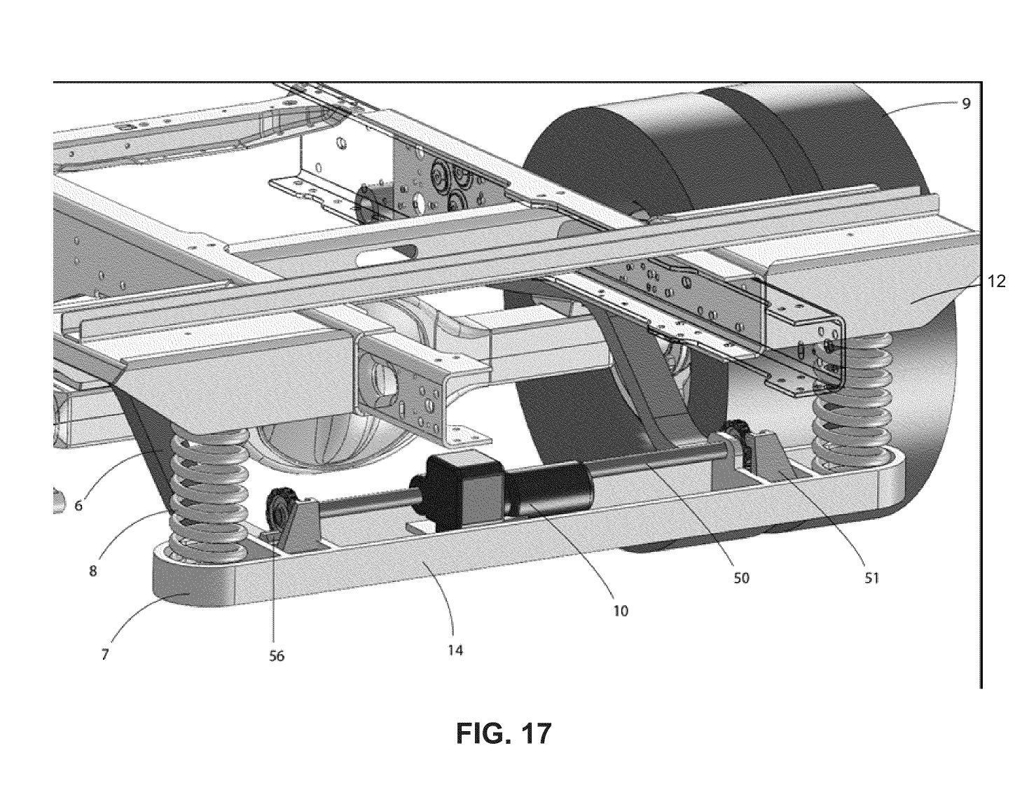

FIGS. 17-22 show the apparatus of a suspension lowering system according to another embodiment of the present invention. The vehicle includes a coil spring carrier frame (14) that includes a pair of outboard pockets, each receiving the bottom end of a respective coil spring (8). Located just inboard of the spring pockets are another pair of pockets that receive the aftmost ends of corresponding trailing arms (6). Located centrally on carrier frame (14) is a rotary actuator (10) that can rotate, after receipt of a command signal, a shaft (50) that extends laterally across frame 14, from one trailing arm pocket to the other. Located generally within the pocket, and attached at the ends of shaft 50, are drive sprockets (52). Each sprocket is connected to the end of a corresponding chain (54). The other end of the chain is mounted by way of a pivot coupling (55) to an upper mount (51). Upper mount (51) is fixedly attached to the end of the corresponding suspension arm (6).

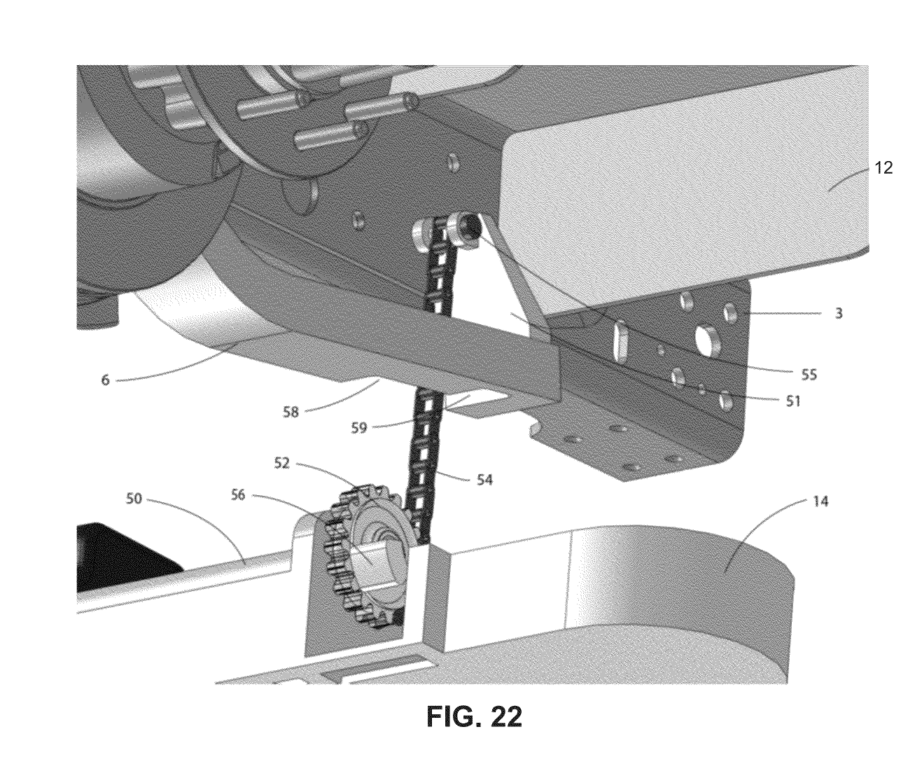

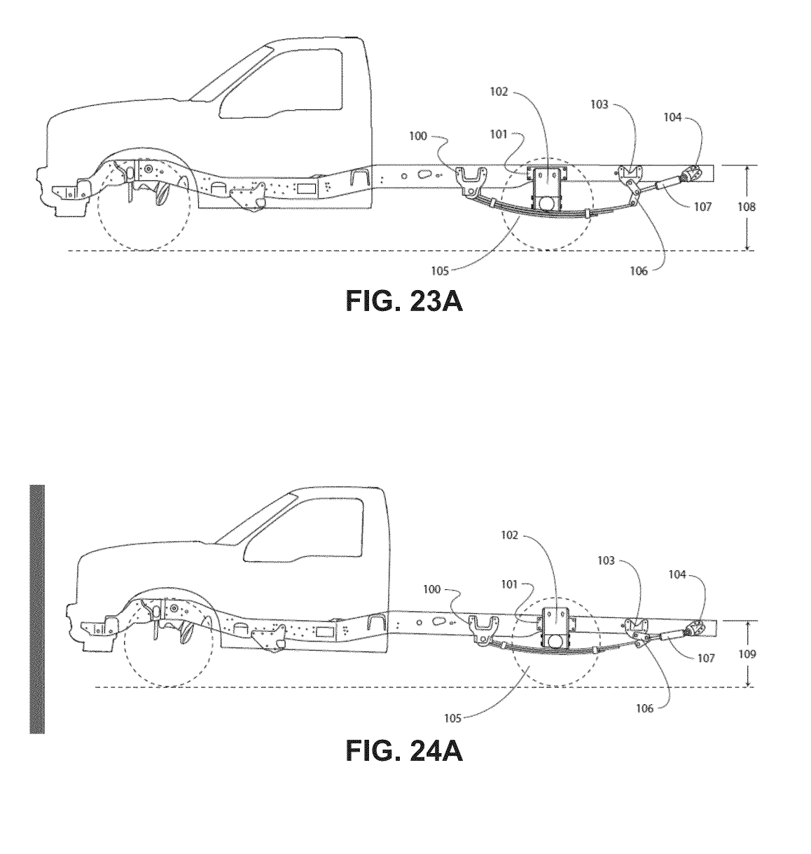

Each suspension arm (6) includes a lock cavity (58) that is adapted and configured to permit vertical passage of a drive sprocket (52). However, each drive sprocket further includes a locking lug 56 mounted at a predetermined location around the periphery of the corresponding sprocket. The combined width of lug 56 and sprocket 52 is too wide to pass through cavity 58. However, suspension arm (6) further includes a notch (59) located along the aftmost end of cavity (58), and generally in front of the front face of mount (51). Referring to FIG. 22 (in which the coil spring (8) has been omitted for clarity), it can be seen that chain (54) extends from the top of mount (51) downward to sprocket (52), passing freely through either or both of cavity (58) or notch (59). In this extended position as shown in FIG. 22, coil spring (8) is not supporting the weight of the chassis frame.

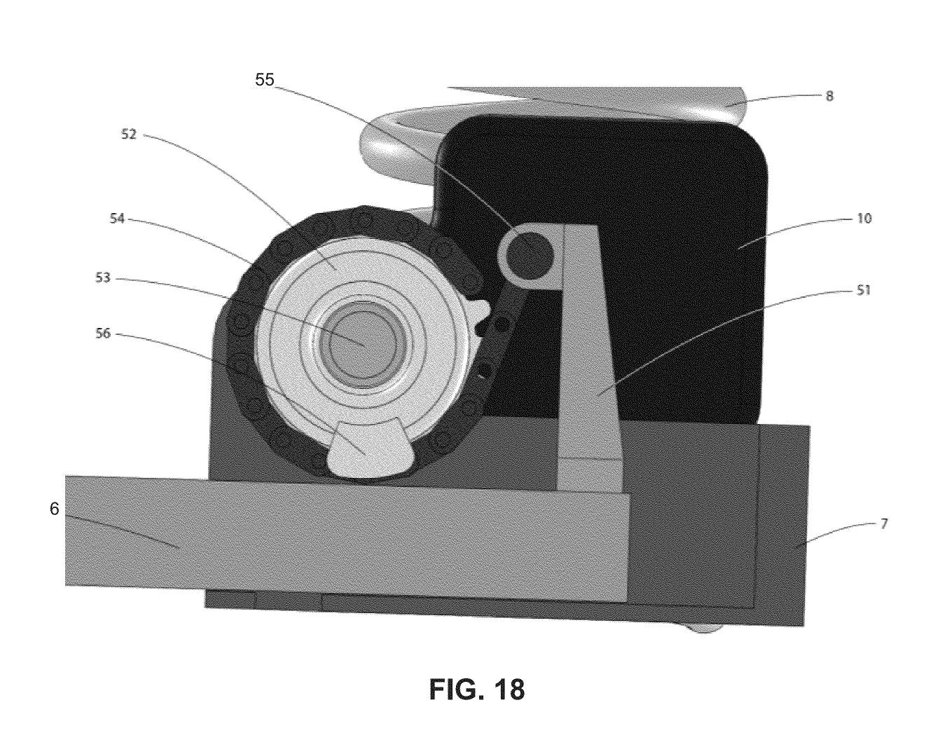

FIGS. 17, 18, 19, and 20 show the suspension system in a fully wound state. It can be seen that chain (54) is wrapped around the periphery of sprocket (52). Lug (56) is located generally above and proximate to the top surface of trailing arm (6). As shown in FIG. 8, in an overwound state, there can be a slight gap between the bottom surface of lug (56) and the top surface of arm (6). However, as the sprocket of FIG. 18 is slightly unwound (counterclockwise rotation), the top surface of arm (6) and the bottom surface of lug (56) meet, and this contact is sufficient to support the cap chassis frame during normal operation.

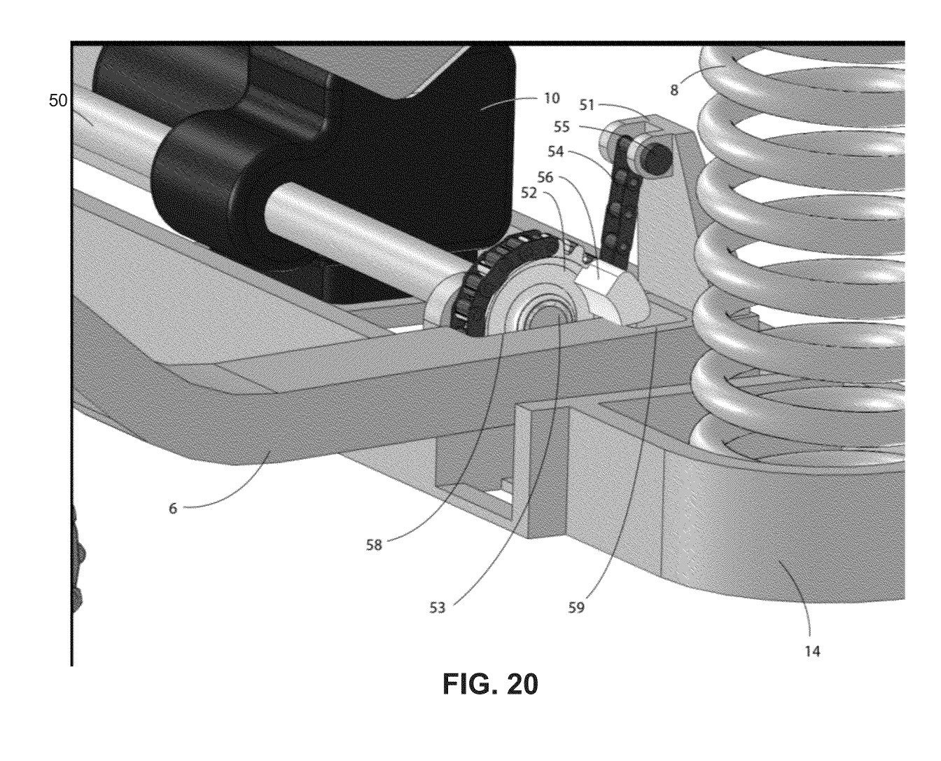

FIG. 20 shows a partial unwinding of sprocket (52) as the vehicle suspension transitions from the transport mode to the loading mode of operation. Lug (56) has rotated from its position on FIG. 18 in a counterclockwise direction by about one-third of a revolution. In so doing, mount (7) drops downward relative to suspension arm (6). However, lug (56) does not interfere with this vertical movement because of the clearance provided by notch. Comparing suspension of FIG. 23 to the suspension of FIG. 1, it can be seen that the OEM position of the leaf springs (on top of the rear axle) has been reversed, such that the leaf spring is now located on the underside of the rear axle.

It is further understood that the actuator (107) is energized (such as by electrical power or hydraulic power) to the extended position shown in FIG. 23 during normal operation of the vehicle. However, yet other embodiments of the present invention contemplate the application of a locking mechanism to the links (106) as shown in FIG. 23, such that a locking mechanism to lock in the transport height can be energized by an over travel of actuator (107), followed by a subsequent retraction. Still further in such embodiments, as the actuator extends from the retracted position of FIG. 24 back toward the normal operation position of FIG. 23, this actuation mechanism is self-energized to hold the two links (106) in a locked position, until released by the next over travel.

FIG. 24 shows that a mechanical interference between components has limited the drop height (109), such as contact between the axle housing and the frame rails (3), or contact between other components. Sliding block (102) is shown at its maximum, upward location relative to frame (3), and as guided vertically by mount (101).

Other embodiments of the invention having the connected trailing arms released from the wide leveraged coil spring carrier frame are specifically illustrated in FIG. 17 through and including FIG. 22 (excluding FIG. 16). As can be seen in FIG. 17 and FIG. 22 the rotary actuator (10) is a through-shaft drive gear motor having a sprocket (52) at each end of the drive shaft (50) which interfaces with a locking or unlocking mode with each trailing arm (6). The drive chain (54) is connected to each sprocket (52) and to a mating clevis (51) connected by a rotational bushing mount (55) of each trailing arm (6). The trailing arms (6) each have sprocket clearance pathways (58) and a sprocket lug (56) for trailing arm (6) securement to the coil spring carrier frame assembly.

Another embodiment of the invention can be viewed in FIGS. 23 and 24, wherein it shows that the leaf spring assembly is mounted to the underside of the rear drive axle (13) and coupled at the front by a pivot mount (100) to frame rail (3), and mounted at the rear to frame rail (3) by a combination of a pivoting mount (103) and a pair of brackets (106). As shown in FIGS. 23 and 24, actuator (107) is a linear actuator, pivotally coupled at one end by a mount 104 to frame 103, and pivotally coupled at the other end to a pivot connection that is shared with each of the two links (106). A first link (106) is further pivotally coupled to spring mount (103), and the other link member (106) is pivotally coupled to the end of the leaf spring. As actuator (107) retracts, the pivotal connection of the actuator shared with both links is pulled backwards, thus reducing the distance between the rear pivoting of the leaf spring, and the leaf spring coupling bracket 103.

As the rear end of the leaf spring is brought toward frame rail 3 by the retraction of actuator (107), it can be seen that spring mount 102 slides vertically and is guided vertically by bracket (101), which is coupled to frame rail (3). Therefore, in the lowered position as seen in FIG. 24, the top surface of wheel (105) extends further above the top surface of frame rail (3), when the rear suspension is in the compressed position. The rear hangar assembly supporting the rear of the leaf spring is moveable by an actuator (107) through a pivotable arrangement of a pair of pivotally coupled links (106) for providing a means to lower the vehicle's frame (3) directly downward to the rear drive axle, significantly lowering the vehicle's rear load floor deck, allowing for a shorter length loading ramp to be utilized when loading and unloading a van type truck, e.g. U-Haul self-movers truck.

Now referring to FIGS. 23 and 24, a relocated under axle leaf spring (105) is shown that is connected to a leaf spring front pivot joint (100) and to a rear leaf spring pivotable movable joint (106). The rear pivotable movable joint (106) is connected to a bracket (103) that is mounted to the vehicle's frame and load floor (3) FIG. 1. Attached to the rear pivotable joint is a universal type jointed hydraulic cylinder (107). At the vehicle's ride height Position 1 FIG. 23 a vertical height reference dimensional space (108) of the top of frame (3) FIG. 1 to the ground is provided. At the vehicle's lowered height Position 2 FIG. 24 a vertical reference dimensional space (109) of the top of the frame (3) FIG. 1 to the ground is provided. At the vehicle's ride height (Position 1) FIG. 23 (108) the pivotable movable joint (106) is placed into a “vehicle transport” mode which extends the distance between the leaf spring and the vehicle's frame to provide the vehicle's load floor with its normal ride height position. The pivotable joint (106) through its connected interaction with hydraulic cylinder (107) is capable of being passively locked in the ride height position (109) which allows the leaf spring and OEM shock absorber (not shown) to manage the jounce and rebound activity of the suspension through the vehicle's transport activity; and/or, the pivotable joint (106) can remain active through its operation with the hydraulic cylinder (107) which assists the leaf spring suspension throughout the vehicle's transport mode. During the vehicle's Position 2 FIG. 24 lowered load floor mode, the pivotable moveable joint (106) is adjusted through the hydraulic cylinder (107) to allow for the load floor FIG. 1 (3) to be lowered wherein the leaf spring assembly FIG. 1 (24) (leaf spring shown mounted above axle (13)) which is coupled to the rear drive axle FIG. 1 (13) is now in a closer proximity to the load floor.

FIG. 23C shows an alternate embodiment to the apparatus of FIG. 23A. In FIG. 23C the transport height of the modified chassis cab assembly is achieved by extending actuator (107) to its maximum length, and thus “bottoming out” actuator (107). It can be seen that the transport height (108) of the vehicle of 23C is the same as the vehicle of 23A. However, in FIG. 23C, the pair of links have been driven past the position of FIG. 23A, to the position of FIG. 23C (i.e., going through the straight-line alignment of the two links). The embodiment of FIG. 23C has a lowered height or cargo-loading dimension (109) similar to that of FIG. 23B, except that actuator (107) and the pair of links (106) are adapted and configured such that the actuator is in the fully compressed position, and likewise bottomed-out in the cargo-loading position. Therefore, apparatus of FIG. 24A and the apparatus of FIG. 23C can operate in the transport height and cargo loading positions without hydraulic power. However, hydraulic power (or other such as electrical or pneumatic power) is provided to transition the suspension from one position to the other

FIGS. 25-35 present various shaded CAD representations and line drawings of a suspension according to another embodiment of the present invention. Various embodiments of these inventions can be used with vehicles such as trucks and buses that utilize a ladder frame and incorporate leaf spring rear suspensions. However, various other embodiments pertain to suspensions for any kind of vehicle, using any type of rear suspension. Still further, those of ordinary skill in the art will appreciate that various concepts and features disclosed herein are applicable to front suspensions of vehicles, and still further to any apparatus incorporating a spring in which it is useful to operate the apparatus with the spring being attached to the apparatus at either of two different locations.

FIG. 25 shows a portion of a vehicle having a leaf spring suspension. The apparatus shown and discussed in FIGS. 25-35 are attached to the front pivot joint of a rear leaf spring, and further for a leaf spring located on the driver's side of the vehicle. However, those of ordinary skill in the art will recognize that the invention is not so limited, and this is but a single example.

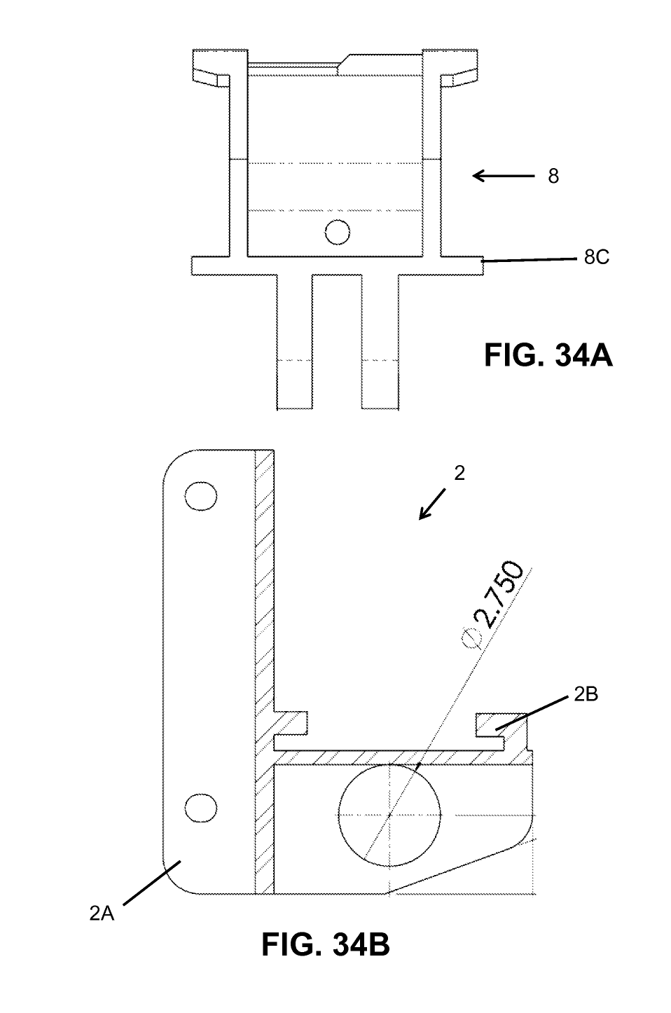

FIG. 25 shows portions of a kit 17 attached to the pivot connection 3A of a leaf spring 4, the leaf spring being part of an OEM chassis assembly. The pivot joint 3 of leaf spring 4 is pivotally coupled to a sliding member or bracket 8. Bracket 8 includes a pair of generally opposing projections 8c. These projections are received within a complementary-shaped channel 2b, both of which can be seen in FIG. 34B. The coaction of the flanges 8c within the channel 2b permits sliding of sliding member 8 relative to a mounting bracket 2.

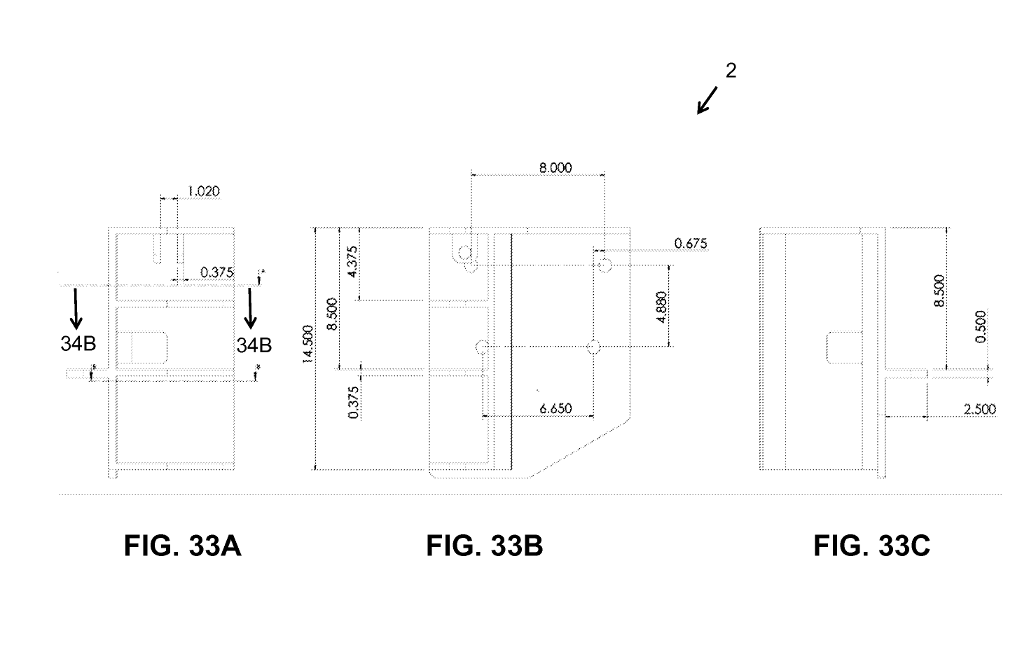

In some embodiments, mounting bracket 2 is attached to the side of an OEM ladder frame member. As best seen in FIG. 33B, mounting bracket 2 incorporates a four bolt pattern best seen in FIG. 33B. Preferably, this 4 bolt pattern is substantially the same as a four bolt pattern already provided on the OEM ladder member. Therefore, attachment of bracket 2 to the OEM ladder member is simple and straight forward. However, bracket 2 can be attached to the ladder member in any manner. Still further, various embodiments of the present invention contemplate the sliding action of a bracket 8 relative to the OEM ladder member itself, with the ladder member incorporating a guiding channel similar to channel 2b and further including provisions for mounting of one end of an actuator, as will be discussed later. Mounting bracket 2 further includes a lateral flange best seen in FIGS. 33A and 33C (on the outboard side of these figures). This ledge preferably fits under and abuts against the underside of the ladder frame member. Therefore, this projecting ledge provides a load path for the loads transmitted between the suspended wheel and the frame.

Referring again to FIG. 25, it can be seen that mounting bracket 2 incorporates an uppermost coupling that provides pivotal attachment to one end of an actuator 12. The other end of the actuator is pivotally coupled between a pair of bosses 9 extending out of sliding bracket 8. Mounting bracket 2 further includes three stiffening bosses that provide for the transmission of loads from sliding bracket 8. For the specific bracket shown in FIG. 25, each of these three stiffening bosses include a central aperture through which actuator 12 is placed.

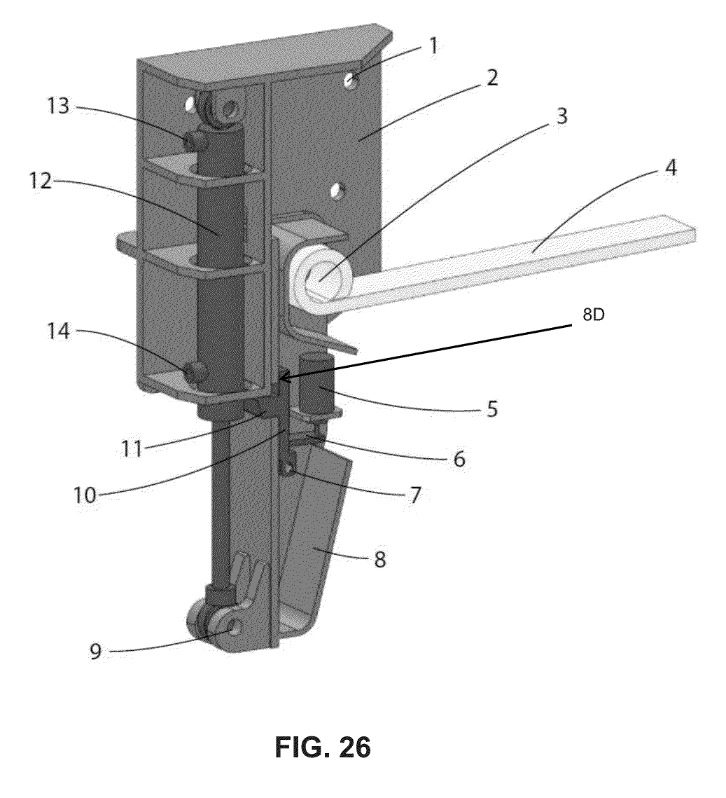

FIG. 26 shows the view of kit 17 of FIG. 25, except with one of the structural side members of the sliding bracket 8 having been removed to show internal components. It can be seen that the pivot point 3 of leaf spring 4 is pivotally coupled to adjacent side panels of bracket 8. This pivotal connection is surrounded in part by a U-shape structural wall that is preferably welded to the panel faces.

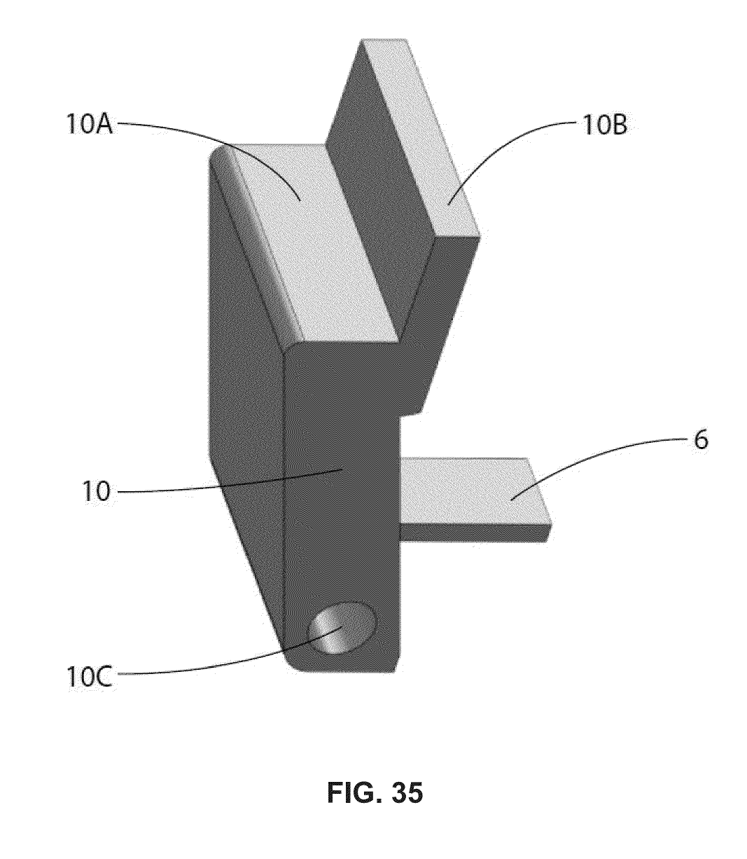

Sliding member 2 further includes a second actuator 5 that is supported by sliding bracket 8. In one embodiment, actuator 5 is a solenoid-type actuator, and upon being energized with a voltage projects a core piece 6 out toward a latching or locking device 10. Referring briefly to FIG. 35, locking mechanism 10 preferably includes a pivot joint 10c, an actuating surface 6, a locking load surface 10a, and a pivot arm 10b.

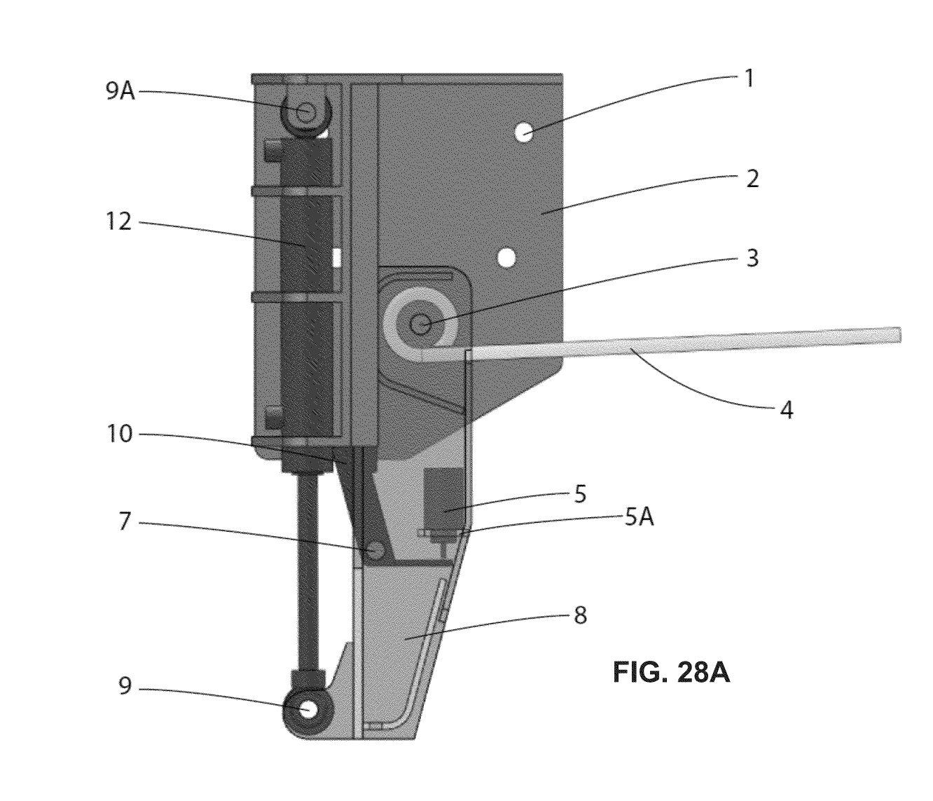

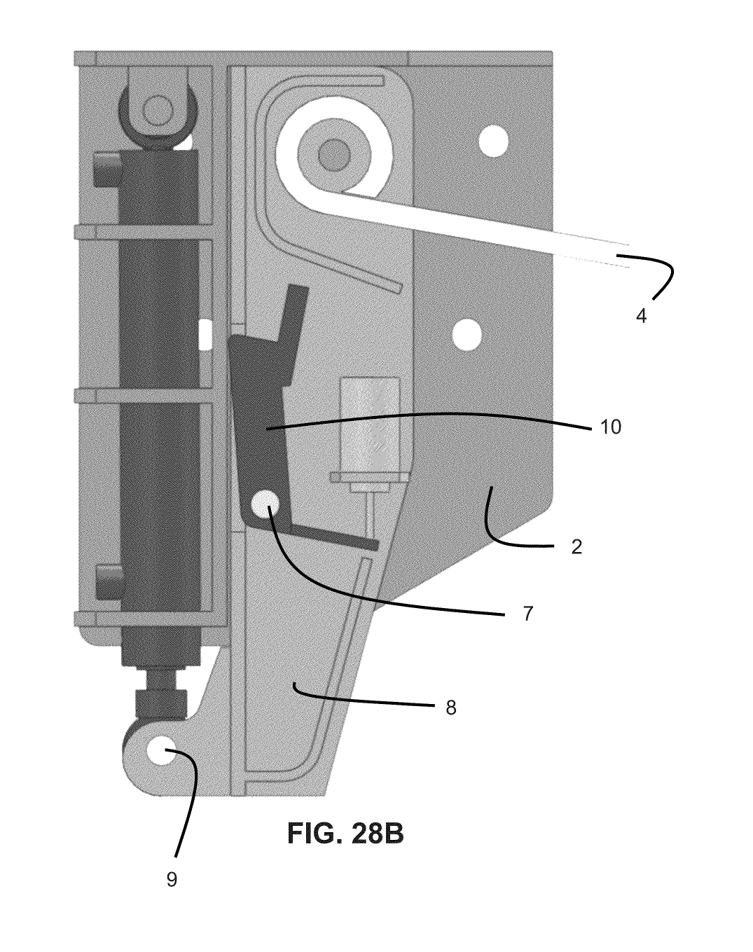

Referring again to FIG. 26, it can be seen that locking member 10 is pivotally coupled to sliding bracket 2 by a pivot point 7. As shown in FIG. 26, the locking surface 10a extends out of an access window 8D formed in a wall of bracket 2. FIG. 26 shows that locking surface 10A extends out of this window, such that the top surface 10A is in abutting relationship with the underside of a ledge of mounting bracket 2. This abutting relationship is best seen in FIG. 28A. It can be seen that the loads imparted by the wheel to the spring (such as the load resulting from the weight of the vehicle) places the locking arm 10B of lock mechanism 10 generally in compression between the top face 10A that abuts against a ledge of mounting bracket 2 and the inner surface of pivot connection 10C acting against pivot pin 7. Preferably, locking arm 10B is oriented substantially in alignment with the sliding action of bracket 8 relative to bracket 2, thereby placing the arm generally in compression.

FIGS. 25, 26, 27A, and 28A show sliding bracket 8 at a first position relative to mounting bracket 2, such that the leaf spring pivot joint 3 is at substantially the same location as the pivot joint of the OEM leaf spring. By arranging the geometry of brackets 2 and 8 in this manner, the vehicle will exhibit handling qualities substantially the same as the OEM vehicle, since the location of the leaf spring has not been altered by the application of kit 17 to the OEM ladder frame chassis and suspension.

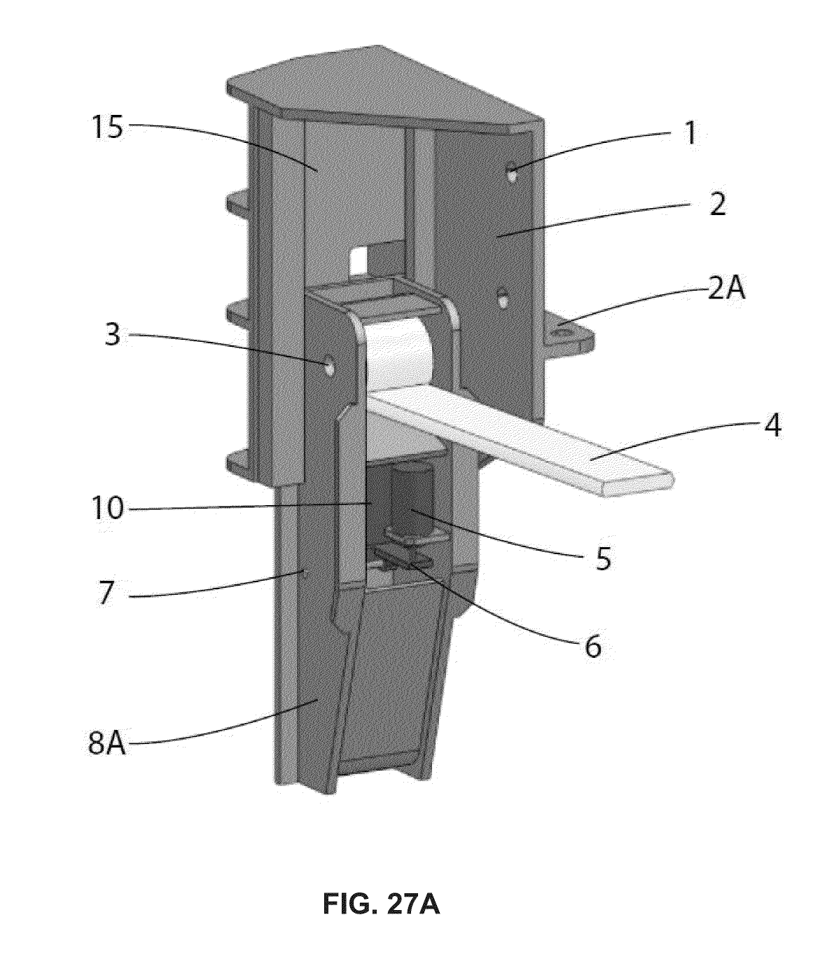

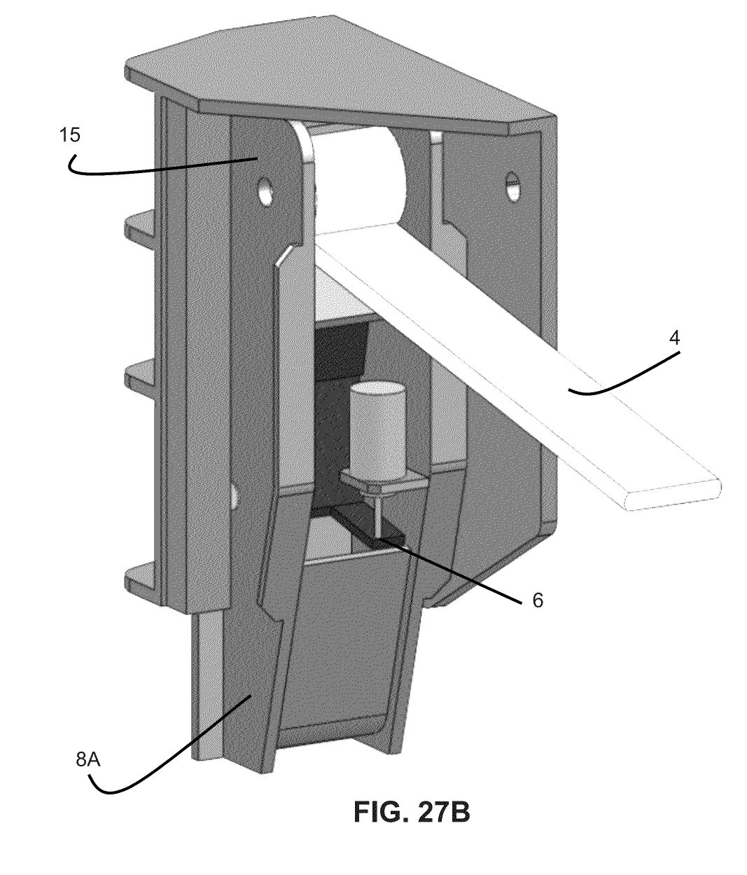

FIGS. 27B and 28B show perspective and side views, respectively, of kit 17 when leaf spring 4 is placed at a second position. It will be appreciated that the pivot joint 3 of leaf spring 4 has moved toward the four bolt pattern OEM attachment holes, such that pivot joint 3 is now shown higher relative to the ladder member of the OEM chassis. Said differently, in considering that leaf spring 4 is still supporting the weight of the suspended wheel, it is the ladder frame chassis that has actually moved downward for the second position shown in FIGS. 27B and 28B. Therefore, the floor of the vehicle is lower in the second position, relative to the OEM level of the first position.

FIG. 28B shows that the plunger or core of actuator 5 has pressed downward against arm 6 of locking mechanism 10, which will pivot locking surface 10A out of engagement with an underside of bracket 2. Since locking mechanism 10 no longer abuts against a surface of mounting bracket 2, sliding bracket 8 is free to slide upwards as shown in FIG. 28B (which if also to be considered as downward motion of bracket 2 as installed in the vehicle). FIG. 28B shows that the topmost surfaces of sliding bracket 8 are in abutting relationship with the underside of a portion of bracket 2. This abutting and interfering relationship establishes a final location of leaf spring pivot 3 in the second position.

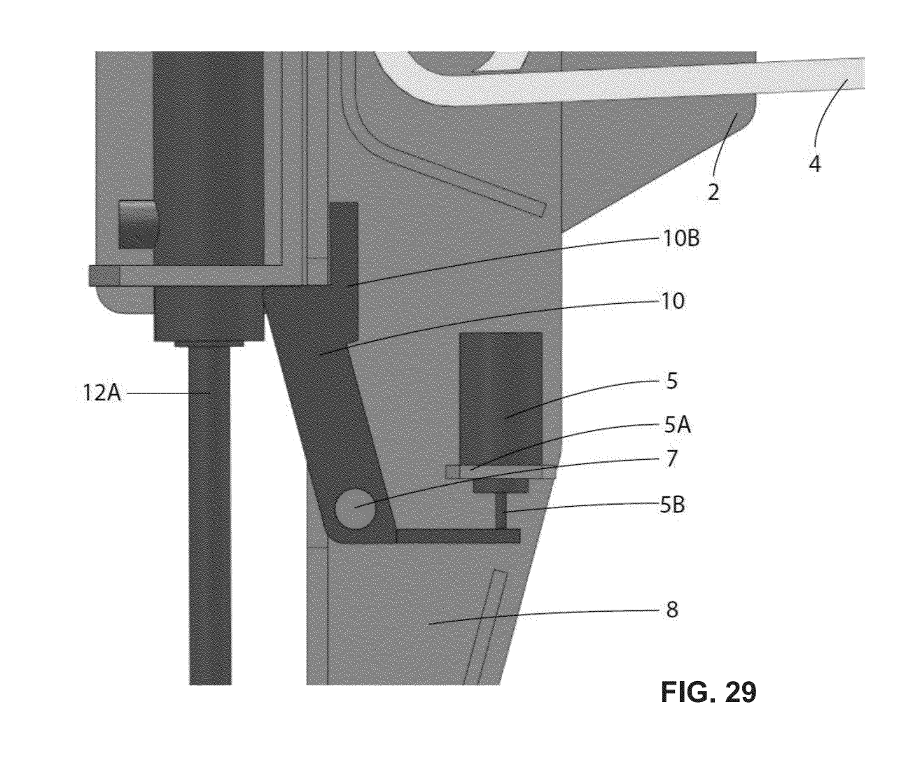

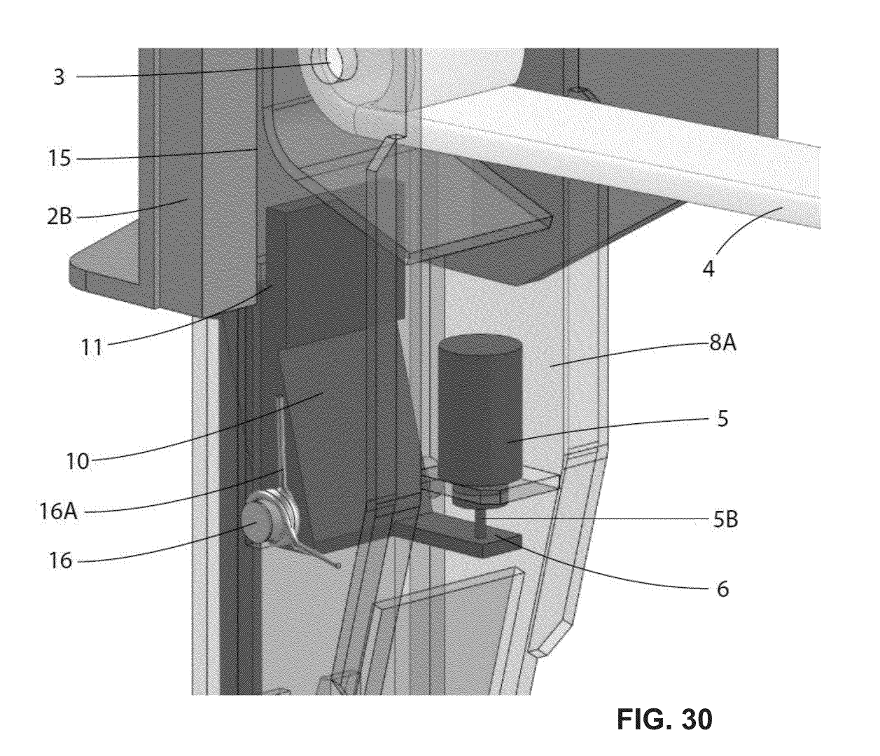

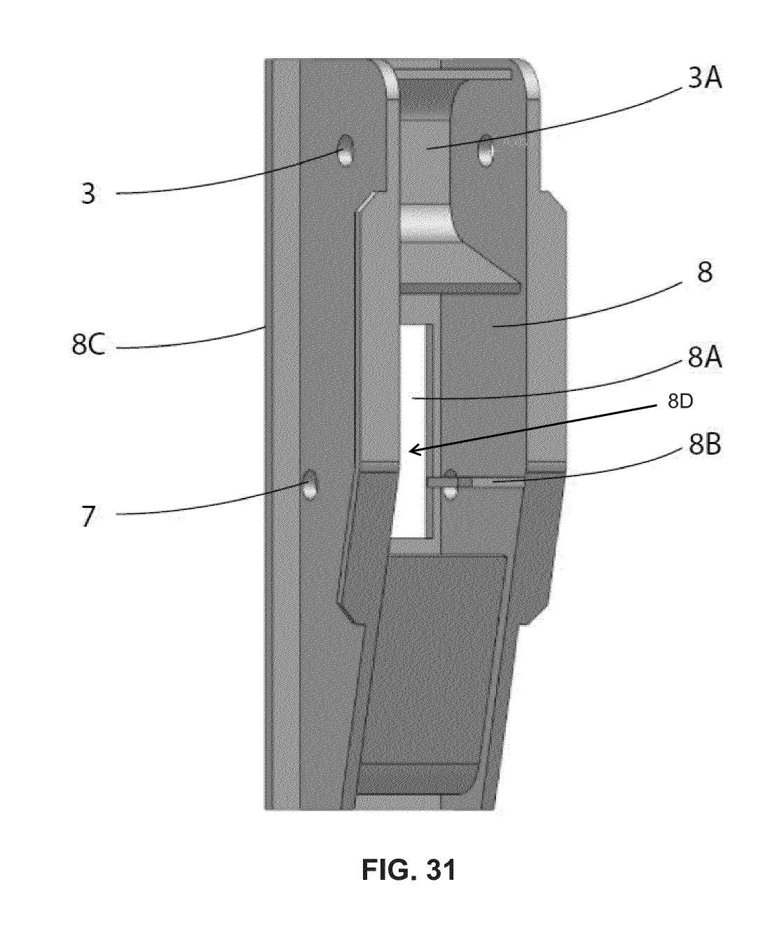

FIG. 30 shows an alternate construction in which a torsional spring 16 is connected to pivot 7. The action of torsion spring 16 biases locking mechanism 10 toward counterclockwise location (with regards to FIG. 29). This biasing urges locking surface 10A to extend through the window 8A (as best seen in FIG. 31), and move to a position where locking surface 10A abuts against mounting bracket 2 so as to establish the first position. Therefore, the locking assembly shown in FIG. 31 is biased toward a position 1 lock by the action of biasing spring 16 (although in some embodiments the weight distribution of lock 10 is such that the weight of the locking arm extending past pivot 7 establishes a gravity biasing toward the locked first position). Further, the de-energized state of solenoid 5 (or any other type of actuator used in this same manner) is normally retracted or to not interfere with this biasing of spring 16. Still further, in some embodiments the end 5b of the core of solenoid 5 is pivotally connected to arm 6, and further the core of solenoid 5 is internally spring biased upward, such that in the de-energized state the solenoid actively biases to move arm 10a toward the first position.

Referring to FIG. 29, it can be seen that the compression forces from the weight of the vehicle acting on arm 10B result in a static frictional force that must be overcome before locking arm 10a can move away from the first position and permit sliding motion toward the second position. However, in some embodiments, locking mechanism 10 is adapted and configured such that the extension force of solenoid 5 is not sufficient to overcome this sliding friction. Therefore, if the sliding bracket is in the first position the action of the solenoid cannot by itself allow sliding motion of the bracket. Instead, actuator 12 must be energized and extended in these embodiments so as to remove the compressive load from arm 10B. When this compressive load is removed, the remaining frictional forces in the pivoting motion of arm 10 can be overcome by the extension force of solenoid 5.

In these embodiments, actuator 12 is adapted and configured to provide a range of extension that is greater than the difference between the first and second positions. When the suspension is in the second position, such as that seen in FIG. 28B, the extension of actuator 12 causes sliding arm 8 to move downward relative to bracket 2 such that arm 10B will pivot and drop into window 8a (under the operation or the biasing forces previously discussed). In some embodiments, kit 7 further includes an electrical switch, the state of which is dependent upon the position of arm 10. After actuator 12 has fully extended and arm 10B has pivoted into window 8A, the state of this switch is changed, indicating to the user (or a control system) that it is acceptable to permit actuator 12 to retract. After a small amount of retraction, the sliding motion of bracket 8 stops when the arm 10A abuts against the underside of bracket 2.

In some embodiments, actuator 12 is a hydraulic actuator. Application of hydraulic pressure causes extension of actuator 12, and removal of that pressure permits the action of gravity to result in retraction of actuator 12. Although the use of a hydraulic actuator has been shown and described, it is appreciated that any kind of actuator can be used, including electric and pneumatic actuators.

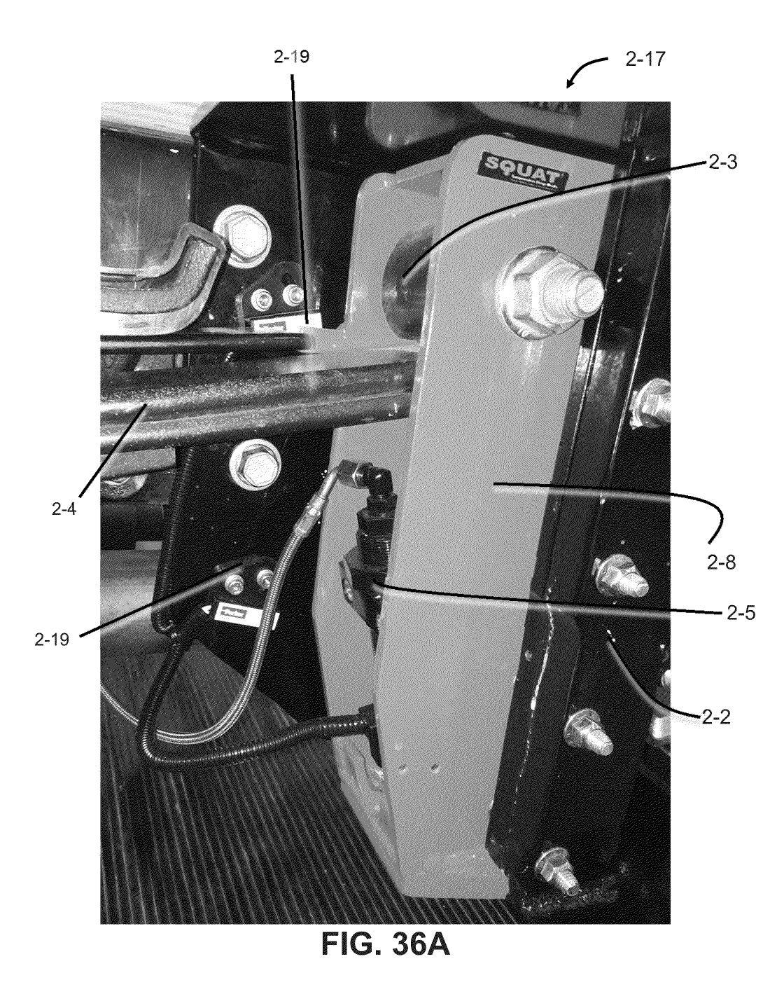

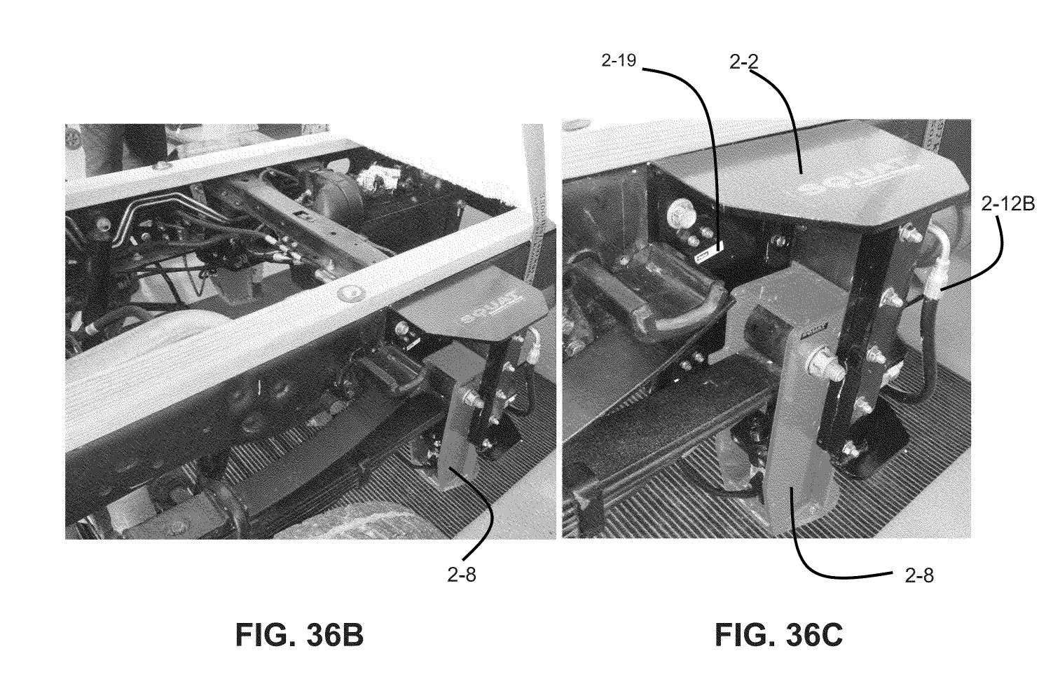

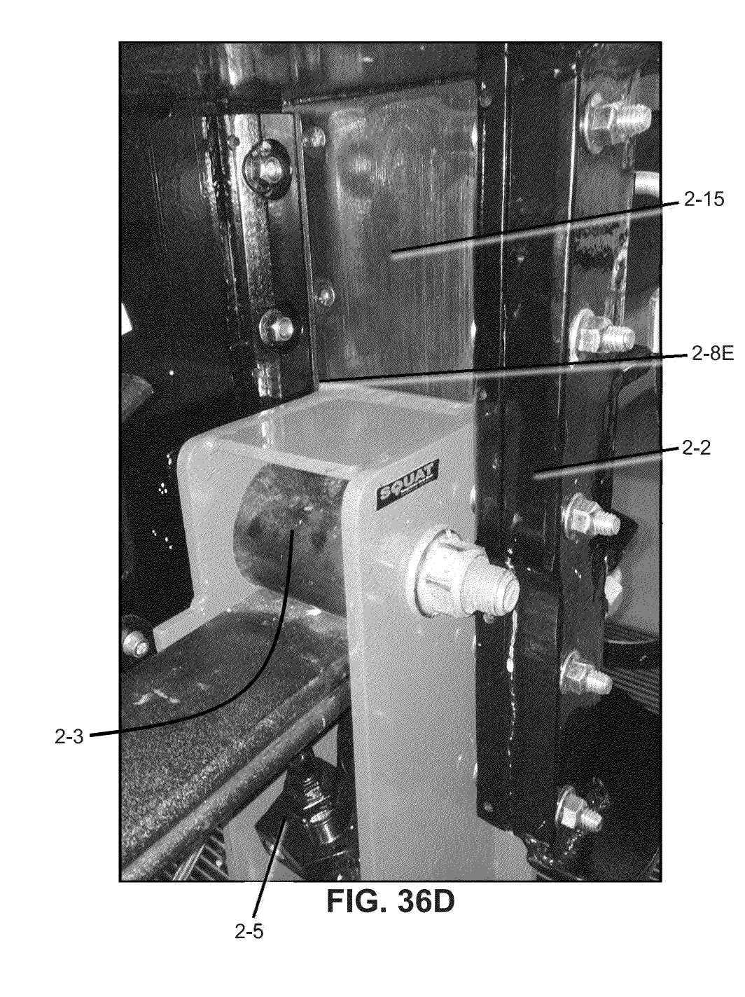

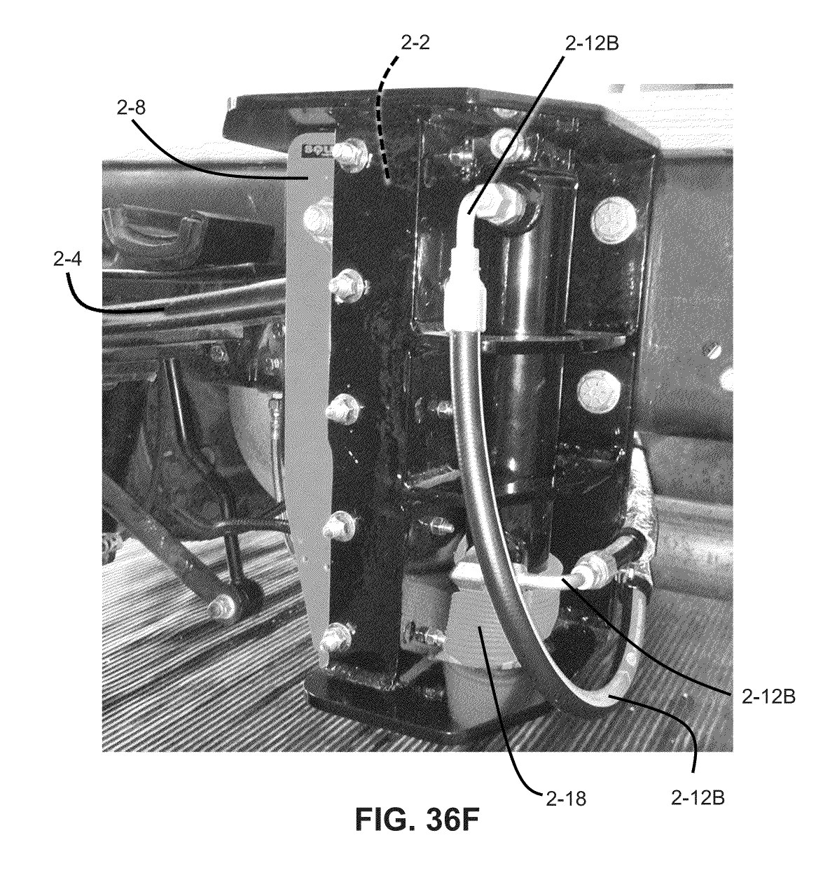

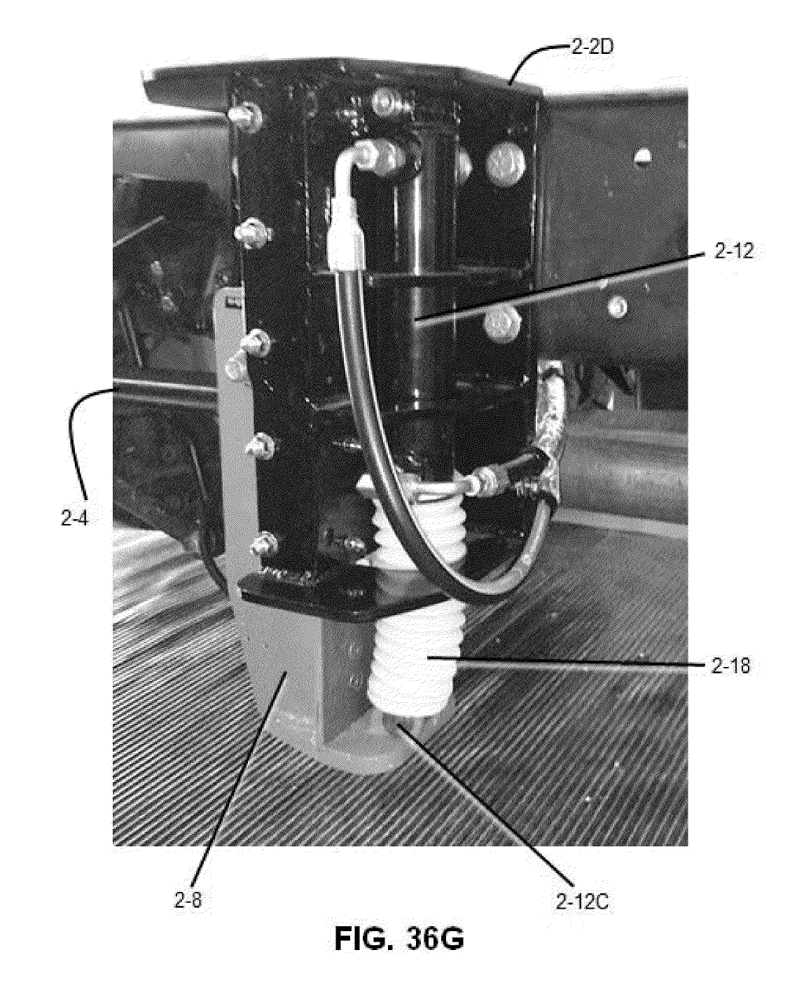

FIG. 36 show an OEM ladder frame vehicle that incorporates a suspension modification kit 2-17 similar to the kit shown and discussed with regards to FIGS. 25-35. Several of the aspects pertaining to the embodiment of FIGS. 25-35 and the embodiment of FIGS. 36-51 will now be discussed, although those of ordinary skill in the art will see still other differences apparent from a review of these two sets of figures, and still further differences that are logically and inherently inferable from these two sets of figures.

FIGS. 36A-36G are black and white photographic representations of a kit 2-17 installed on an OEM ladder frame chassis. The various element numbers used in FIG. 36 are each prefaced with a “2” that precedes the element number. It will be recognized that these element numbers are comparable to the element numbers used in FIGS. 25-35, except for those differences shown and described herein and logically inherent.

FIG. 36A is a side view of a support bracket 2-2 that is preferably bolted to a main longitudinal rail of the OEM ladder frame chassis. The right and left main longitudinal members can be seen in FIG. 36B, in which the members have bolted on top of them a 2×4 length of wood (which provides an interface for a dead weight being supported by the frame). Referring to FIG. 36D, sliding bracket 2-8 and bracket 2-2 are adapted and configured to coact and guide the sliding motion of bracket 2-2 in a direction. Bracket 2-2 includes a T-shape track that guides within it a guiding feature 2-8E of a sliding bracket 2-8. Pivotally coupled to sliding bracket 2-8 is the forward termination 2-3 of an OEM leaf spring 2-4.

There is a sliding interface between brackets 2-2 and 2-8, and this sliding interface includes a block 2-15 of an ultrahigh molecular weight organic material that provides a low friction sliding interface, as well as a wear-resistant interface. It is understood that block 2-15 can be coupled to either of brackets 2-2 or 2-8, with FIG. 36D showing block 2-15 being captured on a surface of bracket 2-2.

FIGS. 36B, 36C, 36D and 36G each show the actuator 2-18 in an extended position. This is generally the same representation as shown in FIGS. 25, 26, 27A, and 28A. In this extended position, the termination of the leaf spring (as best seen in FIG. 36D) is located at the same location as in the OEM configuration. FIGS. 36A and 36F show the actuator 2-12 in a retracted position, comparable to the arrangement shown in FIGS. 27B and 28B. With the actuator fully retracted, the termination 2-3 of leaf spring 2-4 (as seen in FIG. 36A) is located closer to the top surface of the main longitudinal member of the ladder frame, which thereby places the top surface of the ladder frame closer to the ground (since the leaf spring 2-4 supports a wheel that remains in contact with the ground regardless of whether the actuator is extended or retracted).

FIG. 36F shows a protective boot 2-18 that generally surrounds the rod end of actuator 2-12, this boot being shown in a compressed state. FIG. 36G shows boot 2-18 in an extended state compatible with the extended state of actuator 2-12.

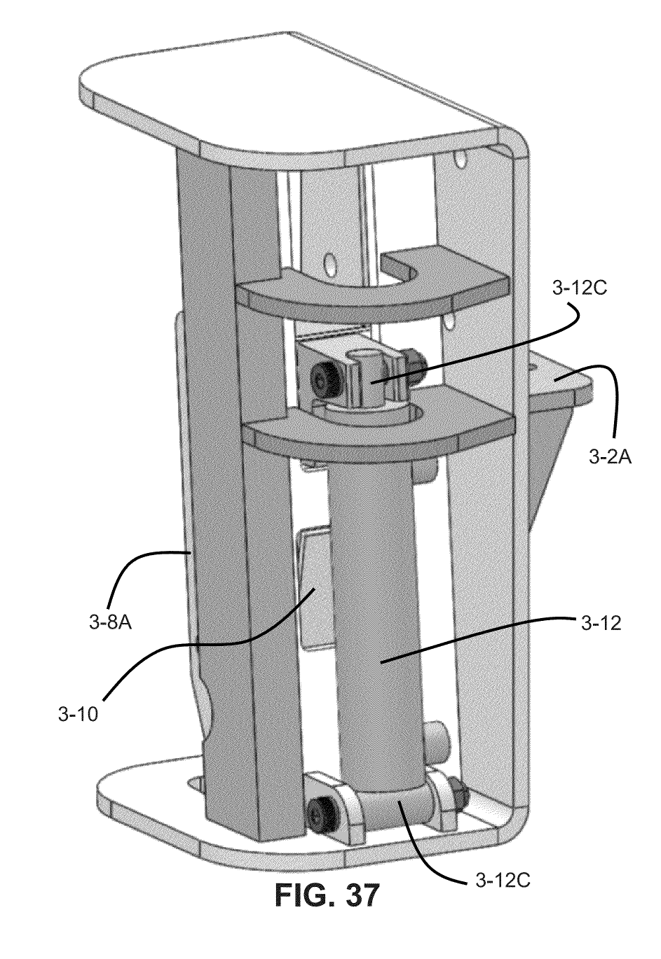

FIGS. 37-51 show drawings of a suspension kit 3-17 for an OEM ladder frame chassis with a leaf spring. This kit, similar to the kits X-17 described herein, provide for the adjustment of the height of the vehicle. With one position of an actuator, the vehicle is placed at the OEM ride height, and the termination of the leaf spring is placed at the OEM spatial location. When the actuator is in other position, the top surface of the chassis is brought downward, closer to the termination of the leaf spring. In this second position, the aftmost end of the vehicle is lowered toward the ground, from which position it is easier to load and unload cargo.

The configurations shown in FIGS. 37-51 are substantially similar to the configuration shown in FIGS. 25-35, except that the operation of the actuator is reversed. In FIGS. 37-51, an extension of the actuator rod from the actuator cylinder places the chassis top surface at the lower, cargo-loading height. Likewise, in the retracted position of the actuator (in which the rod is substantially or completely protected within the cylinder) the chassis is maintained at its OEM ride height. However, it is understood that in yet other embodiments the ride height position of the chassis established by kit X-17 can be higher or lower than the OEM ride height.

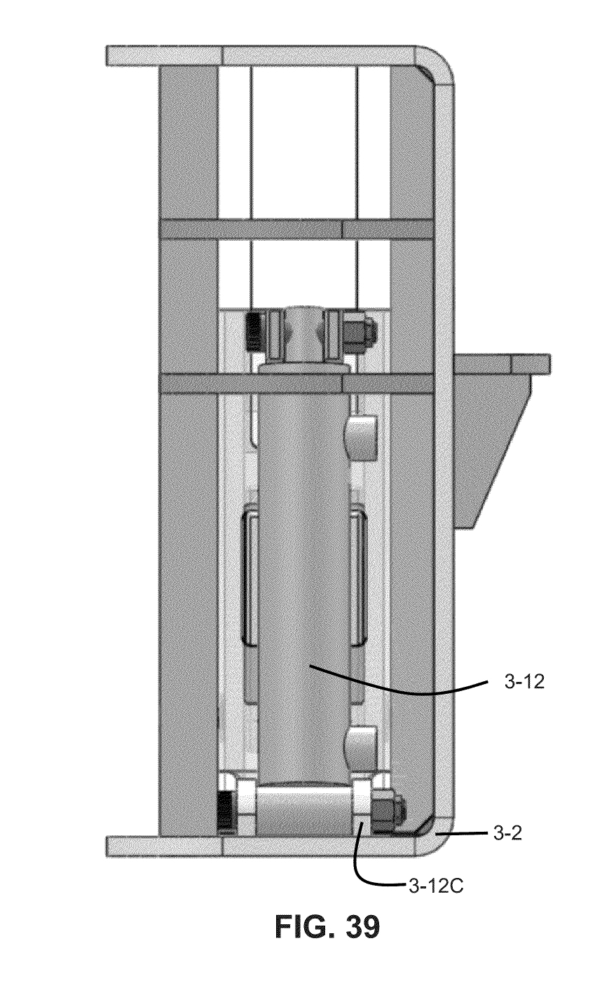

FIGS. 37-41 show the actuator 3-12 in the retracted position. In one embodiment, the rod end of the actuator is pivotally coupled to sliding bracket 3-8 by a topmost pivotal attachment 3-12C. The bottommost end of the actuator is pivotally coupled to support bracket 3-2, as best seen in FIG. 39.

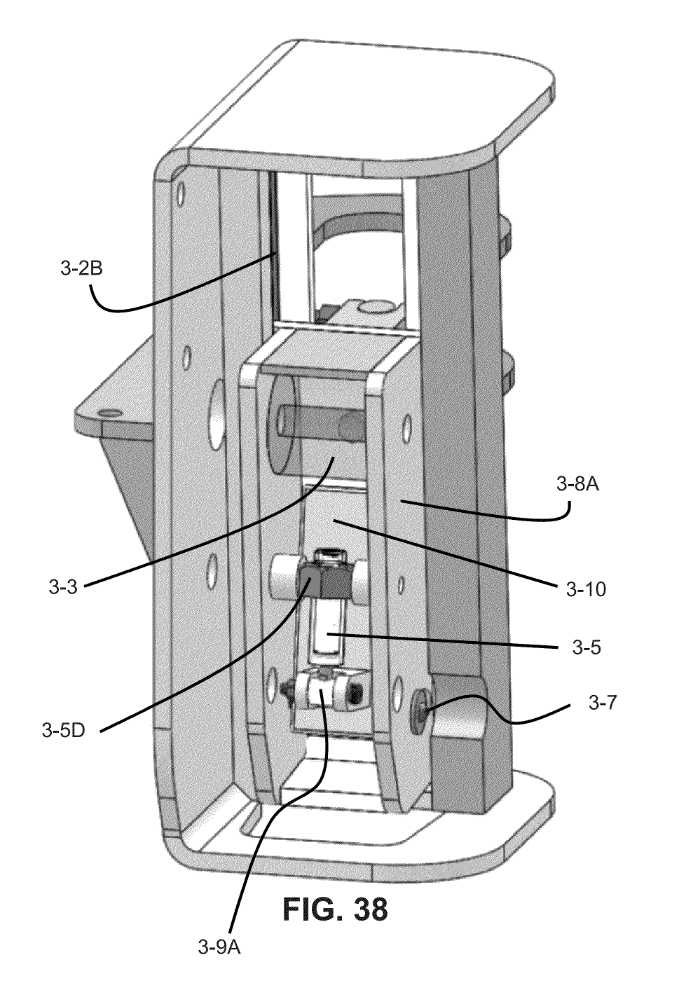

Kit 3-17 includes a latching mechanism in which there is a spring-loaded hydraulic actuator and other moving parts that are all located on sliding assembly 2-8. Referring to FIGS. 38, 40, 47B and 48B, it can be seen that hydraulic actuator 3-5 and latching pivot arm 3-10 are both preferably part of slider assembly 3-8. As sliding assembly 3-8 moves relative to bracket 3-2 along guided track GT, lever 3-10, actuator 3-5, leaf spring termination 3-3, and the top pivotal connection 3-12C of rod 3-12A all move together in unison. Leaf spring termination 3-3, actuator 3-5, and latch arm 3-10 are generally contained between and protected by the structural side members 3-8F of the sliding bracket. In this manner, the leaf spring termination and the latch actuator are protected by side members 3-8F against damage from rocks or other debris kicked up by the vehicle's wheels.

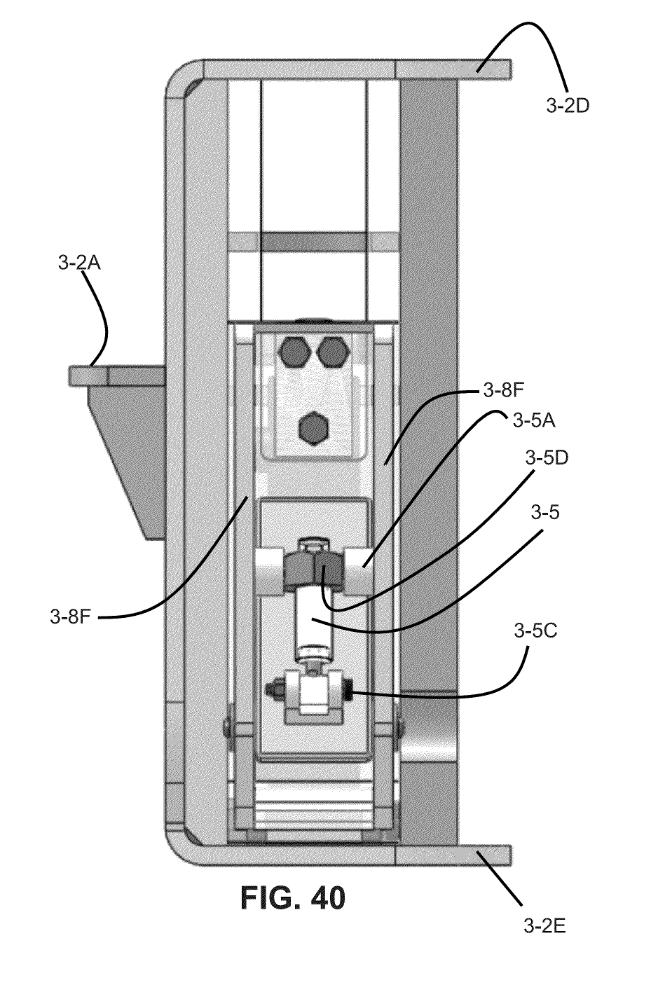

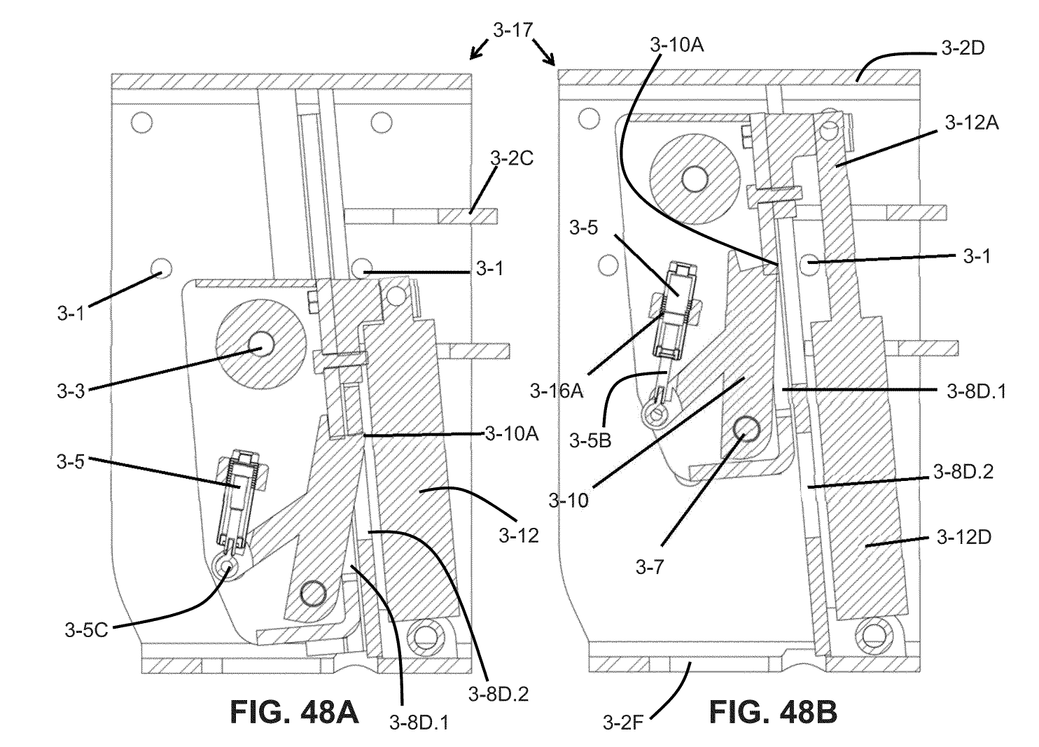

FIGS. 38 and 40 show that actuator 3-5 is attached to side members 3-8 by a pair of endboard and outboard pillow blocks, with a hex nut 3-5D attached to inner facing surfaces of the pillow blocks 3-5A. The spring loaded hydraulic actuator 3-5 is threadably coupled to the cylindrical body of actuator 3-5, thus permitting adjustment of the location of the actuator. The rod 3-5B is coupled by a pivotal attachment 3-5C to pivot arm 3-10 (as best seen in FIG. 48B). The extension and retraction of actuator 3-5 pushes and pulls, respectively, on the pivotal attachment 3-5C, so as to thereby pivot arm 3-10 about pivot joint 3-7 (as best seen in comparing FIG. 48A to FIG. 48B).

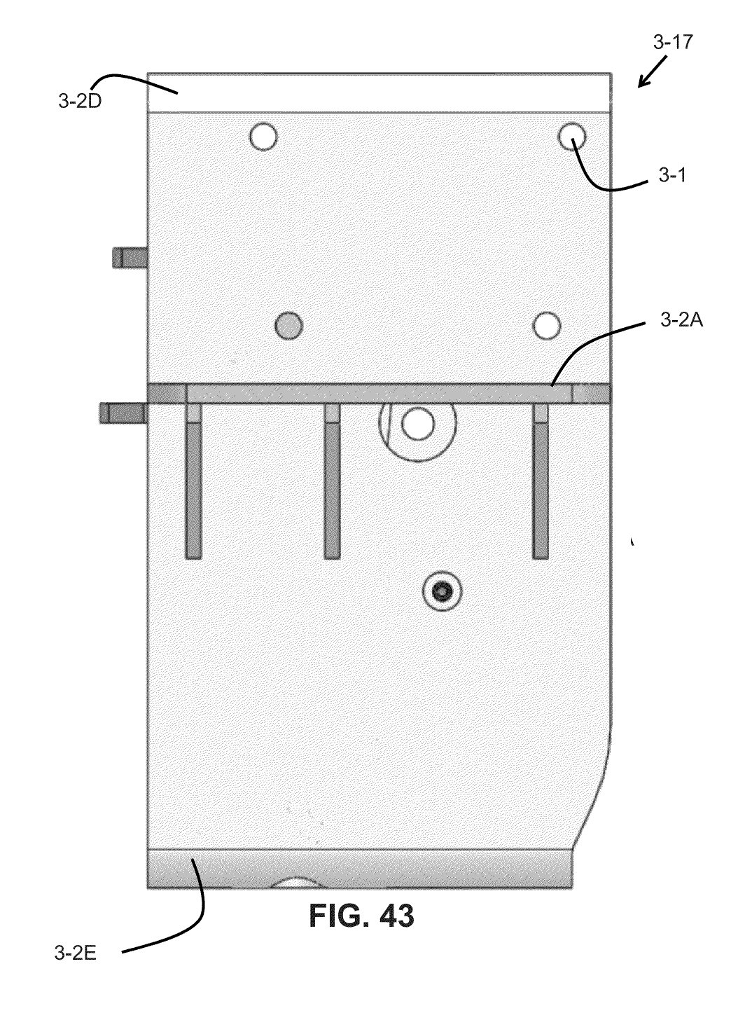

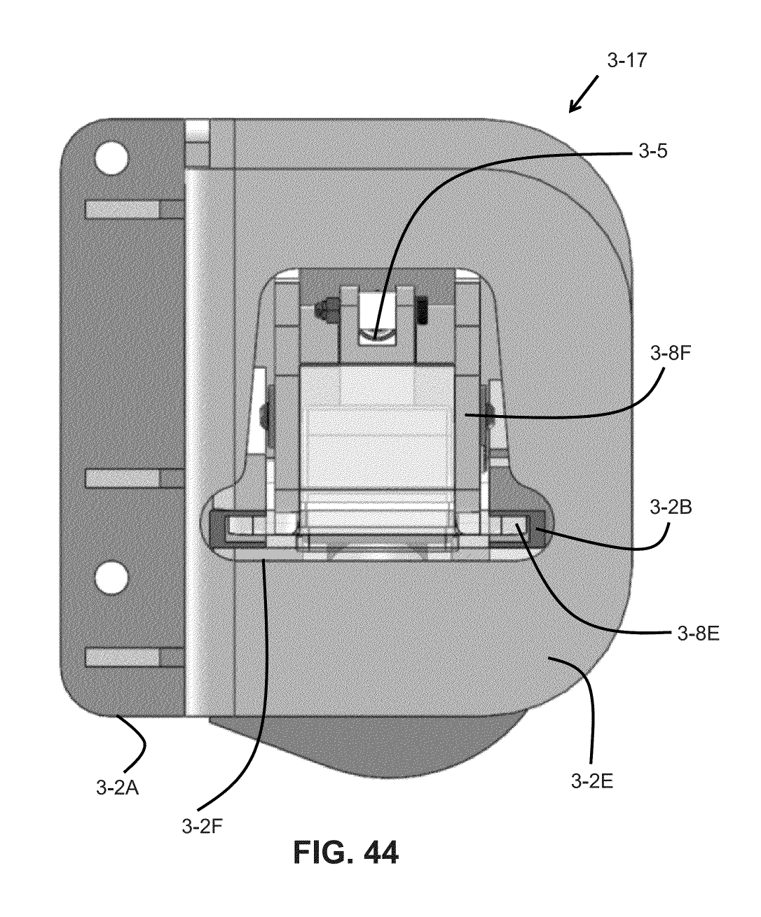

FIGS. 43 and 44 show inside and bottom views, respectively, of the actuator kit 3-17. FIG. 43 shows a surface 3-2A of mounting bracket 2 that abuts the underneath surface of a longitudinal frame rail of the OEM frame. This supporting ledge (also shown in FIGS. 39 and 40 provide support of the kit to the frame that is in addition to the support provided by attachment by bolts through the OEM-provided attachment locations 3-1.

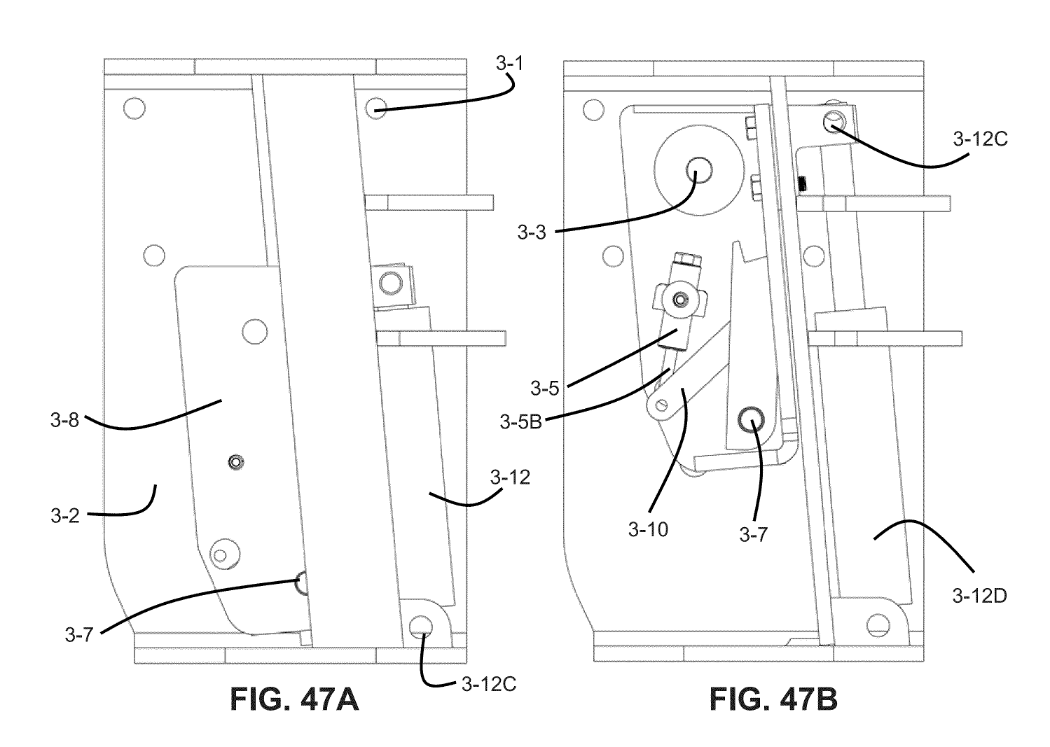

Support bracket 3-2 further includes a top plate 3-2D. The top surface of plate 3-2D (best seen in FIGS. 45A, 45B, 43, and 51) has a top surface that is generally flush with the frame top surface FTS when kit 3-17 is installed. The underside of top plate 3-2D serves as a redundant safety stop that limits the movement of actuator 3-12 relative to bracket 3-2 in the event of a failure of the actuator attachments 3-12C (as best seen in FIGS. 47B and 48B. Preferably, the fully extended position of actuator 3-12 is established by one or more mechanical stops within cylinder 3-12D that limit the maximum extension of rod 3-12A.

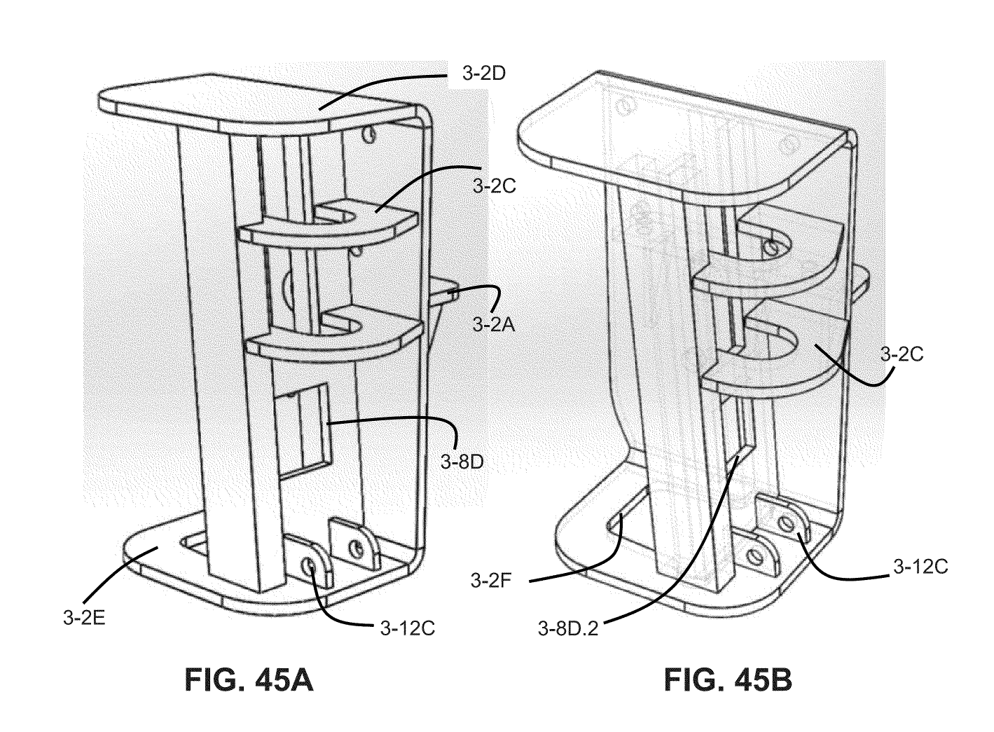

Referring to FIGS. 44, 45A, and 45B, it can be seen that bracket 3-2 further includes a bottom plate 3-2E that defines an aperture 3-2F. Bottom plate 3-2E provides structural support for the various members that support the transfer of loads from leaf spring 3-4 to sliding assembly 3-8, to bracket 3-2, and into the OEM frame. Plate 3-2E provides stability and strength to the bottom actuator connections 3-12C. Further, plate 3-2E defines an aperture 3-2F that is adapted and configured to facilitate installation of kit 3-17 (as best seen in FIG. 44). Aperture 3-2F permits the slider assembly 8 to be installed through the bottom of bracket 3-2, after bracket 3-2 has been attached to the OEM frame. It can be seen that the shape of aperture 3-2 preferably fits closely to structural side members 3-8F.

FIGS. 47 and 48 present side-by-side comparisons of the kit 3-17 in both the actuator retracted first position (spring at OEM spatial location) and extended position (top of chassis lowered toward spring; cargo-loading second position). FIG. 47 show several external views, whereas FIG. 48 show corresponding cross sectional views.

FIGS. 47A and 48A show the actuator 3-8 in the retracted position. Locking actuator 3-5 has placed latch arm 3-10 within window 3-8D.2 of bracket 3-2 and also within window 3-8D.1 of sliding bracket 3-8. One surface of arm 3-10A is in abutting relationship with a bottom-facing surface of window 3-8D.2. In this configuration, sliding arm 3-8 is locked relative to bracket 3-2, and the vehicle can be operated at its OEM ride height.

Actuator 3-5 in one embodiment is a spring-loaded, hydraulic actuator. When actuator 3-12 is in the first position, and as best seen in FIG. 48A, actuator 3-5 is preferably not pressurized with hydraulic fluid. Therefore, internal spring 3-16A biases the rod of actuator 3-5 to a fully retracted position, which causes latch 3-10 to pivot toward actuator 3-12 and through windows 3-8D.1 and 3-8D.2. It is also understood that yet other embodiments include a latch actuator that is of a two-way design, and retracted by hydraulic pressure. In still other embodiments, the latching actuator can be powered by pneumatic or electrical sources, the latter including solenoids and ball screw actuators as examples.

FIGS. 47B and 48B show actuator 3-5 in the fully extended position, which causes lever 3-10 to rotate away from actuator 3-12 and out of windows 3-8D.1 and 3-8D.2. As shown in FIG. 48B, the top inner corner 3-10A of lever 3-10 rests against a back surface of bracket 3-2. As discussed earlier, in order for actuator 3-5 to be able to pivot arm 3-10 out of the windows, actuator 3-12 is hydraulically powered to retract until the normal force between surface 3-10A and the underside of the window is relieved (thus relieving the frictional force), and thus permitting arm 3-10 to freely pivot about pivot joint 3-7. As lever 3-10 pivots away from actuator 3-12 (counterclockwise rotation, referring to FIG. 48), the hydraulic pressure to actuator 3-12 is reversed such that the rod end extends out of the actuator cylinder, as best seen in FIGS. 47B and 48B.

With regards to the first position of the actuator (fully retracted for normal operation of the vehicle), as shown in FIG. 48A, kit 3-17 further includes a pair of shut-off valves, one shut-off valve being in fluid communication with one fluid port of actuator 3-12, and the other shut-off valve being in fluid communication with the other fluid port. In the retracted and locked position, these shut-off valves are closed, such that fluid can neither be provided to actuator 3-12, nor can fluid flow out of actuator 3-12. Therefore, the actuator shown in FIGS. 47A and 48A is hydraulically locked in position.

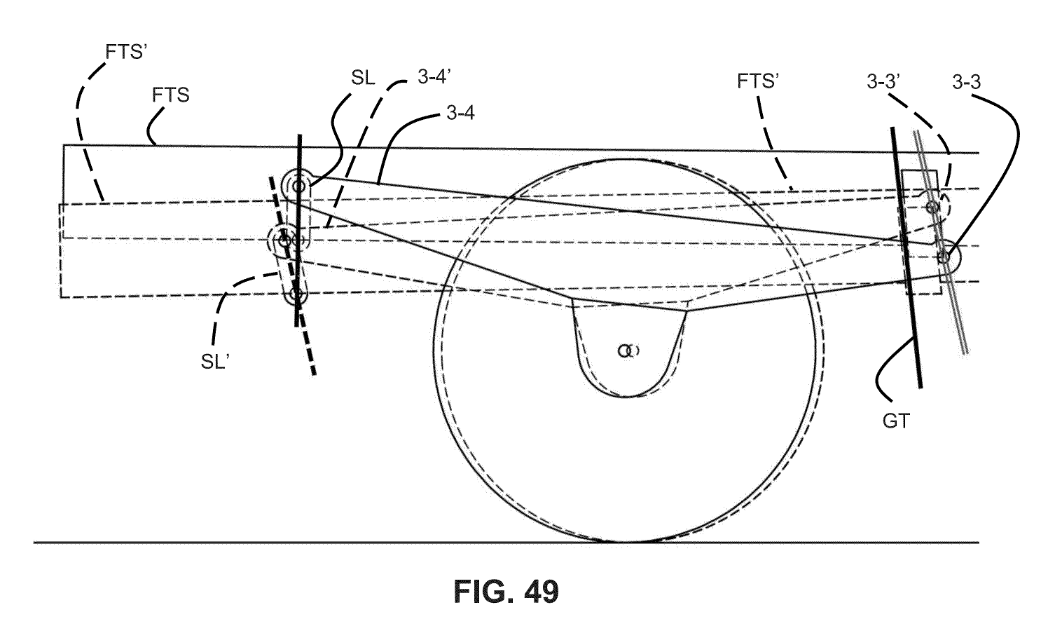

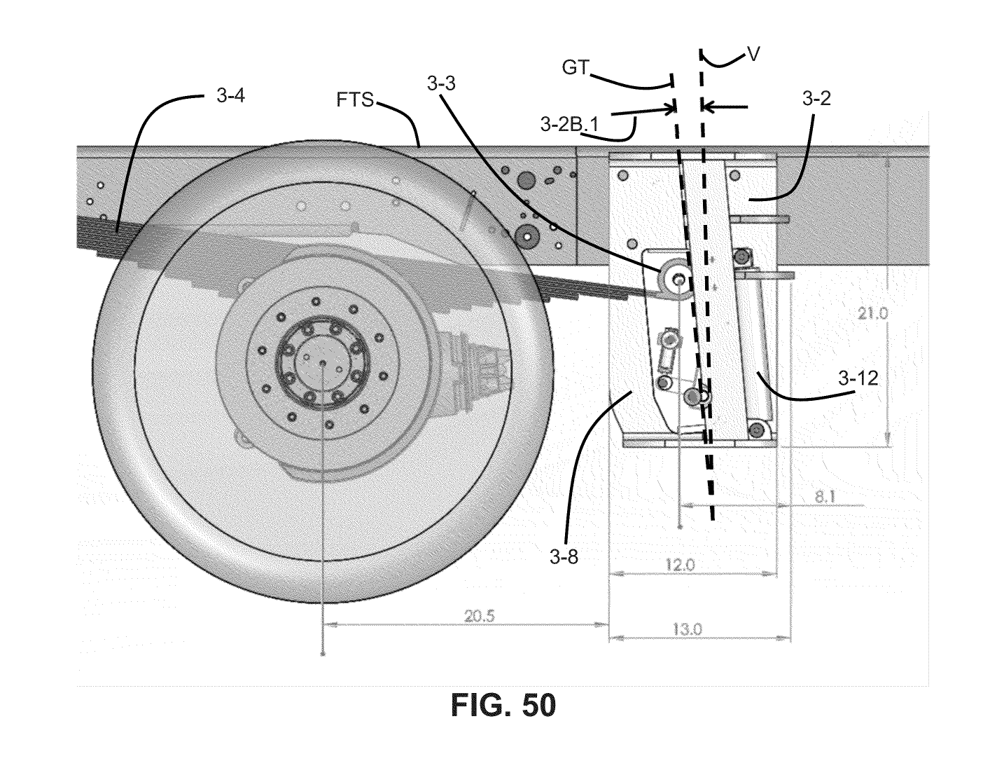

FIGS. 49-51 show various side and top views of a kit 3-17 installed on the ladder frame of a vehicle. Referring to FIG. 50, it can be seen that brackets 3-8 and 3-2 are adapted and configured to slide in a direction GT (Guided Track) indicated by angle 3-2B.1. This angle is anywhere from about one degree to about eight degrees aft of a vertical line V. Therefore, as actuator 3-12 extends so as to lower the frame top surface FTS and the chassis to a cargo-loading position the forward termination 3-3 of leaf spring 3-4 moves in an aftward direction relative to the ladder frame.

FIG. 49 presents a graphical overlay of certain components, with the chassis shown in the normal ride height, and also shown in the cargo-loading position (the latter being indicated by the prime (′) designation). FIG. 49 shows leaf spring 3-4 extending from a front pivoting termination 3-3 to a rear pivoting termination, this rear termination being pivotally coupled to a short link SL. Link SL is further pivotally coupled to the ladder frame. As the spring mount moves along guided track GT between the retracted and extended positions, the forward termination 3-3 of the leaf spring instead moves along a generally linear path as indicated in the figure. In so doing, and as the actuator is moved to place the chassis at the cargo-loading position, leaf spring 3-4 moves aft slightly, and link SL pivots aft also. FIG. 49 shows the top surface of the frame FTS relatively level and at the OEM height when the kit X-17 places forward leaf spring termination 3-3 at the OEM position. FIG. 49 further shows that as the leaf spring termination is brought to the cargo-loading position 3-3′ because of actuator movement along direction GT, the top surface of the frame drops to the cargo-loading position FTS′, and the leaf spring drops to the cargo-loading position 3-4′. It can further be seen that short link SL moves downward and pivots toward the rear to a cargo-loading position SL′. The pivoting action of the short link can further be seen in the comparison of the general OEM alignment of the pivotal attachments of the link SL (indicated by the solid line), and the lowering and angular movement as the link transitions to location SL′ (indicated by the dotted line).

It has been found that in some embodiments if the chassis is lowered and the leaf spring forward termination moves along the normal arc shown on FIG. 49 that the forward end of the driveshaft (not shown) moves too far forward into the aft end of the transmission, which can damage the transmission output shaft, seals, housing, or other components. By moving the forward leaf spring termination along the tilted path GT, the longitudinal relationship between the rear axle (which is located by leaf spring 3-4) and the aft end of the vehicle transmission (which is located by the OEM frame) is managed such the forward end of the drive shaft (not shown) maintains acceptable contact with the transmission output shaft.

In some embodiments, kit X-17 includes hydraulic and electrical components that provide the operation thus described. With regards to the hydraulic aspects of the kit, the kit can include a hydraulic pump, associated hydraulic lines X-12B, a pressure regulating valve, the solenoid shut-off valves previously described, and related components. The pump in some embodiments is electrically powered, whereas in other embodiments it is powered by the vehicle engine. In still further embodiments, the kit is provided with hydraulic fluid from an existing source of hydraulic pressure already existing on the vehicle.

The electrical system that supports operation of a kit X-17 can include a processor, various operator inputs, various switches and sensors, as well as the electrohydraulic locking actuator previously described. FIG. 36A shows upper and lower limit switches 2-19. These switches change their electrical state based on movement of a portion of the kit or movement of the leaf spring. These limit switches can be installed and interpreted in some embodiments as over travel limit switches. For example, the lower limit switch 2-19 can be installed at a location that provides a signal when actuator 2-12 has overextended, such that the location of OEM leaf spring pivot 2-3 has been extended beyond the OEM position. With such electronic notification, the kit controller would therefore recognize that the vehicle weight has been removed from the locking arm, such that actuator 2-5 is now free to move the actuator between locking and unlocking states.

Referring again to FIG. 36A, the upper limit switch 2-19 provides a signal indicative of the location of leaf spring 2-4 that corresponds to the cargo-loading position of the chassis. The controller for kit 2-17 uses the state of the switch to indicate to the operator that the vehicle is in the cargo-loading position, thus warning the operator that the handling characteristics of the vehicle are no longer the OEM handling characteristics.

Operation of a kit X-17 according to some embodiments will now be described. There are four digital inputs and eight digital outputs. The four digital inputs (DI) can be labeled as follows: Kneel Input, Upper Limit, Lower Limit, and Latch Released. The eight digital outputs (DO) can be labeled as follows: Pump Drive, Raise Solenoid, Lower Solenoid, Latch Release Solenoid, Latch Lock Solenoid, Raised Indicator LED, Lowered Indicator LED, and Raising/Lowering Alarm. The pump drive DO will power a 200 amp power relay for the pump motor and can draw approx. 25 watts. The raise solenoid, lower solenoid, latch release solenoid, and latch lock solenoid are hydraulic control solenoids that are built into a manifold, with the coils drawing 25 watts. The DI's for the limit switches and the latch switch are preferably ferrous switches. The DI from the kneel input can come from a door switch located on the rear doors of the ambulance and can also have a manual override switch located in the cab (such as a SPST rocker switch).

The Squat system has two functions: (1) to place the vehicle at OEM ride height; and (2) to lower the vehicle to a predetermined loading deck height. When the system receives a signal from the kneel input, the latch release solenoid is energized. The pump drive and the raise solenoid outputs are energized to raise the chassis far enough to release the latch, but no further than the upper limit switch. When the latch releases, the latch released switch is triggered and the lower solenoid output is energized to lower the chassis. The latch release solenoid, pump drive, and the lower solenoid outputs preferably stay energized until the lower limit switch is triggered, at which time the three outputs are de-energized and the lowered indicator light is active. The raising/lowering alarm output is active during the process, and the lowered indicator flashes.

When the system loses the kneel input signal, the pump drive, raise solenoid, and the latch lock solenoid outputs energize. The pump drive, raise solenoid, and latch lock solenoid outputs remain energized until the latch released switch losses its trigger, but no further than the upper limit switch. When the latch released switch losses its trigger, the raise solenoid de-energizes and the lower solenoid energizes for one second to seat the latch to its hard stop. After the one second timer, all outputs except for the raised indicator are de-energized. The raising/lowering alarm is active during this process, and the raising light flashes.

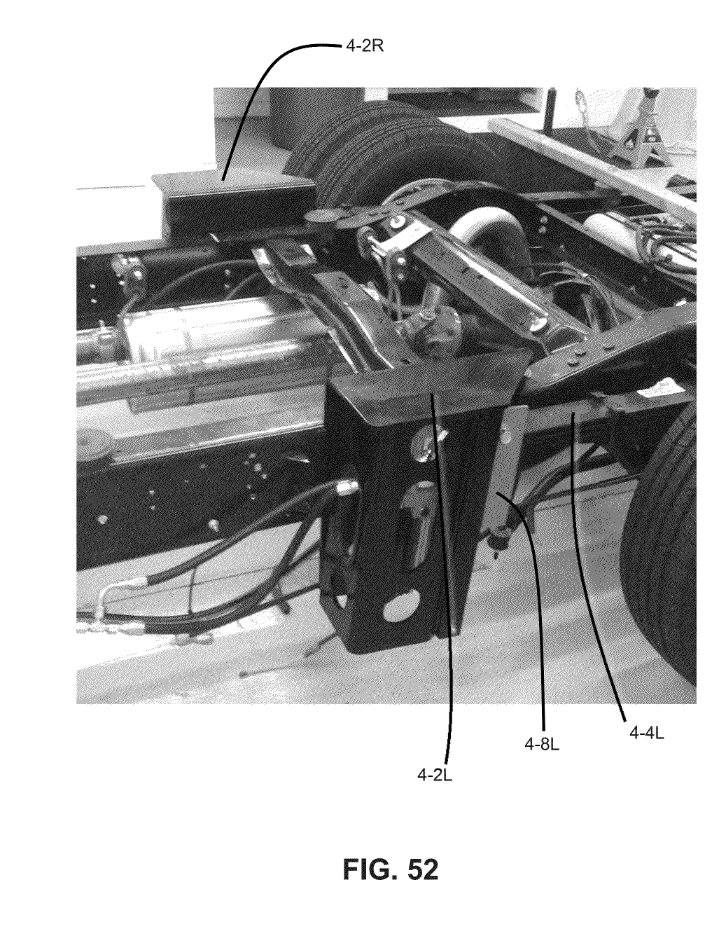

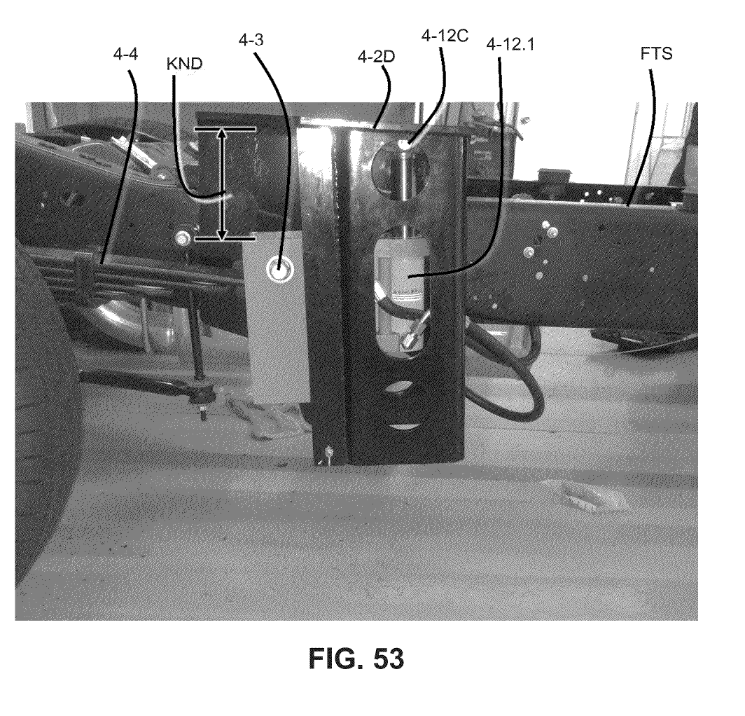

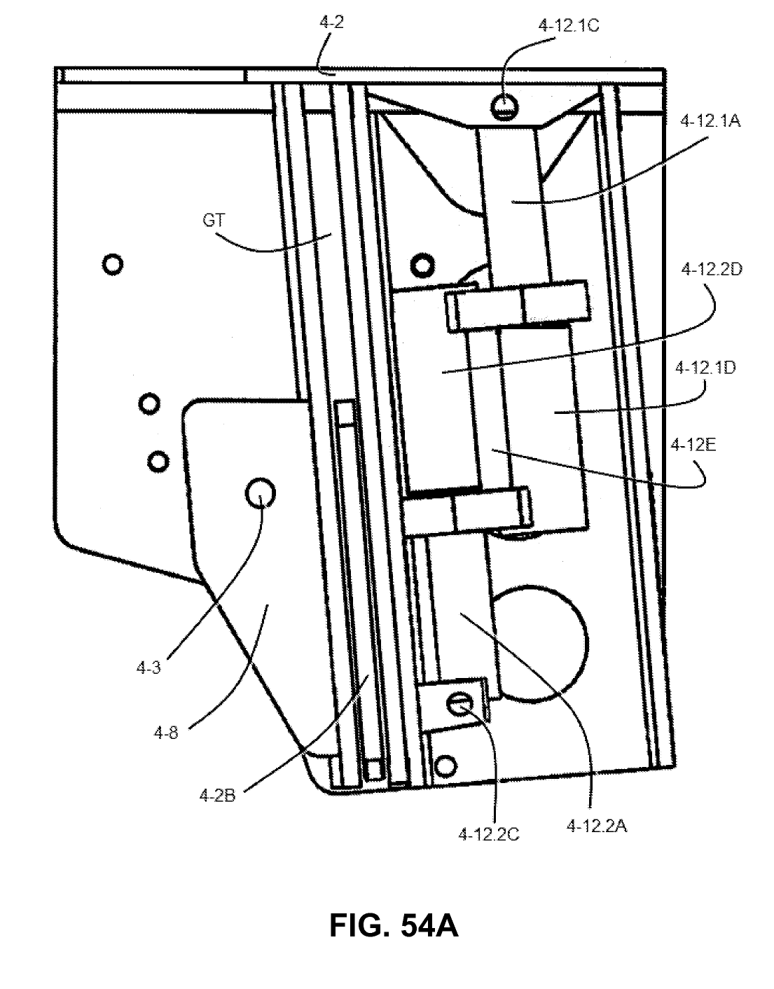

FIGS. 52-63 present various views of a chassis according to another embodiment of the present invention. The chassis shown in these figures incorporates a dual height rear suspension, and a dual height front suspension. FIGS. 52-59 show various views of the rear suspension. FIG. 52 shows a chassis having dual height suspension kits added to both the right (R) and left (L) sides of a vehicle. Each of these kits include kit assembly support housings 4-2R and 4-2L, each including a sliding assembly 4-8 that changes the location of the front pivot of a leaf spring 4-4. As best seen in FIGS. 52 and 53, the top surface 4-2D (and therefore the top pivot joint 5-12C of the actuator) are located above the frame top surface FTS of the main longitudinal frame members of the OEM chassis. In one embodiment, this offset is about 4 inches. Various embodiment of the present invention include a −2 housing that extends above the frame top surface FTS in order to permit additional lowering of the chassis to the kneeled position. As best seen in FIG. 53, this additional kneeling distance KND can be seen between the top of sliding bracket 4-8 and the underside of surface 4-2D.

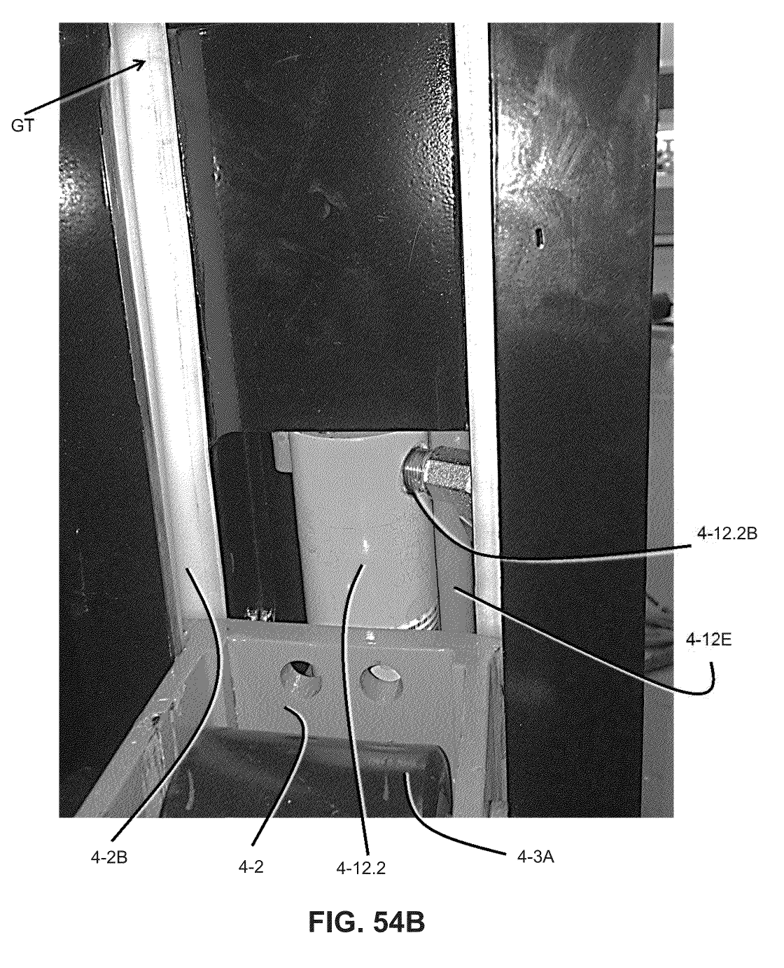

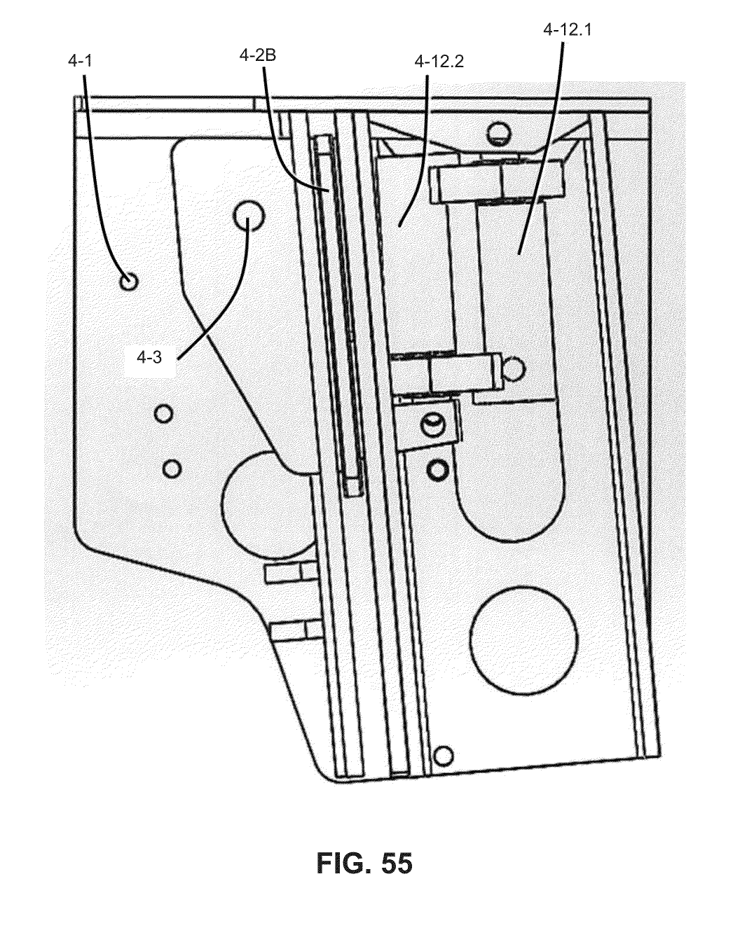

FIGS. 53-58 all show views of the right rear side of the vehicle. A support housing 4-2 contains within it a sliding assembly 4-8 that is moved substantially vertically along a guided track GT by a pair of piggyback actuators 4-12.1 and 4-12.2. It is further understood that in some embodiments guided track GT is canted at an slight angle from the vertical, as previously discussed, and as best seen in FIG. 54A.

FIGS. 54A and 54B show the spring in the normal ride height position, in which leaf spring pivot 4-3 is located at substantially the same position in space as the OEM pivot joint. In one embodiment, the normal ride height position is established when each of the actuators 4-12 are extended. Referring to FIG. 54A, it can be seen that actuator 4-12.2 is fully extended, with rod 4-12.2A extending out of cylinder 4-12.2D, the end of the rod being pivotally coupled at 4-12.2C to the sliding assembly 4-8. Likewise, the second actuator 4-12.1 is fully extended, with the pivot 4-12.1C of the rod 4-12.1A attached near the top of housing 4-2.

As best seen in FIGS. 54A, 55, and 56, each actuator 4-12 is mounted to a common piggyback bracket 4-12E. In some embodiments, the actuator cylinder bodies 4-12.2D and 4-12.1D are each rigidly connected to different sides of bracket 4-12E. In yet other embodiments, each actuator 4-12 includes a pivotal attachment to the bracket 4-12E. These dual pivotal attachments may be implemented along the central common member of bracket 4-12E or can be implemented in the individual connection of the top and bottom horizontal arms of bracket 4-12E. As best seen in FIG. 54A, the actuation direction of the piggyback actuators is substantially parallel to the direction of the flanges 4-2B contained within the guided flange GT. However, the present invention also includes those embodiments in which the angle of actuation of the actuators is nonparallel to the guided track GT.

In some embodiments, each of the actuators is a single-acting actuator, receiving hydraulic pressure in order to extend. In such embodiments, the weight of the vehicle suspended by the actuators causes the actuators to retract, and therefore there is no need for the application of hydraulic pressure to cause retraction. However, it is understood that yet other embodiments of the present invention include dual acting actuators requiring hydraulic pressure for both extension and retraction. It is further understood that in some embodiments the operation of the actuator is supplemented with a spring (either internal or external). The use of such springs can provide an offset in the actuation forces applied to the suspension, such that less pressure may be required for either retraction or extension.

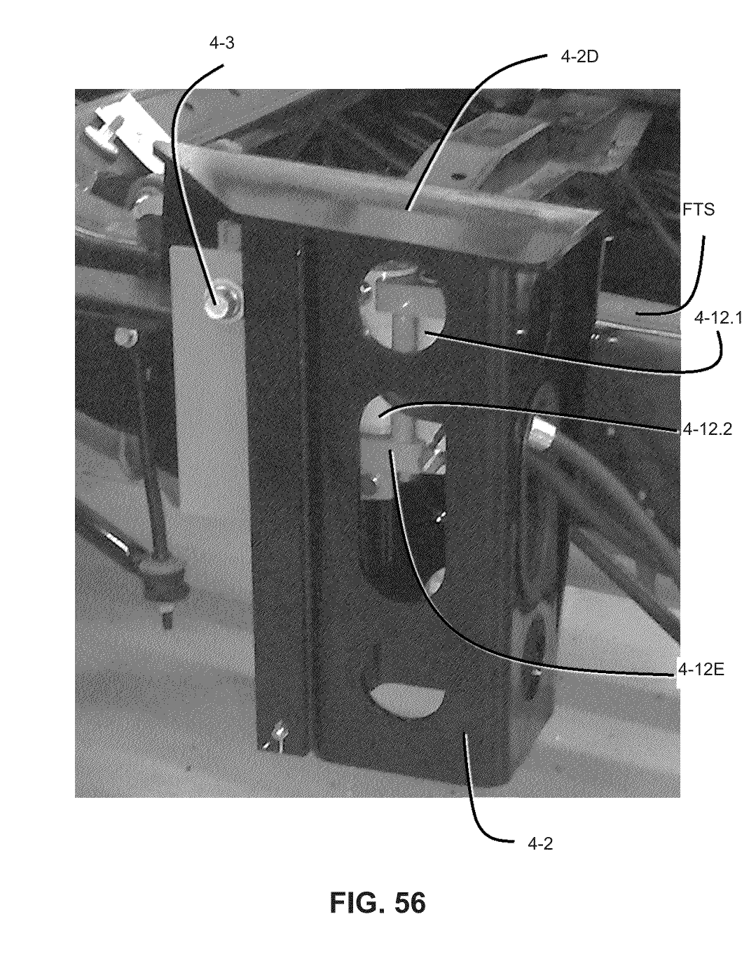

FIG. 55 shows both of the actuators 4-12.2 and 4-12.1 in the fully retracted position, such that each rod is contained substantially within its corresponding cylindrical housing. In this state, the location of the leaf spring pivot 4-3 is vertically high compared to the bracket attachment pattern 4-1, indicating that the frame top surface FTS is located downward at its kneeling position. In some embodiments, the rear suspension is placed at its dropped or kneeled configuration by relieving hydraulic pressure in the actuator. When the actuator pressure is reduced, the weight of the chassis (operating between the pivot points 4-12.1C of FIG. 54A) expels hydraulic fluid from the actuator to the system fluid reservoir. This dropped configuration can be achieved by the simple opening of a solenoid valve that is in communication with fluid exit ports of each of the actuators. Conversely, to place the suspension at its normal OEM right height, the embodiment shown in FIG. 54A is pressurized with hydraulic fluid received from a pump. FIGS. 56, 57, and 58 each show the suspension at the fully kneeled position.

In some embodiments, the rear suspension kit does not include a locking mechanism, except for hydraulically-actuating locks. When piggyback actuator 4-12 is extended to the normal ride height position, the pressurized fluid is captured by an on/off solenoid valve. In the fully retracted position, there is no need for a lock, instead relying on gravity and bottoming out of various components to maintain the system in the kneeled configuration.

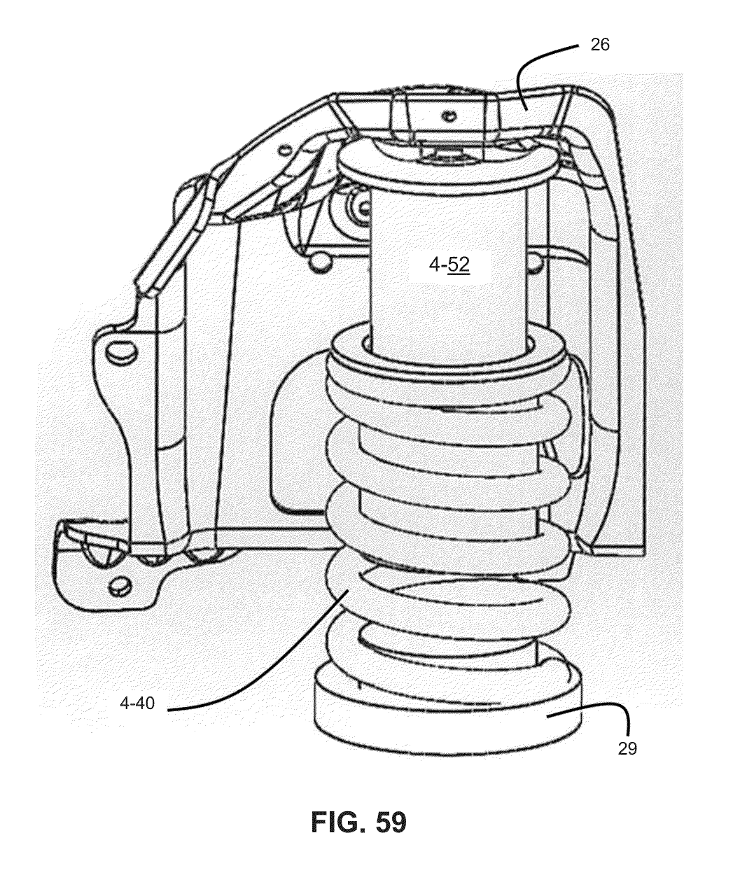

FIGS. 59-63 show various views of the front suspension of the chassis shown in FIG. 52. FIG. 59 shows a front left suspension that has been modified with a kit including an actuator 4-30, a spring 4-40, and an interface assembly 4-50 that adapts the action of actuator 4-30 to the spring 4-40.

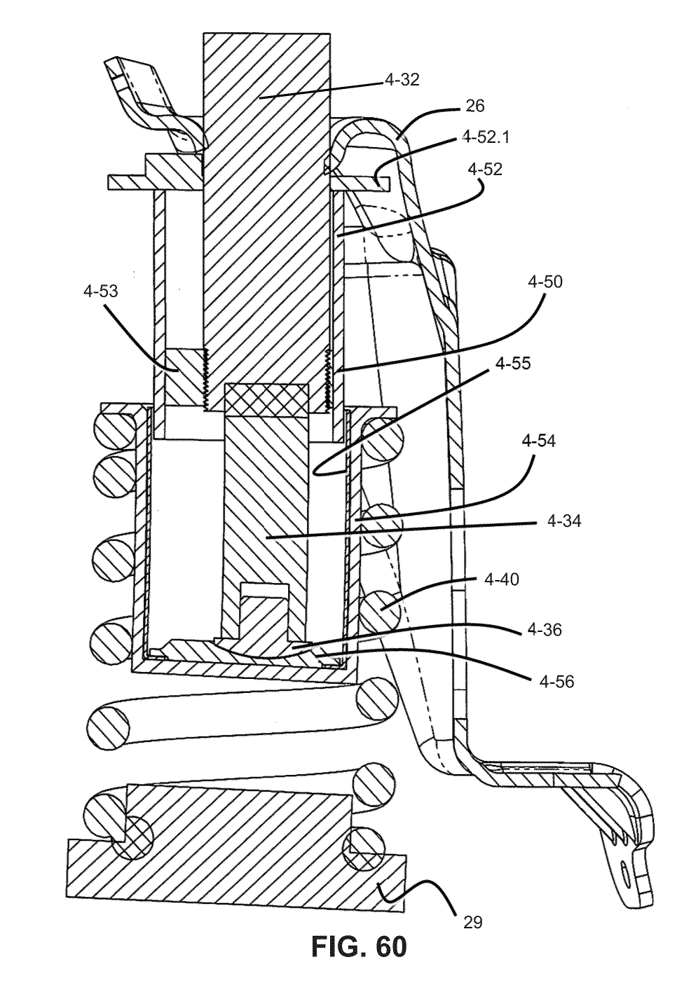

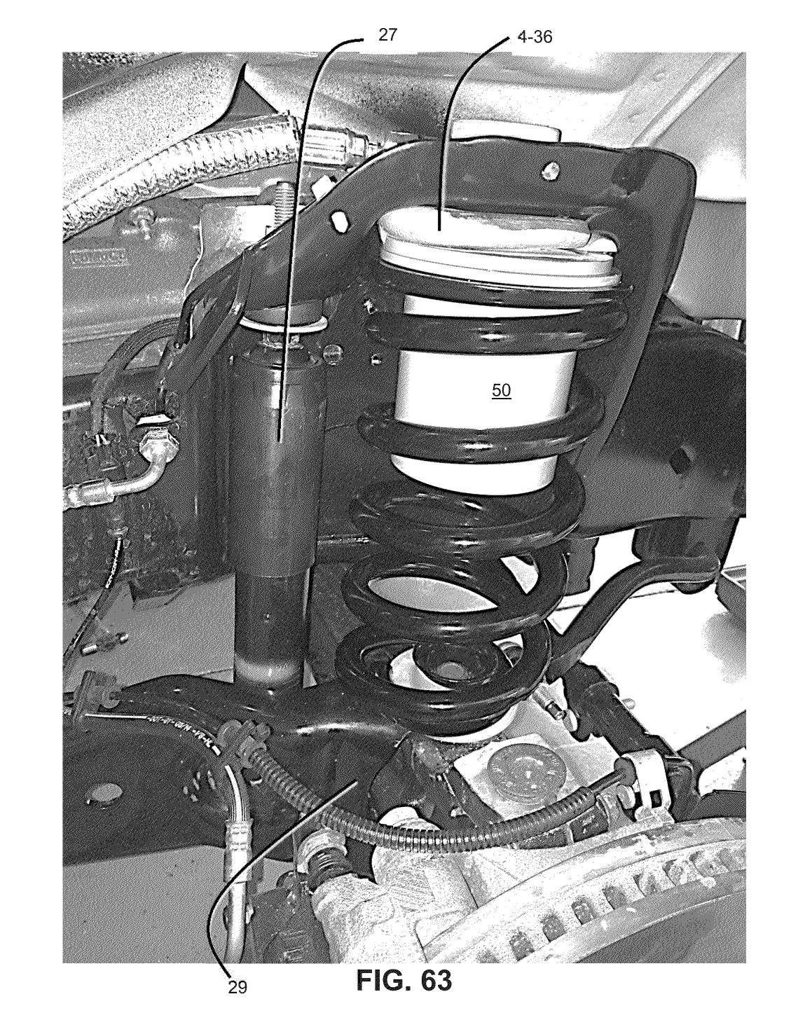

Referring to FIGS. 59-63, the cylinder 4-32 of actuator 4-30 is coupled to an outer actuator support 4-52. In some embodiments, it is helpful to offset the axis of actuation of actuator 4-30 relative to the axis of spring 4-40. In such embodiments, it may be desirable to provide a clearance hole or a mounting hole for the actuator in frame member 26, with this mounting location or clearance location being offset from the centerline of the OEM spring. In the embodiment shown in FIG. 60, it can be seen that the cylindrical body 4-32 of the actuator is rigidly coupled to a cylindrical housing 4-52 by way of an eccentric mounting donut 4-53. In some embodiments, donut 4-53 can be threadably coupled to the actuator, and welded to the inner diameter of the body of member 4-52. The figures also show that the top of member 4-52 provides a load path from the actuator through donut 4-53 by way of a top flange that interfaces with the contours of the OEM frame 26. In one embodiment, for those frame members 26 having a contour configured and adapted to accept the OEM spring, it can be helpful to attach a portion of the OEM spring 4-40.1 to the top flange 4-52.1, as best seen in FIG. 63.

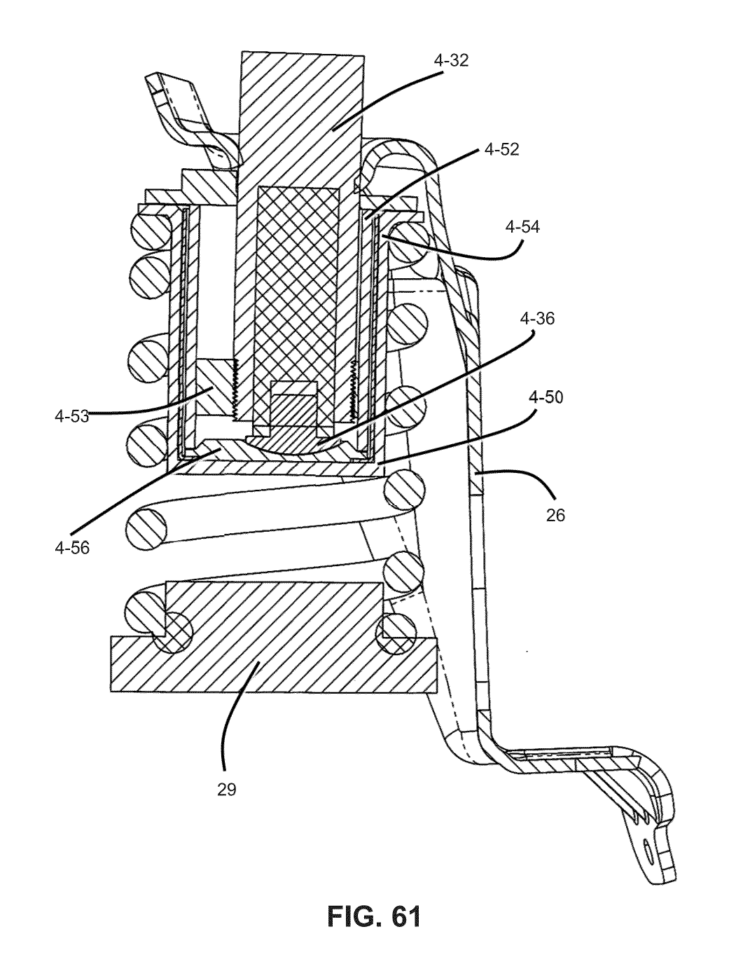

Referring to FIGS. 60 and 61, it can be seen that sliding interface assembly 50 further includes a spring support 4-54 that receives within it the outer diameter of housing 4-52, and further is received within the inner diameter of the coils of spring 4-40. FIG. 60 shows that at the normal OEM ride height, the rod 4-34 is fully extended. Since this rod is extended relative to the cylinder 4-32, which in turn is supported by inner support 4-53 and thus frame 26, the extension of rod 4-34 pushes apart spring support 4-54 from outer support 4-52. This substantially axial force is provided by rod 4-34 through a spherical end 4-36.

Spherical member 4-36 has an outer diameter supported within an inner diameter of rod 4-34, and a substantially spherical end surface that comes into contact with a spring support loading member 4-56 located at the bottom of support 4-54. Support 4-56 includes a substantially spherical surface (shown a pocket) that is complementary in shape to the loading end of rod end member 4-36. Therefore, as shown in both FIGS. 60 and 61, the actuation of rod 4-34 against spring support 4-54 is provided with a centering and alignment function by the sliding of the two spherical surfaces on one another. Preferably, one or both of members 4-36 and 4-56 are fabricated from a wear-resistant, low friction material such as an ultra-high molecular weight polymer (UHMW). Still further, in some embodiments the sliding interface between the outer diameter of cylinder support 4-52 and the inner diameter of spring support 4-54 with a wear-resistant, low friction material, such as a UHMW polymer.

The modification kit for a dual height front suspension in one embodiment includes a spring 4-40. In one embodiment, the spring 4-40 is adapted and configured to have substantially the same spring stiffness as the OEM spring. In one embodiment of the present invention, that stiffness is between about 600 pounds per inch and 700 pounds per inch. In yet another embodiment the spring of the kit has a free length that is about four inches less than the free length of the OEM spring. However, the kit spring 4-40 is adapted and configured to have about the same spring stiffness so as to provide about the same handling and ride characteristics as the OEM vehicle.

Various embodiments of the present invention include an electronic control system including an electronic controller and various sensors, the controller being in operative communication with a hydraulic system including an electric motor driving a hydraulic pump, various electrohydraulic valves, and various electrohydraulic switches or sensors. Some embodiments of the present invention are applicable to vehicles that can have unpredictable camber angles, such as with the Ford E-series twin I-beam front suspension. In such cases, a front leveling system will be utilized. The leveling system will function by sensing the height of either the I-beam or the radius arm by a sensor such as a proximity sensing device or a rotary encoding device. By processing the response of the sensing device, the deflection of the hydraulic actuator will be modulated to maintain a constant leveled height. With the hydraulic actuator being located directly above the coil spring, the actuator will accommodate any changes in spring height caused by differential loading and road surface irregularities. This will result in the ability to maintain a constant camber regardless of chassis loading. This process will increase vehicle stability as well as reduce tire wear.

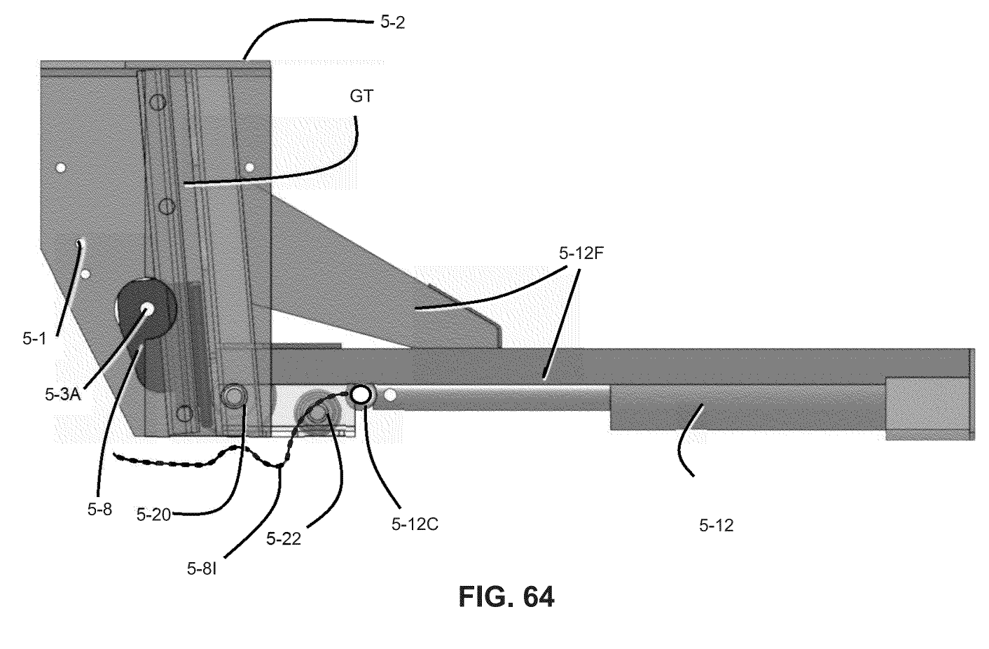

FIGS. 64-69 show various embodiments of a rear suspension actuation kit according to another embodiment of the present invention. FIGS. 64-67 show various views of a kit for modifying the rear suspension includes a housing and bracket assembly 5-2, a sliding assembly 5-8 at interfaces between the OEM spring and an actuator, and an actuator 5-12. Housing 5-2 is substantially the same as the other X-2 support assemblies shown herein, including a plurality of mounting holes 5-1 for attaching housing 5-2 to an existing bolt pattern of an OEM frame. Housing 5-2 further includes a guiding track GT that accepts within it a guided flange 5-8E of a sliding bracket 5-8. Bracket 5-8 includes a mounting hole 5-3A for accepting the forward pivot joint of a leaf spring (not shown).

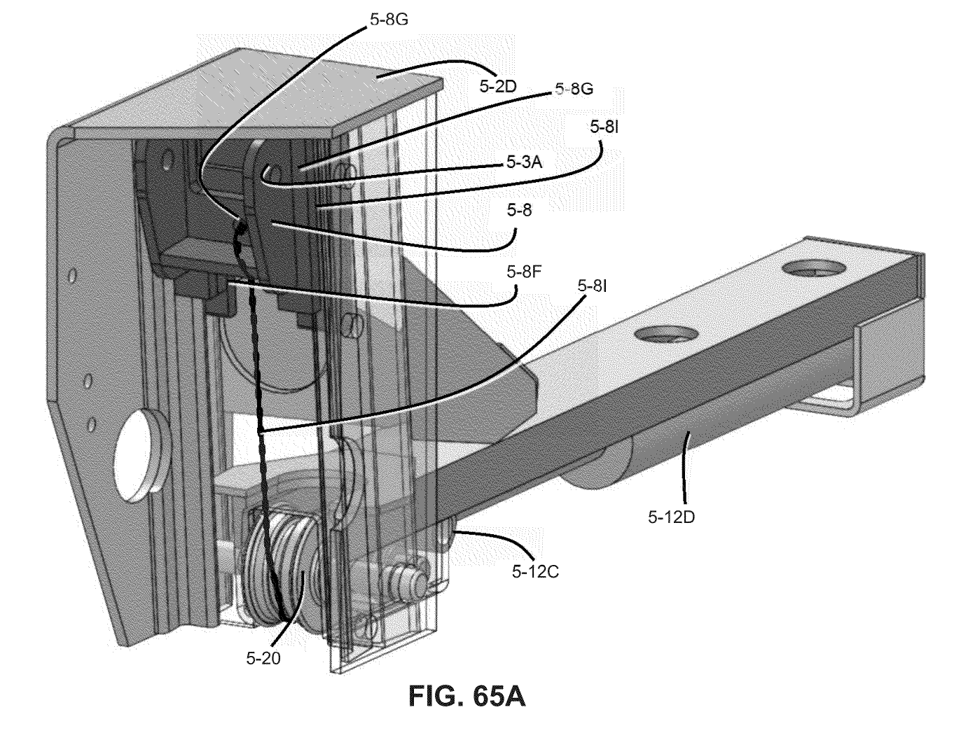

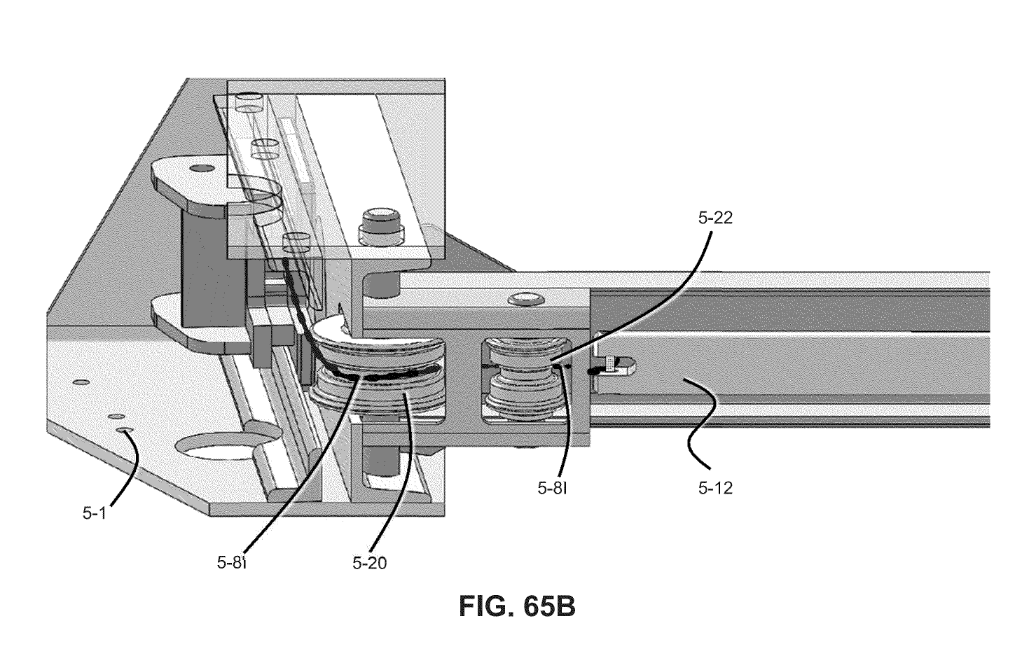

Referring to FIG. 64, the slider assembly 5-8 is shown at the normal, OEM ride height (leaf spring pivot 5-3A shown furthest away from the top surface 5-2D of housing 5-2). However, actuator 5-12 is shown at the fully extended, kneeled position for purposes of clarity. It can be seen that a cable 5-8I is attached to the end 5-12C of the actuator, and extends over and around a first pulley 5-22. Cable 5-8I is shown disconnected from slider 5-8 in FIG. 64. When fully assembled, the free end of cable 5-8I is looped around the bottom of aft pulley 5-20, and then coupled to attachment point 5-8G of slider 5-8, as will be seen in FIG. 65. When cable 5-8I is fully looped and attached, tension on cable 5-8I will pull it downward to the OEM position, which is shown for sliding assembly 5-8 in FIG. 64. The suspension is maintained in this OEM position by applying pressure to hydraulic cylinder 5-2 to cause it to retract. By applying tension to the cable, actuator 5-12 pulls on sliding assembly 5-8 by way of attachment hole 5-8G, and pulls the forward pivot 5-3A of leaf spring 5-4 in a direction away from the top 5-2D of mounting bracket 5-2. Tension in this cable, from retraction of the actuator, places the leaf spring pivot at the OEM position when the actuator is fully retracted.

Those of ordinary skill in art will recognize that the actuator 5-12 can be placed in an opposite position, such that the end of the rod extends in the opposite direction when actuated. In such embodiments, extension of the rod would place tension on cable 5-8I, thus pulling the end of the leaf spring to the OEM position. Likewise, if the hydraulic pressure of the actuator is released (and there is no means for locking the sliding bracket at the OEM position), then the weight of the vehicle would result in the end of the leaf spring moving toward the top FTS of the longitudinal rail by operation of gravity. The weight of the vehicle would place tension on cable 5-8I that would pull the actuator rod into a retracted position within the cylinder.

It is further understood that the various means for locking the sliding bracket in a position can be incorporated with any of the various actuating mechanisms shown herein. For example, the kit 5-17 of FIGS. 64-69 could incorporate any of the various mechanical or hydraulic locking means shown herein.

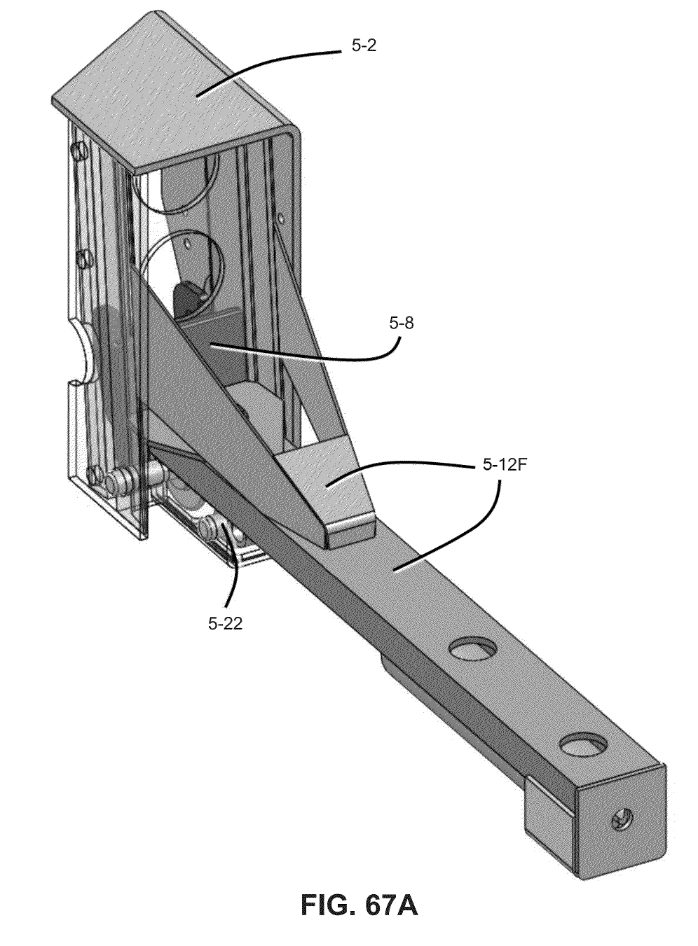

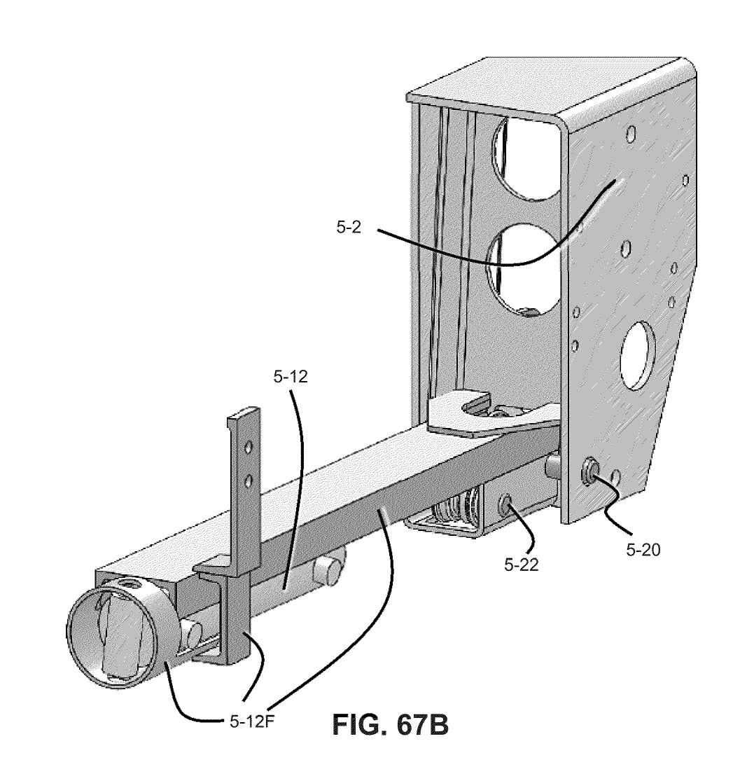

FIGS. 65A and 65B show the suspension kit in the kneeled or dropped state, with slider 5-8 in an upwardmost position relative to bracket assembly 5-2. Cable 5-8I can be seen attached to sliding bracket 5-8, and extending downward and under aft most pulley 5-20. As best seen in FIG. 65B, cable 5-8I continues around pulley 5-20, extends over the top of pulley 5-22, and is attached to the end of rod 5-12A. When actuator 5-12 is relieved of the hydraulic pressure holding it in the fully retracted (OEM ride height) state, the weight of the vehicle continues to apply tension to chain 5-8I, and the slider 5-8 pulls actuator 5-12 to the fully extended position (fully kneeled). FIG. 67B shows an alternative bracketing arrangement 5-12F for coupling of actuator 5-12 to bracket 5-2.

Cable 5-8I can be of various configurations, including flexible members such as chains and cables. The cable 8I is guided in a path from the end of rod 5-12 to sliding assembly 5-8 by a path that traverses over a pair of rotatable pulleys 5-20 and 5-22. Pulley 5-20 substantially converts the linear, longitudinal motion of actuator 5-12 to the linear, substantially vertical motion of slider 5-8. Thus, the kit shown in FIGS. 64-69 includes sliding member that slides in a first direction, and an orthogonal actuating device that moves in a direction that is at least partly orthogonal to the direction of sliding motion. Although a flexible connection between a cylinder and a sliding member including a cable and pulleys is shown, it is under stood that those of ordinary skill in the art can apply still other tension-providing pathways, such as a bicycle-chain moving over one or more sprockets. Still further, yet other embodiments include belts, including as one examples, steel belts covered in an elastomer.

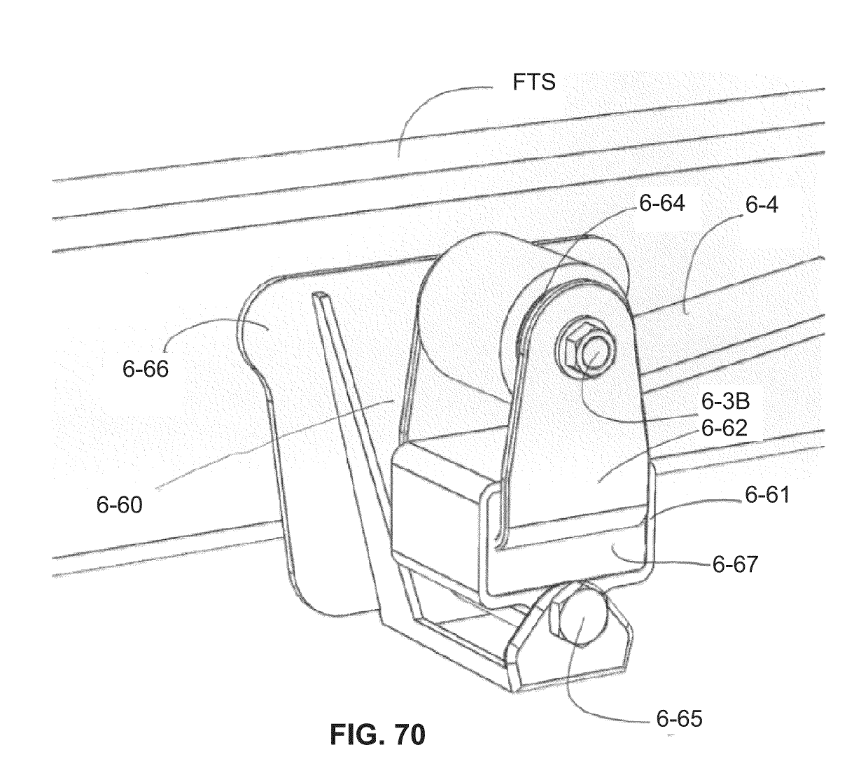

Yet another embodiment of the present invention includes a leaf spring rear shackle assembly 6-60 that incorporates a suspension component, which provides improved ride, stability, and handling, to a standard leaf spring suspension. FIGS. 70-73 show various views of a leaf spring rear shackle assembly 6-60 according to one embodiment of the present invention. The suspension component also provides a softer vehicle ride by its ability to absorb shock and vibration loads during the leaf spring's jounce and rebound events.

Typically, OEM leaf spring rear shackles consist of an upper pivot bushing and a lower pivot bushing and rigidly connected together. The two (2) standard OEM bushings are typically made of rubber and have the general purpose of providing limited pivoting travel in the shackle (fore and aft) to absorb single wheel bounce events.

One embodiment of the present invention provides a replacement shackle bushing 6-63, 6-64 to provide the fore and aft leaf spring movements, but now further provides shock absorption from rotational pivoting; fore and aft compression; downward recoil; upward compression; and, twisting and/or flexing of the leaf spring and the shackle bushing mounts.

The leaf spring rear shackle assembly 6-60 includes five (5) operating components in one embodiment: upper shackle 6-62, lower shackle 6-61, polyurethane bonding member 6-67, upper shackle bushing fastener 6-3B, and lower shackle bushing 6-63 and bushing fastener 6-65.

Upper shackle 6-62 and lower shackle 6-61 are connected (molded together) by a polyurethane bonding member 6-67 producing a unitized leaf spring rear shackle assembly 6-60. An example of the polyurethane bonding material would be Atro Engineering's Dead Soft™ Polyurethane 68-72 Shore A Material.

There are two (2) shackle assemblies 6-60 per vehicle, one assembly 6-60 mounted on the vehicle's driver side frame and the other like shackle assembly 6-60 mounted on the opposite side frame (curbside). Each assembly 6-60 is attached to the vehicle's frame by means of a leaf spring support bracket 6-66. Leaf spring 6-4 includes a rear eye shackle bushing 6-64, wherein the leaf spring 6-4 is attached to the upper shackle 6-62 by fastener 6-3B. The lower shackle 6-61 incorporates a lower shackle bushing 6-63 and is attached to support bracket 6-66 by bushing fastener 6-65.

As a vehicle encounters jounce and rebound events during driving operation, the rear leaf spring suspension will exhibit multiple movements of rotational pivoting; fore and aft compression; downward recoil; upward compression; and, twisting and/or flexing of the leaf spring and the shackle bushing mounts.

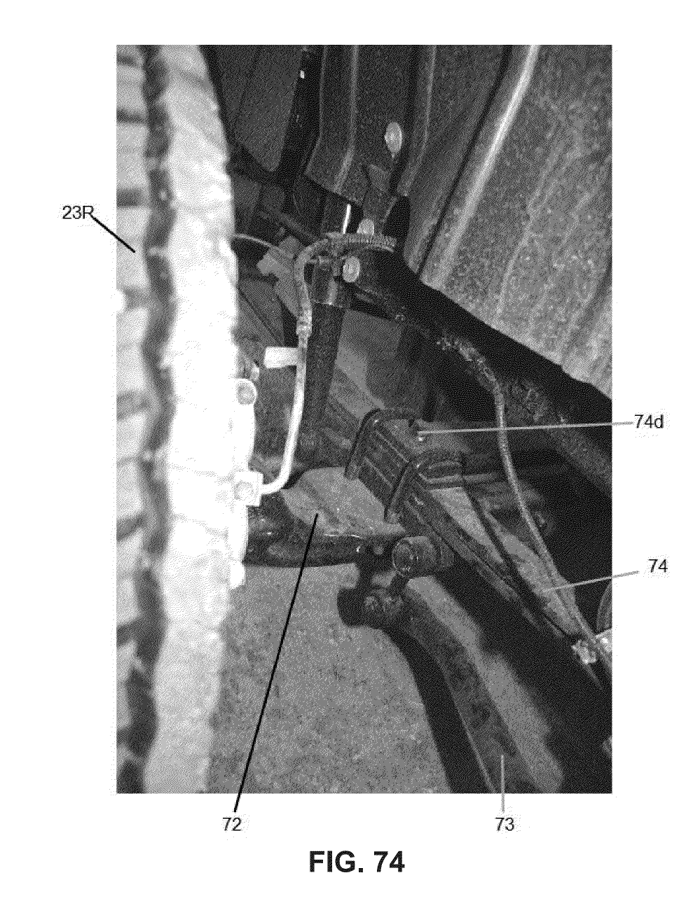

FIGS. 74, 75, 76 and 77 show and describe various aspects of a front suspension of a vehicle. The vehicle 20 includes right and left wheels 23R and 23L, respectively, that support the vehicle from the roadway. Each wheel is coupled to a wheel support 72 attached by clamps 74(d) to a leaf spring assembly 74. A pair of shock absorbers 71 couple each wheel support 72 to the vehicle frame and dampen the movement of wheels 23. A roll bar 73 interconnects the right and left suspensions of vehicle 20 to improve the roll stability of the vehicle.

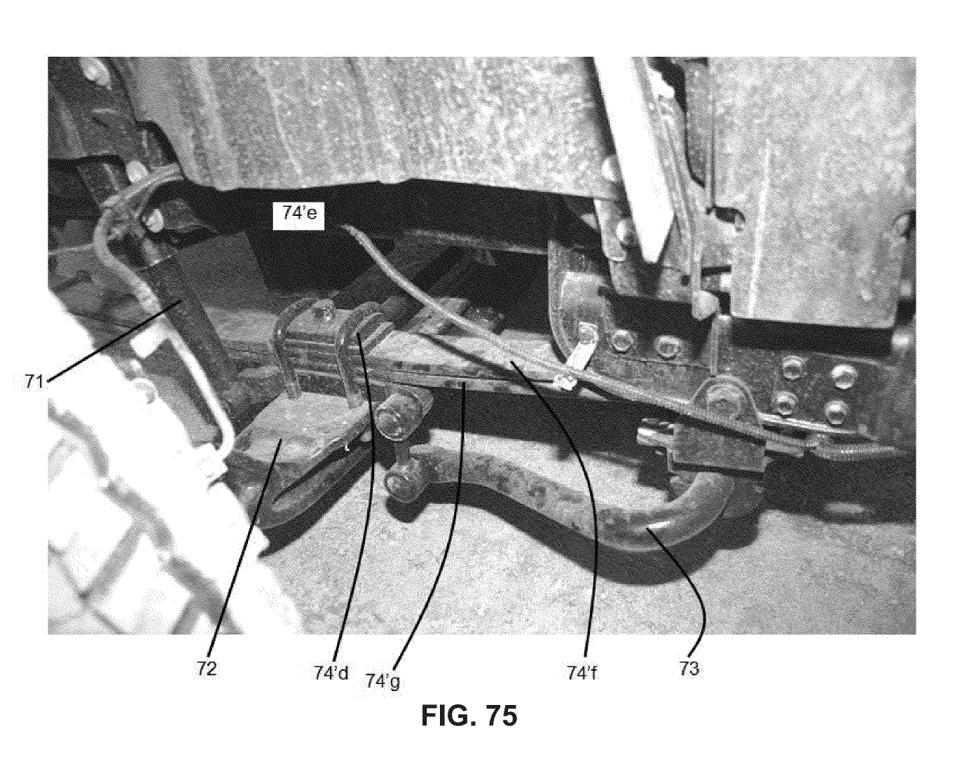

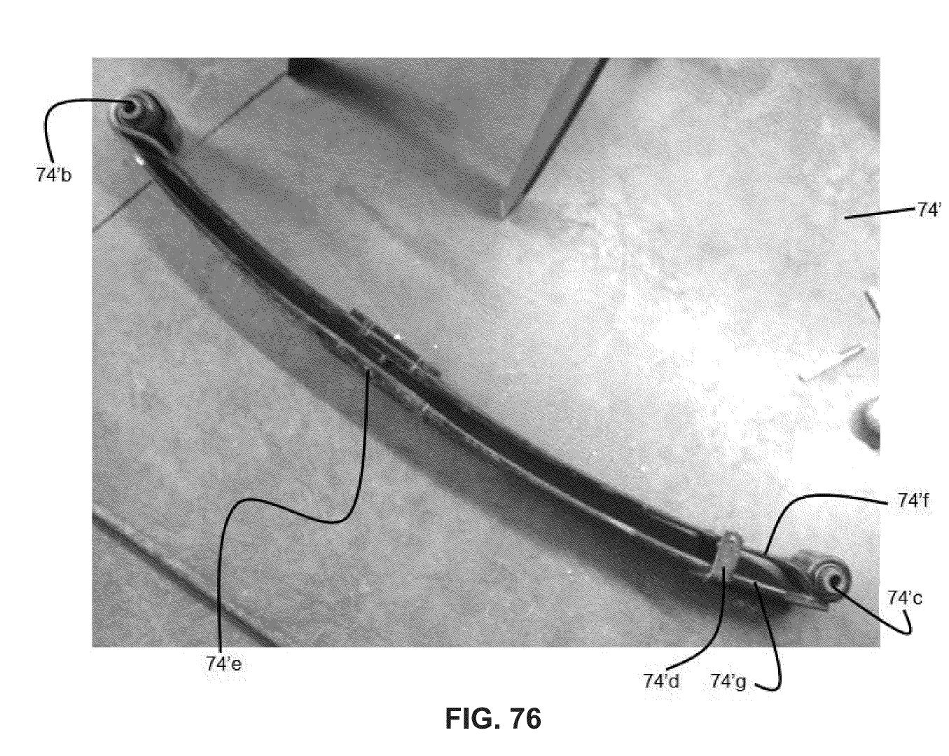

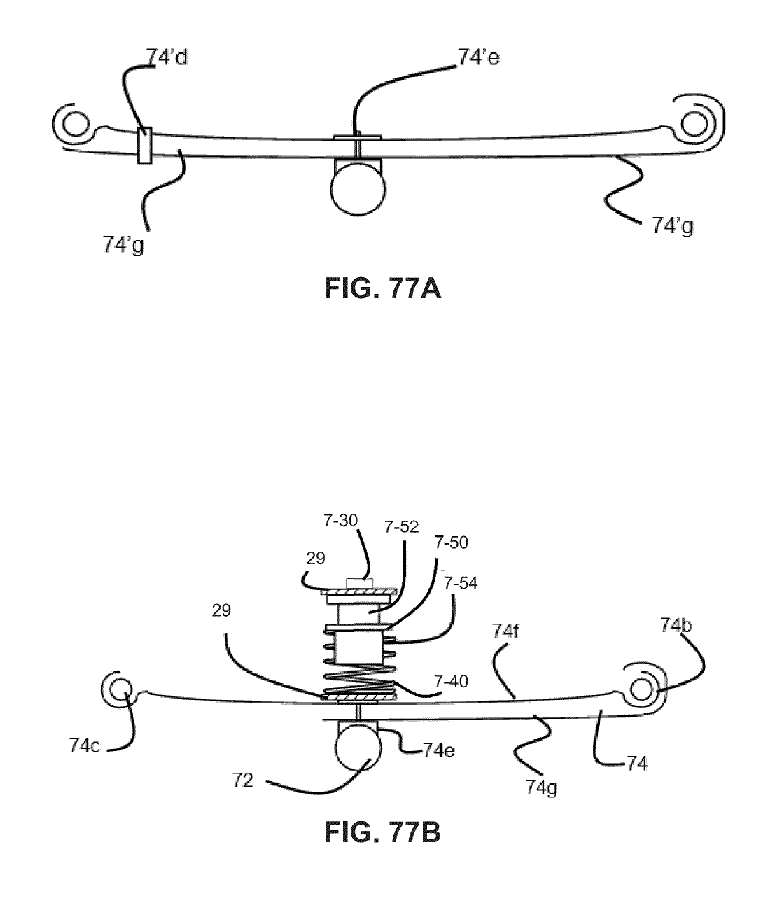

FIGS. 74-77 depict the leaf spring 74′ of the OEM vehicle. Leaf spring 74′ includes a top leaf spring 74′ and bottom leaf spring 74′g that extend from a foreword pivot joint 74′ be to an aft pivot joint 74′c. These top and bottom OEM leaf springs are coupled together by an aft clamp 74′ which is best seen in FIGS. 76 and 77A. Bottom OEM leaf spring 74′g is coupled to the front pivot joint 74′b and extends aft and is located underneath aft pivot joint 74′c. Referring to FIG. 77A, leaf spring assembly 74′ is coupled to front wheel support 72 by a central attachment 74′e. In one embodiment, this central attachment includes a pair of U-clamps and a centrally located fastener, as best seen in FIGS. 75 and 77A.

In one embodiment of the present invention, the front suspension of the vehicle is modified to include a reduced stiffness leaf spring, and further to incorporate a kit according to another embodiment of the present invention. FIG. 77B shows a right side front suspension according to one embodiment of the present invention. As shown in FIG. 77B, the bottom leaf spring 74g in one embodiment of the present invention has a reduced length, and extends from the front pivot 74b to a point just aft of wheel support 72. Bottom leaf 74g is coupled to support 72 by the central attachment 74e. The aft section of OEM bottom leaf spring 74′ has been removed, which provides an overall reduced stiffness to leaf spring 74.

However, in yet other embodiments a similar reduction in stiffness can be accomplished by using, as examples, a reduced thickness bottom leaf spring that extends from the front pivot to the aft pivot, or a bottom leaf of reduced width and commensurate reduced stiffness, or by eliminating the bottom spring altogether. In the latter case, the top leaf may be the OEM leaf, as one example, or could be a top leaf of increased stiffness, but yet in other embodiments could be a top leaf of reduced stiffness (as compared to the OEM top leaf). In those embodiments in which the springs of the front suspension are of the coil type, the OEM coils can be replaced with coils having reduced stiffness, such as by a reduction in wire diameter, change in the number of coils, change in the overall diameter of the spring, or other methods known for the reduction of coil spring stiffness.

Referring again to FIG. 77B, in some embodiments the front suspension of vehicle 20 includes a pair of kits 7-X, one each for support of the right and left front suspension. In one embodiment, coil spring 7-40 is selected to restore the OEM spring characteristics to the front suspension, prior to the reduction in the stiffness of the leaf spring. Kit 7-X operates in a manner similar to that of kit 4-X shown previously. The modification kit according to one embodiment of the present invention includes a coil spring 7-40, an actuator 7-30, an actuator-spring interface 7-50.

Preferably, vehicle 20 includes a front section in which the OEM spring supports have reduced stiffness, and in which that stiffness is compensated by the introduction of the air support. In such embodiments, by reducing the internal pressure of the air support the vehicle can be brought to a lower position temporarily for ingress and egress of passengers from the payload section. This lower position is permitted by the reduced stiffness of the Front suspension springs 74. The continued use of modified front springs 74 in vehicle 20 allows for OEM-levels of reliability during operation.

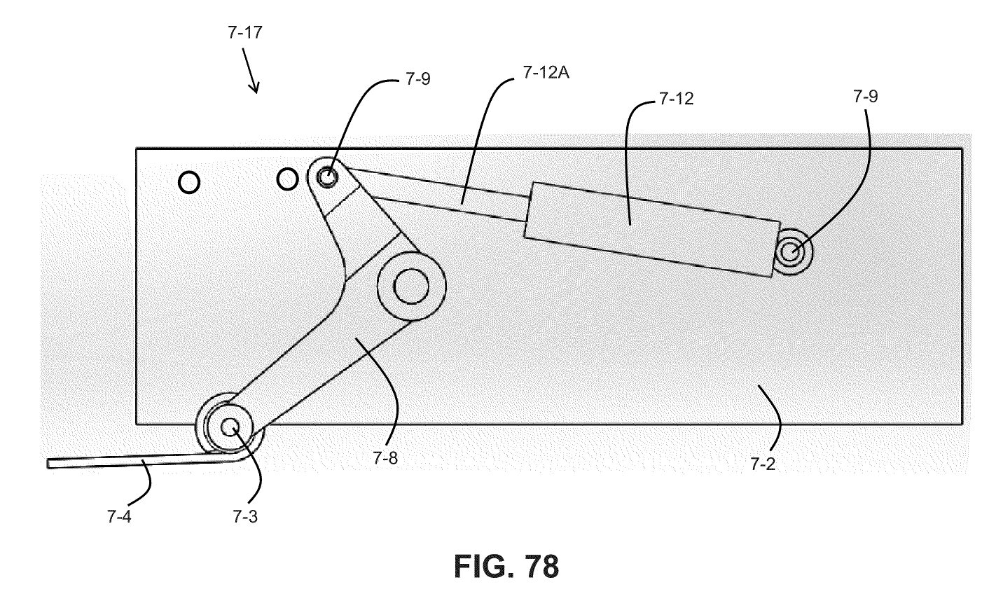

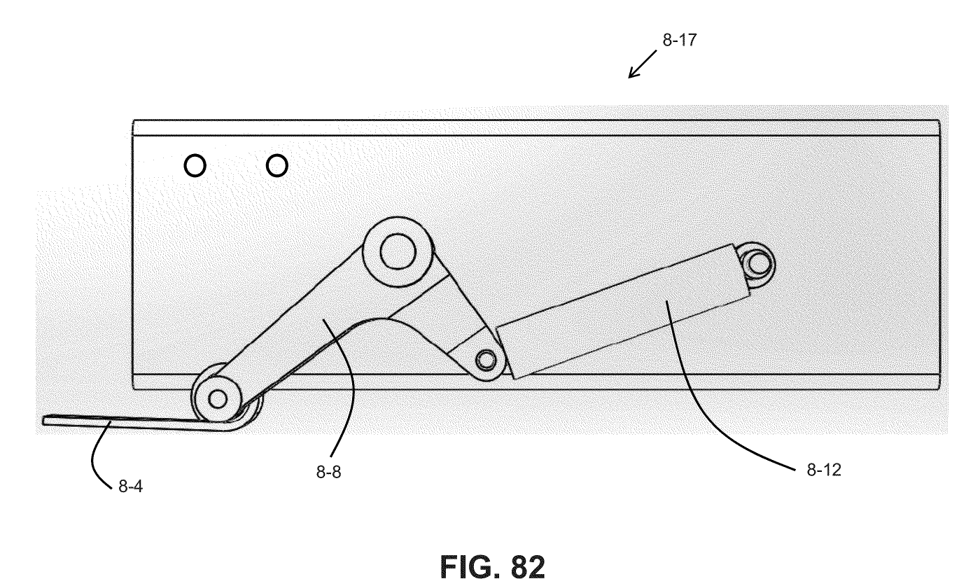

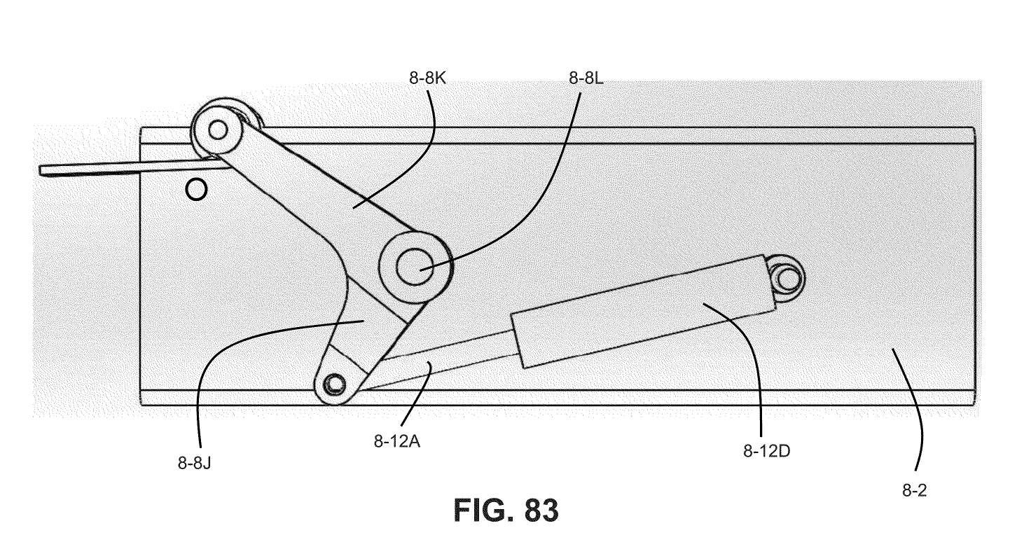

FIGS. 78-83 show a portion of an OEM ladder frame vehicle that that incorporates a suspension modification kit that permits the operator to place the rear suspension at either a ride height or at a lowered position. It will be seen that kit 7-17 of FIGS. 78-81 is similar in many respects to kit 8-17 of FIGS. 82-83, with one difference being that kit 7-17 has an actuator that is fully retracted when the suspension is in the lowered position, whereas kit 8-17 is fully retracted when the suspension is at the normal ride height.

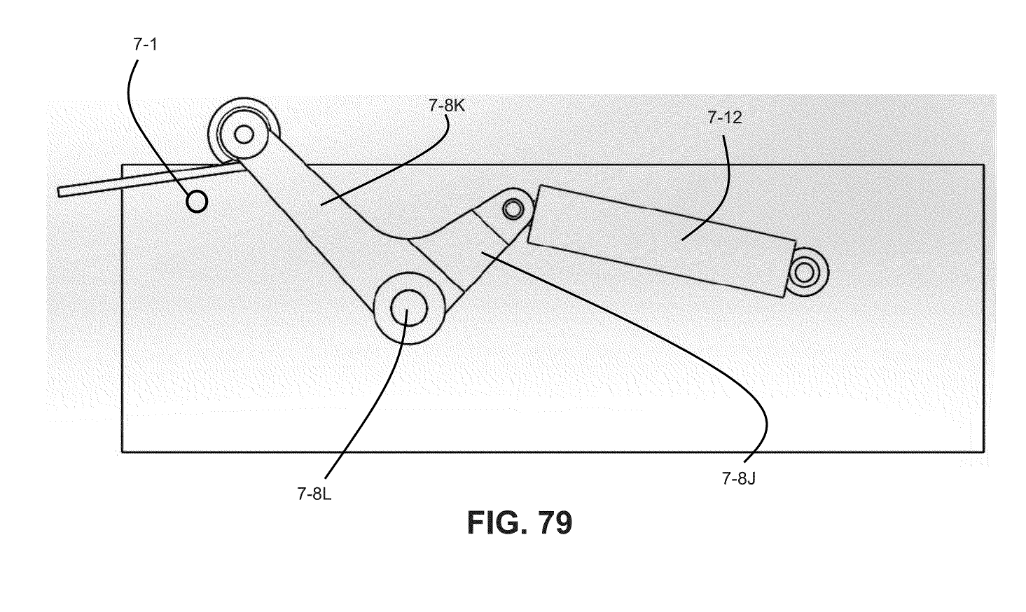

FIGS. 78-81 show various views of a kit 7-17 according to one embodiment of the present invention. In FIG. 78 the kit has been actuated such that the suspension is at the normal ride height. In FIG. 79-81, the kit has been actuated such that the suspension is at the lowered position.

FIG. 78 shows a side elevational view of a kit 7-17. It is understood that kit 7-17 includes a mounting plate 7-2 having a plurality of mounting holes 7-1 that substantially align with existing mounting holes in the OEM vehicle frame longitudinal rail. However, for purposes of clarity, the longitudinal rail of the OEM frame is not shown in FIGS. 78-83. Further, although what is shown and described is a kit including a mounting plate, various other embodiments contemplate actuators and/or bellcranks that are mounted to the OEM longitudinal rail, and further contemplates embodiments in which the components shown and described are part of the OEM frame, and not part of a kit.

Kit 7-17 includes a plate 7-2 that supports an assembly of an actuator 7-12 and a pivot arm or bell crank 7-8. Bell crank 7-8 is pivotally attached by a pivot joint 7-8L to mounting plate 7-2, and actuator 7-12 is pivotally mounted to the plate by a pivot joint 7-9. Further, the bell crank and actuator are pivotally coupled to each other at an aftmost pivot joint 7-9 on rod 7-12A.

Bell crank 7-8 includes a second arm 7-8K that pivotally couples by a pivot joint 7-3 to the forward end of OEM leaf spring 7-4. Preferably, bell crank 7-8 has arms 7-8K and 7-8J adapted and configured such that the application of an axial load from actuator 7-12 will create a torque about pivot joint 7-8L that is sufficient to move portions of the OEM chassis relative to pivot 7-3 of leaf spring 7-4. As can be seen in comparing FIGS. 78 and 79, full extension of actuator 7-12 applies a torque to bell crank 7-8 that results in placement of pivot joint 7-3 at the OEM location of the pivot joint. FIG. 79 shows that full retraction of rod 7-12A into cylinder 7-12D results in placement of the OEM chassis at a lower position relative to pivot 7-3.

As shown and described in FIGS. 78-83, bell crank 7-8 includes an actuator arm and a leaf spring arm that are preferably displaced relative to each other, and further preferably radially displaced relative to the pivot joint 7-8L. Referring to FIG. 78, a bell crank of an approximate “L” shape can be used to reposition the OEM chassis relative to the leaf spring with an actuator that operates in a substantially horizontal manner. In an overlay comparison of FIGS. 78 and 79, it can be seen that actuator cylinder 7-12D pivots slightly about forward pivot joint 7-9 between the fully extending and fully retracted positions. Although what is shown is a bell crank having approximate “L” shape, it is further understood that the bell crank could have a “triangulated” appearance, such that there is a third, structural connection extending from the pivotal attachment to the actuator to the pivotal attachment to the leaf spring.

In some embodiments, the placement of the actuator, bell crank, and form of the bell crank is arranged such that actuator 7-12 pivots only slightly in moving between fully extended and fully retracted positions, which can be useful in maintaining the position of the actuator within a relatively small volume, and preferably still between the top and bottom surfaces of the longitudinal frame member, and preferably in a substantially horizontal position. Still further, it is preferred that the relative positioning of the actuator, bell crank, and the form of the bell crank be such that the positions of the bell crank pivot joints stay within a volume that does not interfere with other chassis components or provide unacceptable ground clearance in the lowered position.

As shown in FIG. 79, a complete loss of hydraulic pressure will result in complete retraction and bottoming out of the actuator with the suspension in the lowered position. The fully extended position shown in FIG. 78 can be maintained even with a failure of the hydraulic pump by placing an on/off solenoid valve in series with the hydraulic fluid ports 7-12B.

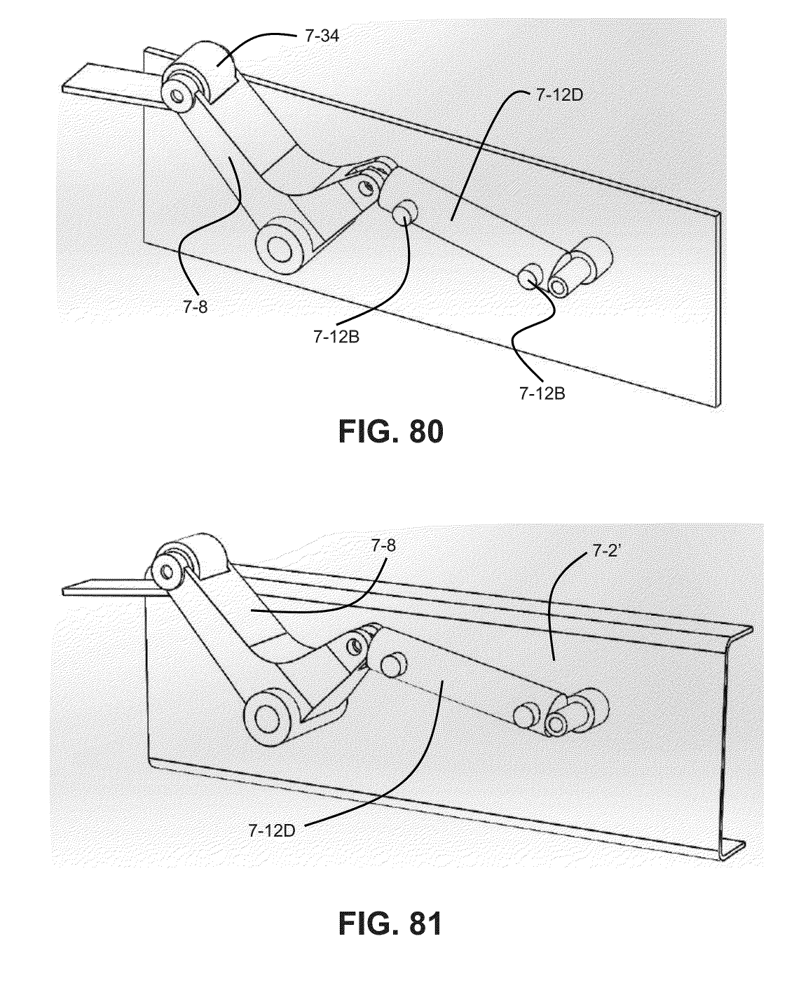

FIGS. 80 and 81 provide perspective views of kit 7-17 of FIG. 79. FIG. 81 shows a modified kit 7-17 in which the mounting plate 7-2′ has top and lower flanges, in an approximate C shape. In some embodiments, the shape is sized to fit over the OEM longitudinal frame rails, in a preferably snug fit.

FIGS. 82 and 83 show the operation of a kit 8-17 according to another embodiment of the present invention. As can be seen in FIG. 82, bell crank 8-8 is similar to bell crank 7-8, except flipped over about the pivot axis 8-8L. Therefore, in kit 8-17 the actuator arm 8-12J extends generally downward from the pivot 8-8L, whereas in kit 7-17 the arm 7-8J extends generally above pivot joint 7-8L. Comparing FIGS. 82 and 78, it can be seen that kit 8-17 operates such that full retraction of the rod 8-12A into the cylinder 8-12D establishes leaf spring 8-4 at the OEM position. Comparing FIGS. 83 and 79, it can be seen that full extension of rod 8-12A from cylinder 8-12D results in placement of OEM spring 8-4 at a position such that the OEM chassis is lower to the ground.

One embodiment of the present invention pertains to a kit for modifying an OEM suspension. The kit includes a mounting plate, a linear actuator pivotally mounted to the mounting plate, and a pivoting member pivotally mounted to the mounting plate. Preferably the other end of the actuator is pivotally mounted to a pivot joint to a pivot joint of a first pivot arm of the pivoting member. The pivoting member includes a second pivot arm that is pivotally coupled to an end of the OEM leaf spring. The mounting plate includes means for mounting the plate to a longitudinal rail of the OEM frame. In yet another embodiment, the two pivot arms of the pivoting member are angularly displaced from one another, and both the pivot connection to the actuator and the pivot connection to the leaf spring are radially displaced from the pivotal mounting of the member to the mounting plate. In another embodiment, the arrangement of the pivoting member and actuator are adapted and configured such that no part of the actuator extends higher than the top surface of the OEM longitudinal rail, and no part of the actuator extends below the lower surface of the OEM rail, for actuator movements between fully extended and full retracted. Preferably, the angular orientation of the fully extended actuator relative to the mounting plate is about the same as the angular orientation of the fully retracted actuator relative to the mounting plate.

Various aspects of different embodiments of the present invention are expressed in paragraphs X1, X2, X3, X4, X5, X6, X7 and X8 as follows:

X1. One aspect of the present invention pertains to a suspension for a wheeled vehicle, comprising an extendable first actuator having two ends, one end providing loads to the frame, a sliding spring mount, said mount being at least in part vertically slidable relative to the frame, the other end of said actuator being attached to said spring mount, and a leaf spring having two ends, one end being pivotally attached to the frame, the other end of said leaf spring being pivotally attached to said spring mount, said leaf spring supporting a wheel of the vehicle in contact with the road from a position intermediate of the two ends, wherein in the first position said actuator locates said other termination of said leaf spring in a position suitable for moving operation of the vehicle, and in the second position the top surface of said frame is placed at a location lower than the location of the top surface in the first position for loading of the vehicle.

X2. Another aspect of the present invention pertains to a kit for a leaf spring suspension of an OEM frame, comprising an extendable actuator extendable between a first position and a second position, said actuator having two ends and a pivotal attachment on each end, a mounting bracket including a first pivotal coupling for joining with one pivotal attachment of said actuator, said mounting bracket including a hole pattern that is the same as an existing hole pattern of the OEM ladder frame, said mounting bracket and said sliding bracket cooperating structurally to provide means for guided sliding, said sliding bracket including a second pivotal coupling for joining with the other pivotal attachment of said actuator, said sliding bracket including a mounting location for pivotal attachment of an end of a leaf spring.

X3. Yet another aspect of the present invention pertains to a kit for a leaf spring suspension of an OEM ladder frame, comprising an actuator including a cylinder and a rod, said rod being extendable relative to said cylinder to a first position, said rod being retractable within said cylinder to a second position, a mounting bracket including a support flange that couples to said actuator to direct at least part of the loads of the actuator into the ladder frame, said mounting bracket including a hole pattern that is generally the same as an existing hole pattern of the OEM ladder frame, said mounting bracket including one of a channel or a flange receivable within the channel, a sliding bracket including the other of the channel or the flange receivable within the channel, said sliding bracket including a mounting location for pivotal attachment of an end of a leaf spring; and means for flexibly coupling said actuator to one of said sliding bracket or the end of the leaf spring, wherein said actuator applies tension to said flexible coupling means to transition to one of said first position or said second position, and the weight of the ladder frame applies tension to said flexible coupling means to transition said actuator to the other of said first position or said second position.

X4. Yet another aspect of the present invention pertains to a kit for an OEM coil spring suspension of a motorized vehicle, comprising a coil spring having a stiffness that is about the same as the OEM stiffness of the OEM coil spring, said coil spring having a free height that is less than the OEM free height of the OEM coil spring, an actuator having a cylinder with a rod extendable from said cylinder to a first position and retractable to within said cylinder to a second position, a spring support adapted and configured to be received within the coils of said coil spring, said spring support having a loading surface adapted and configured for accepting a compressive load, an actuator support adapted and configured to be slidingly received within said spring support, said actuator support being attached to one of said rod or said cylinder, the other of said rod or said cylinder having an end adapted and configured for sliding contact with the loading surface.

X5. Still another aspect of the present invention pertains to a method of modifying an OEM leaf spring suspension of a motorized vehicle, comprising providing a coil spring, an extendable actuator, and a replacement leaf spring having a stiffness less than the stiffness of the OEM leaf spring, replacing the OEM leaf spring with the replacement leaf spring, placing the coil spring above the replacement leaf spring and able to apply a load to the replacement leaf spring; and locating the actuator to apply a load between the coil spring and the frame of the vehicle.

X6. Another aspect of the present invention pertains to a suspension for a ladder frame vehicle, comprising a rear leaf spring having a forward termination and an aftward termination, the aftward termination being pivotally coupled to one end of a link with the other end of the link being pivotally coupled to the frame of the vehicle, an actuator movable between a first extended position and a second retracted position, said actuator having first and second opposite ends and a pivotal attachment on each end, a mounting bracket pivotally attached to one end of said actuator, said mounting bracket being attached to the frame of the vehicle, a sliding bracket pivotally attached to the other end of said actuator, said sliding bracket coacting with said mounting bracket to guide said sliding bracket in a direction relative to said mounting bracket when said actuator moves between the first and second positions, said sliding bracket being pivotally coupled to the forward termination of said leaf spring, wherein said mounting bracket and said sliding bracket are adapted and configured such that said rear leaf spring moves partially forward and aftward when said actuator moves between the two positions.

X7. Yet another aspect of the present invention pertains to a method for supporting a vehicle from a wheel, comprising providing a hydraulic actuator capable of extension and retraction and coupled to one end of a leaf spring, the other end of the leaf spring being coupled to a frame of the vehicle, a source of hydraulic fluid, and a electrically actuatable valve having opened and closed positions, delivering hydraulic fluid under pressure from the source and through the opened valve to extend the actuator, releasing the hydraulic fluid pressure from the actuator and retracting the actuator by operation of gravity, closing the valve after said releasing; and hydraulically locking the actuator in the retracted position by said closing.

X8. Still another aspect of the present invention pertains to a method for supporting a vehicle from a wheel, comprising providing a powered actuator coupled to one end of a leaf spring, the other end of the leaf spring being coupled to a frame of the vehicle, and the middle of the leaf spring being coupled to the wheel, moving the one end of the leaf spring with the actuator to a first location, locking the one end at the first location, maintaining the one end at the locked first location with part of the weight of the vehicle, operating the vehicle in transport with the one end locked at the first location, and preventing the one end of the leaf spring from being unlocked from the first location without powering the actuator to support the part of the weight of the vehicle.

Yet other embodiments include the features described in any of the previous statements X1, X2, X3, X4, X5, X6, X7 and X8, as combined with

(i) one or more of the previous statements X1, X2, X3, X4, X5, X6, X7 and X8,

(ii) one or more of the following aspects, or

(iii) one or more of the previous statements X1, X2, X3, X4, X5, X6, X7 and X8 and one or more of the following aspects:

Wherein said actuator is a piggyback actuator having a pair of rods having parallel lines of actuation, and/or wherein said piggyback actuator is hydraulically pressurized to extend in two opposite directions, and/or wherein said piggyback actuator is compressed to a retracted position by the weight of the vehicle.

Wherein in the first position said actuator is extended and in the second position said actuator is retracted, or wherein in the first position said actuator is retracted and in the second position said actuator is extended.

Which further comprises a bracket for pivotally supporting the one said end relative to the frame and for slidably coupling said spring mount to said frame, said bracket and said spring mount including means for guiding the sliding motion of said spring mount along a track.

Which further comprises a separable rubbing block, said guiding means including said block, one side of said block being coupled to one of said spring mount or said bracket, the other side of said block being in sliding contact with the other of said spring mount or said bracket.

Wherein said block is fabricated from an ultra high molecular weight organic material.

Wherein the frame includes a first guiding member having a first cross sectional shape, said sliding spring mount includes a second guiding member having a second cross sectional shape complementary to the first cross sectional shape, said first guiding member and said second guiding member coacting to constrain the sliding motion of said spring mount to a substantially vertical direction.

Wherein said sliding spring mount is constrained to substantially vertical movement only.

Which further comprises a locking member movable between locked and unlocked positions, wherein in the locked position said locking member prevents sliding movement of the spring mount away from the first position, and in the unlocked position permits sliding movement of the spring mount from the first position to the second position.

Which further comprises a solenoid actuator operable to bias said locking member to the unlocked position, and/or which further comprises a spring to bias said locking member to the locked position, and/or wherein said locking member is gravity biased to the locking position.

The suspension of claim 1 wherein the one termination of said leaf spring is pivotally coupled to a link, said link being pivotally attached to the ladder frame. Which further comprises a locking member movable between a locked position which prevents the sliding of said sliding bracket relative to said mounting bracket and an unlocked position in which said sliding bracket is able to move vertically at least in part from the first position to the second position.

Wherein said sliding bracket includes a first through hole and said locking member includes a projection, wherein in the locked position the projection extends through the first through hole and contact a surface of said mounting bracket.

Wherein said locking member is pivotally coupled to said sliding bracket, and/or wherein said locking member is loaded substantially in compression in the locked position.

Wherein said sliding bracket has a pair of opposing flanges, the leaf spring has a width, and the opposing flanges are spaced apart to closely receive therebetween the leaf spring proximate to the pivotal attachment of end of the leaf spring.

Wherein said mounting bracket includes a horizontal flange, and the horizontal flange fits closely to the bottom of the ladder frame when said mounting bracket is attached to the hole pattern.

Wherein said mounting bracket includes a first surface, said sliding bracket includes a second surface, and the first surface and the second surface are placed in abutting relationship to establish the second position.

Wherein in the other position the end of the leaf spring is higher than in the one position, or wherein the one position is the OEM position of the leaf spring, or wherein in the one position is the first position.

Which further comprises means for locking said sliding bracket at the one position, or wherein said actuator is a hydraulic actuator and said locking means is by hydraulically locking said actuator in place with a shutoff valve, or wherein said locking means includes a sliding member that extends past a surface of said sliding bracket to maintain said sliding bracket in the one position.

Wherein said actuator extends and retracts along a first direction and said sliding bracket slides relative to said ladder frame along a second direction substantially orthogonal to the first direction.

Wherein said flexible coupling means includes a flexible cable having one end connected to said rod or said cylinder and the other end connected to said sliding bracket or the end of the leaf spring, and/or wherein said flexible coupling means includes a rotatable pulley having an outer diameter over which an intermediate portion of said cable extends.

Wherein said coil spring support includes a top flange the underside of which is in contact with the top of said coil spring.

Wherein the loading surface has a shape that is one of concave or convex and the end has a shape that is complementary to the shape of the loading surface.

Wherein the end has a spherical shape and the loading surface has a spherical shape.

Wherein the attachment of said actuator support to the one of said rod or said cylinder is a first attachment, and said actuator support includes a second attachment to the one of said rod or said cylinder, the second attachment being spaced apart from the first attachment.

Which further comprises extending the actuator to place the vehicle at the OEM ride height, and retracting the actuator to place the vehicle at a lowered height.

Wherein the combined stiffness of the coil spring and the replacement leaf spring is about the same as the stiffness of the OEM multileaf spring.

Wherein the replacement leaf spring is an OEM multileaf spring with at least one half of an OEM leaf removed.

Wherein said other end of said link is generally below said one end.

Wherein the actuator is hydraulically powered to extend and to retract, the shut off valve is a first shut off valve that controls the flow of fluid from the source to extend the actuator, said providing includes a second shut off valve that controls the flow of fluid from the source to retract the actuator, and which further comprises closing the second shut off valve after said retracting.

Which further comprises lowering the frame toward the ground by said delivering hydraulic fluid.

Wherein the shut off valve includes an electric solenoid.

Wherein the actuator is spring-biased to retract.

Wherein said providing includes a second actuator and which further comprises moving a lock to a released position with the second actuator during said powering.

Wherein said providing includes a movable locking member and which further comprises moving the locking member to a locking position during said locking, and said maintaining is with friction resulting from the part of the weight.

Wherein said maintaining is with the actuator being depowered.

Which further comprises unlocking the one end of the leaf spring and moving the one end to a second position in which the frame of the vehicle is closer to the roadway than in the first position.

Wherein said providing includes a movable locking member and which further comprises biasing the locking member to a locking position when the end of the leaf spring is at the second location.

While the inventions have been illustrated and described in detail in the drawings and foregoing description, the same is to be considered as illustrative and not restrictive in character, it being understood that only certain embodiments have been shown and described and that all changes and modifications that come within the spirit of the invention are desired to be protected.

1. A suspension for a ladder frame of a wheeled vehicle, comprising:
an extendable first actuator having two ends, one end providing loads to the ladder frame;
a sliding spring mount, said mount being at least in part vertically slidable relative to the ladder frame, the other end of said actuator being attached to said spring mount; and
a leaf spring having two terminations, one termination being pivotally attached to the ladder frame, the other termination of said leaf spring being pivotally attached to said spring mount, said leaf spring supporting a wheel of the vehicle in contact with the road from a position intermediate of the two ends;
wherein in the first position said actuator locates said other termination of said leaf spring in a position suitable for moving operation of the vehicle, and in the second position the top surface of said frame is placed at a location closer to the top surface in the first position for loading of the vehicle.

2. The suspension of claim 1 wherein said actuator is a piggyback actuator having a pair of rods having parallel lines of actuation.

3. The suspension of claim 2 wherein said piggyback actuator is hydraulically pressurized to extend in two opposite directions.

4. The suspension of claim 2 wherein said piggyback actuator is compressed by the weight of the vehicle.

5. The suspension of claim 1 wherein in the first position said actuator is extended and in the second position said actuator is retracted.

6. The suspension of claim 1 wherein in the first position said actuator is retracted and in the second position said actuator is extended.

7. The suspension of claim 1 which further comprises a bracket for pivotally supporting the one said end relative to the frame and for slidably coupling said spring mount to said frame, said bracket and said spring mount including means for guiding the sliding motion of said spring mount along a track.

8. The suspension of claim 7 which further comprises a separable rubbing block, said guiding means including said block, one side of said block being coupled to one of said spring mount or said bracket, the other side of said block being in sliding contact with the other of said spring mount or said bracket.

9. The suspension of claim 8 wherein said block is fabricated from an ultra high molecular weight organic material.

10. The suspension of claim 1 wherein the frame includes a first guiding member having a first cross sectional shape, said sliding spring mount includes a second guiding member having a second cross sectional shape complementary to the first cross sectional shape, said first guiding member and said second guiding member coacting to constrain the sliding motion of said spring mount to a substantially vertical direction.

11. The suspension of claim 1 wherein said sliding spring mount is constrained to substantially vertical movement only.

12. The suspension of claim 1 which further comprises a locking member movable between locked and unlocked positions, wherein in the locked position said locking member prevents sliding movement of the spring mount away from the first position, and in the unlocked position permits sliding movement of the spring mount from the first position to the second position.

13. The suspension of claim 12 which further comprises a solenoid actuator operable to bias said locking member to the unlocked position.

14. The suspension of claim 12 which further comprises a spring to bias said locking member to the locked position.

15. The suspension of claim 12 wherein said locking member is gravity biased to the locking position.

16. The suspension of claim 1 wherein the one termination of said leaf spring is pivotally coupled to a link, said link being pivotally attached to the ladder frame.

17. A kit for a leaf spring suspension of an OEM ladder frame vehicle, comprising:
an extendable actuator extendable between a first position and a second position, said actuator having two ends and a pivotal attachment on at least one end;
a mounting bracket including a first mounting feature adapted and configured for attachment of said actuator, said mounting bracket including a hole pattern that is generally the same as an existing hole pattern of the OEM ladder frame, said mounting bracket including one of a channel or a flange receivable within the channel; and
a sliding bracket including a second attachment feature adapted and configured for attachment of said actuator, said sliding bracket including the other of the channel or the flange receivable within the channel, said sliding bracket including a mounting location for pivotal attachment of an end of a leaf spring, one of said mounting bracket or said sliding bracket being pivotally coupled to said actuator.

18. The kit of claim 17 which further comprises a locking member movable between a locked position which prevents the sliding of said sliding bracket relative to said mounting bracket and an unlocked position in which said sliding bracket is able to move vertically at least in part from the first position to the second position.

19. The kit of claim 18 wherein said sliding bracket includes a first through hole and said locking member includes a projection, wherein in the locked position the projection extends through the first through hole and contact a surface of said mounting bracket.

20. The kit of claim 18 wherein said locking member is pivotally coupled to said sliding bracket.

21. The kit of claim 18 wherein said locking member is loaded substantially in compression in the locked position.

22. The kit of claim 17 wherein said sliding bracket has a pair of opposing flanges, the leaf spring has a width, and the opposing flanges are spaced apart to closely receive therebetween the leaf spring proximate to the pivotal attachment of end of the leaf spring.

23. The kit of claim 17 wherein said mounting bracket includes a horizontal flange, and the horizontal flange fits closely to the bottom of the ladder frame when said mounting bracket is attached to the hole pattern.

24. The kit of claim 17 wherein said mounting bracket includes a first surface, said sliding bracket includes a second surface, and the first surface and the second surface are placed in abutting relationship to establish the second position.

25. A kit for a leaf spring suspension of an OEM ladder frame, comprising:
an actuator including a cylinder and a rod, said rod being extendable relative to said cylinder to a first position, said rod being retractable within said cylinder to a second position;
a mounting bracket including a support flange that couples to said actuator to direct at least part of the loads of the actuator into the ladder frame, said mounting bracket including a hole pattern that is generally the same as an existing hole pattern of the OEM ladder frame, said mounting bracket including one of a channel or a flange receivable within the channel;
a sliding bracket including the other of the channel or the flange receivable within the channel, said sliding bracket including a mounting location for pivotal attachment of an end of a leaf spring; and
means for flexibly coupling said actuator to one of said sliding bracket or the end of the leaf spring;
wherein said actuator applies tension to said flexible coupling means to transition to one of said first position or said second position, and the weight of the ladder frame applies tension to said flexible coupling means to transition said actuator to the other of said first position or said second position.

26. The kit of claim 25 wherein in the other position the end of the leaf spring is higher than in the one position.

27. The kit of claim 26 wherein the one position is the OEM position of the leaf spring.

28. The kit of claim 25 wherein the one position is the first position.

29. The kit of claim 25 which further comprises means for locking said sliding bracket at the one position.

30. The kit of claim 29 wherein said actuator is a hydraulic actuator and said locking means is by hydraulically locking said actuator in place with a shutoff valve.

31. The kit of claim 29 wherein said locking means includes a sliding member that extends past a surface of said sliding bracket to maintain said sliding bracket in the one position.

32. The kit of claim 25 wherein said actuator extends and retracts along a first direction and said sliding bracket slides relative to said ladder frame along a second direction substantially orthogonal to the first direction.

33. The kit of claim 25 wherein said flexible coupling means includes a flexible cable having one end connected to said rod or said cylinder and the other end connected to said sliding bracket or the end of the leaf spring.

34. The kit of claim 25 wherein said flexible coupling means includes a rotatable pulley having an outer diameter over which an intermediate portion of said cable extends.

35. A kit for an OEM coil spring suspension of a motorized vehicle, comprising:
a coil spring having a stiffness that is about the same as the OEM stiffness of the OEM coil spring, said coil spring having a free height that is less than the OEM free height of the OEM coil spring;
an actuator having a cylinder with a rod extendable from said cylinder to a first position and retractable to within said cylinder to a second position;
a spring support adapted and configured to be received within the coils of said coil spring, said spring support having a loading surface adapted and configured for accepting a compressive load;
an actuator support adapted and configured to be slidingly received within said spring support, said actuator support being attached to one of said rod or said cylinder, the other of said rod or said cylinder having an end adapted and configured for sliding contact with the loading surface;
wherein the first position the end and the loading surface support in compression therebetween a portion of the weight of the vehicle a the OEM ride height, said spring support transferring this portion into said coil spring, and in the second position the height of the vehicle proximate to said coil spring is reduced from the OEM ride height.

36. The kit of claim 35 wherein said spring support includes a top flange the underside of which is in contact with the top of said coil spring.

37. The kit of claim 35 wherein the loading surface has a shape that is one of concave or convex and the end has a shape that is complementary to the shape of the loading surface.

38. The kit of claim 35 wherein the end has a spherical shape and the loading surface has a spherical shape.

39. The kit of claim 35 wherein the attachment of said actuator support to the one of said rod or said cylinder is a first attachment, and said actuator support includes a second attachment to the one of said rod or said cylinder, the second attachment being spaced apart from the first attachment.

40. A method of modifying the OEM multileaf spring suspension of a motorized vehicle, comprising:
providing a coil spring, an extendable actuator, and a replacement leaf spring having a stiffness less than the stiffness of the OEM multileaf spring;
replacing the OEM multileaf spring with the replacement leaf spring;
placing the coil spring above the replacement leaf spring and able to apply a load to the replacement leaf spring; and
locating the actuator to apply a load between the coil spring and the frame of the vehicle.

41. The method of claim 40 which further comprises extending the actuator to place the vehicle at the OEM ride height, and retracting the actuator to place the vehicle at a lowered height.

42. The method of claim 40 wherein the combined stiffness of the coil spring and the replacement leaf spring is about the same as the stiffness of the OEM multileaf spring.

43. The method of claim 40 wherein the replacement leaf spring is an OEM multileaf spring with at least one half of an OEM leaf removed.

44. The method of claim 40 wherein the suspension is the front suspension of the vehicle.

45. A suspension for a ladder frame vehicle, comprising:
a rear leaf spring having a forward termination and an aftward termination, the aftward termination being pivotally coupled to one end of a link with the other end of the link being pivotally coupled to the frame of the vehicle;
an actuator movable between a first extended position and a second retracted position, said actuator having first and second opposite ends and a pivotal attachment on each end;
a mounting bracket pivotally attached to one end of said actuator, said mounting bracket being attached to the frame of the vehicle;
a sliding bracket pivotally attached to the other end of said actuator, said sliding bracket coacting with said mounting bracket to guide said sliding bracket in a direction relative to said mounting bracket when said actuator moves between the first and second positions, said sliding bracket being pivotally coupled to the forward termination of said leaf spring;
wherein said mounting bracket and said sliding bracket are adapted and configured such that said rear leaf spring moves partially forward and aftward when said actuator moves between the two positions.

46. The suspension of claim 45 wherein said other end of said link is generally below said one end.

47. A method for supporting a vehicle from a wheel, comprising:
providing a hydraulic actuator capable of extension and retraction and coupled to one end of a leaf spring, the other end of the leaf spring being coupled to a frame of the vehicle, a source of hydraulic fluid, and a shut off valve actuatable between opened and closed positions;
delivering hydraulic fluid under pressure from the source and through the opened shut off valve to extend the actuator;
releasing the hydraulic fluid pressure from the actuator and retracting the actuator by operation of gravity;
closing the shut off valve after said releasing; and
hydraulically locking the actuator in the retracted position by said closing.

48. The method of claim 47 wherein the actuator is hydraulically powered to extend and to retract, the shut off valve is a first shut off valve that controls the flow of fluid from the source to extend the actuator, said providing includes a second shut off valve that controls the flow of fluid from the source to retract the actuator, and which further comprises closing the second shut off valve after said retracting.

49. The method of claim 47 which further comprises lowering the frame toward the ground by said delivering hydraulic fluid.

50. The method of claim 47 wherein the shut off valve includes an electric solenoid.

51. The method of claim 47 wherein the actuator is spring-biased to retract.

52. A method for supporting a vehicle from a wheel, comprising:
providing a powered actuator coupled to one end of a leaf spring, the other end of the leaf spring being coupled to a frame of the vehicle, and the middle of the leaf spring being coupled to the wheel;
moving the one end of the leaf spring with the actuator to a first location;
locking the one end at the first location;
maintaining the one end at the locked first location with part of the weight of the vehicle;
operating the vehicle in transport with the one end locked at the first location; and
preventing the one end of the leaf spring from being unlocked from the first location without powering the actuator to support the part of the weight of the vehicle.

53. The method of claim 52 wherein said providing includes a second actuator and which further comprises moving a lock to a released position with the second actuator during said powering.

54. The method of claim 52 wherein said providing includes a movable locking member and which further comprises moving the locking member to a locking position during said locking, and said maintaining is with friction resulting from the part of the weight.

55. The method of claim 52 wherein said maintaining is with the actuator being depowered.

56. The method of claim 52 which further comprises unlocking the one end of the leaf spring and moving the one end to a second position in which the frame of the vehicle is closer to the roadway than in the first position.

57. The method of claim 52 wherein said providing includes a movable locking member and which further comprises biasing the locking member to a locking position when the end of the leaf spring is at the second location.

58. A leaf spring suspension for a ladder frame of a wheeled vehicle, comprising:
an extendable actuator having two pivotal ends, one end providing loads to the frame and generally located in a parallel outboard arrangement relative to a longitudinal rail of the frame; the actuator having two positions;
a multi link pivotal mount having a first link pivotally attached to the actuator and a second pivotal link attached to the leaf spring, said first link being pivotally coupled to said second link; and
a leaf spring having two ends, one end being pivotally attached to the frame, the other end being pivotally attached to said second pivotal link, said leaf spring supporting a wheel of the vehicle in contact with the road at a location intermediate of the two ends;
wherein in the first position said actuator locates said leaf spring in a position suitable for moving operation of the vehicle, and in the second position the top surface of said frame is placed at a location closer to the location of the top surface in the first position for loading of the vehicle.

59. The suspension of claim 58 wherein said first link, said second link, and the other end of said actuator operate through the same pivotal connection.

60. The suspension of claim 58 wherein said first link has a second pivotal attachment relative to the ladder frame.

61. The suspension of claim 58 wherein the first position of said actuator is extended.

62. The suspension of claim 58 wherein the first position of said actuator is full extension to an internal stop of said actuator.

63. The suspension of claim 58 wherein the first position of said actuator is retracted.

64. The suspension of claim 58 wherein the one end of said leaf spring is the aftmost end.

65. The suspension of claim 58 wherein the one end of said leaf spring is the forwardmost end.
